(19) United States
(12) Patent Application Publication
(10) Pub. No.: US 2026/0269901 A1
(43) Pub. Date: Sep. 10, 2026

(54) METHODS, ARCHITECTURES, APPARATUSES AND SYSTEMS FOR UNIFIED TRANSMISSION CONFIGURATION INDICATOR (TCI) FRAMEWORK EXTENSIONS FOR HYBRID FIELD OPERATION

(71) Applicant: InterDigital Patent Holdings, Inc., Wilmington, DE (US)

(72) Inventors: Chia-Hung Wei, Chesterbrook, PA (US); Afshin Haghighat, Ile-Bizard (CA); Patrick Svedman, Stockholm (SE); Ravikumar Pragada, Warrington, PA (US); Jonghyun Park, Syosset, NY (US); Saiah Elhoushy, LaSalle (CA); Allan Yingming Tsai, Boonton, NJ (US); Yifan Li, Conshohocken, PA (US)

(73) Assignee: InterDigital Patent Holdings, Inc., Wilmington, DE (US)

(21) Appl. No.: 19/073,976

(22) Filed: Mar. 7, 2025

(51) Int. Cl. H04B 7/06; H04W 72/1273

(52) U.S. Cl. CPC H04B 7/0626; H04B 7/06968; H04W 72/1273

(57) ABSTRACT

A wireless transmit/receive unit (WTRU) may receive configuration information indicating a plurality of transmission configuration indicator (TCI) states and a plurality of aperiodic (AP) channel state information reference signal (CSI-RS) trigger states. The WTRU may determine that a unified TCI state is applicable. The WTRU may receive DCI scheduling a downlink transmission. For example, the DCI may include information indicating (i) a trigger state, (ii) an applicable RS, and/or (iii) a source RS of the unified TCI state or a previous AP CSI-RS. The WTRU may determine a RS, to apply for the downlink transmission, from the applicable RS, the source RS of the unified TCI state, and the previous AP CSI-RS. The WTRU may receive the downlink transmission using one or more first quasi-colocation (QCL) type properties associated with the determined RS and a second QCL type property associated with the unified TCI state.

### BACKGROUND

The present application is related to the fields of communications, software and encoding, including, for example, to methods, architectures, apparatuses, systems directed to extensions to the unified transmission configuration indicator (TCI) framework, and more particularly to unified TCI extensions for hybrid field operation.

In legacy systems, a wireless transmit/receive unit (WTRU) can be configured with a reference signal (RS) to be monitored for variety of purposes including beam management. For example, in the Transmission Configuration Indication (TCI) framework for beam management in 3GPP NR wireless communication systems, a WTRU can be indicated with a TCI state to be applied for a downlink (e.g. signal, channel) reception and/or an uplink (e.g. signal, channel) transmission. Each TCI state may indicate one or two source RSs to be applied for different types of quasi-colocation (QCL) property (e.g., parameter) estimation. A source RS may be configured as one of periodic, semi-persistent, or aperiodic types.

The WTRU may be pre-configured, by the gNB via radio resource control (RRC) (e.g., configuration), with multiple TCI states as candidates. A subset of the pre-configured TCI states may be activated by the gNB via medium access control (MAC) control element (CE). A TCI state from the TCI states, which have been activated by the MAC CE, may be indicated, by the gNB via downlink control information (DCI), to be applied by the WTRU for downlink (e.g. signal, channel) reception and/or uplink (e.g. signal, channel) transmission. For TCI state(s) that have been activated by the MAC CE, the WTRU may monitor the corresponding source RS for QCL property estimation, and to perform the corresponding downlink signal/channel reception and/or uplink signal/channel transmission.

A need exists extend the TCI framework to account for far field (FF) and near field (NF), as well as hybrid field, downlink and/or uplink communications. Taking the unified TCI framework as a baseline, it would be beneficial to enable control channel transmissions, such as on the physical downlink control channel (PDCCH) to be served by FF beams for robustness, and for achieving high signal-to-noise ratios (SNRs), data channel transmissions, such as on the physical downlink shared channel (PDSCH) may be served by different types of beams (e.g., NF or FF).

### BRIEF SUMMARY

Briefly stated, in one embodiment, a WTRU may receive configuration information indicating a plurality of TCI states and a plurality of aperiodic (AP) channel state information reference signal (CSI-RS) trigger states. The WTRU may determine that a unified TCI state is applicable (e.g., to downlink control and data transmissions). The WTRU may receive DCI scheduling a downlink transmission. For example, the DCI may include information indicating (i) a trigger state, (ii) an applicable RS, and/or (iii) a source RS of the unified TCI state or a previous AP CSI-RS. The WTRU may determine a RS, to apply for the downlink transmission, from the applicable RS, the source RS of the unified TCI state, and the previous AP CSI-RS. The WTRU may receive the downlink transmission using one or more first QCL type properties associated with the determined RS and a second QCL type property associated with the unified TCI state.

In one embodiment, a WTRU may send information indicating a capability of the WTRU associated with source RS determination. The WTRU may receive configuration information including (i) a plurality of TCI states and (ii) an AP CSI-RS configuration that includes a set of AP CSI-RS trigger states. The WTRU may receive a first PDCCH transmission that includes a first DCI. The first DCI may include information indicating a unified TCI state. The WTRU may receive a second PDCCH transmission using the unified TCI state. For example, the second PDCCH transmission includes a second DCI that may include (i) information scheduling a physical downlink shared channel (PDSCH) transmission, (ii) a CSI trigger state indicator indicating an AP CSI-RS trigger state of the set of AP CSI-RS trigger states, and (iii) a previous CSI-RS indicator. The WTRU may estimate one or more properties of a first QCL type (e.g., QCL-A) using the respective AP CSI-RS resource associated with the indicated AP CSI-RS trigger state. The WTRU may may receive the PDSCH transmission using the one or more estimated QCL properties of the first QCL type and at least one QCL property of a second QCL type (e.g., QCL-D) associated with the unified TCI state.

In one embodiment, a WTRU may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. The WTRU may receive a first PDCCH transmission that includes a first DCI. The first DCI may include information indicating a unified TCI state. The WTRU may receive a second PDCCH transmission using the unified TCI state. For example, the second PDCCH transmission includes a second DCI that may include (i) information scheduling a physical downlink shared channel (PDSCH) transmission, (ii) a CSI trigger state indicator indicating an AP CSI-RS trigger state of the set of AP CSI-RS trigger states, and/or (iii) a previous CSI-RS indicator. The WTRU may receive, based on (i) the CSI trigger state indicator not indicating one of the set of AP CSI-RS trigger states and/or (ii) information indicated by the previous CSI-RS indicator, the PDSCH transmission using the unified TCI state.

In one embodiment, a WTRU may receive information indicating a capability of the WTRU associated with source RS determination. The WTRU may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. The WTRU may receive a first PDCCH transmission that includes a first DCI. The first DCI may include information indicating a unified TCI state. The WTRU may receive a second PDCCH transmission using the unified TCI state. For example, the second PDCCH transmission includes a second DCI that may include (i) information scheduling a physical downlink shared channel (PDSCH) transmission, (ii) a CSI trigger state indicator indicating an AP CSI-RS trigger state of the set of AP CSI-RS trigger states, and/or (iii) a previous CSI-RS indicator. The WTRU may receive, based on (i) the CSI trigger state indicator not indicating one of the set of AP CSI-RS trigger states and (ii) information indicated by the previous CSI-RS indicator, the PDSCH transmission using one or more estimated QCL properties of a first QCL type (e.g., QCL-A) associated with an indicated one or more of the previously triggered AP CSI-RS resources and a second QCL type property (e.g., QCL-D) associated with the unified TCI state.

In one embodiment, a WTRU may send information indicating a capability of the WTRU associated with AP CSI-RS trigger timing. The WTRU may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. The WTRU may receive a first PDCCH transmission that includes a first DCI. For example, the first DCI may include information indicating a unified TCI state. The WTRU may receive a second PDCCH transmission using the unified TCI state. For example, the second PDCCH transmission may include a second DCI that includes (i) information scheduling a PDSCH transmission, and (ii) a CSI trigger state indicator indicating an AP CSI-RS trigger state of the set of AP CSI-RS trigger states, and/or (iii) a previous CSI-RS indicator. The WTRU may estimate one or more QCL (e.g., QCL-A) properties using the respective AP CSI-RS resource associated with the indicated AP CSI-RS trigger state based on a time duration (e.g., between the received second DCI and the scheduled PDSCH transmission) being greater than, or equal to, the indicated capability of the WTRU. The WTRU may receive the PDSCH transmission using the one or more estimated QCL properties of the first QCL type and a QCL property of a second QCL type (e.g., QCL-D) associated with the unified TCI state.

In one embodiment, a WTRU may send information indicating a capability of the WTRU associated with AP CSI-RS trigger timing. The WTRU may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. The WTRU may receive a first PDCCH transmission that includes a first DCI. For example, the first DCI may include information indicating a unified TCI state. The WTRU may receive a second PDCCH transmission using the unified TCI state. For example, the second PDCCH transmission may include a second DCI that includes (i) information scheduling a PDSCH transmission, and (ii) a CSI trigger state indicator, and/or (iii) a previous CSI-RS indicator. The WTRU may receive the PDSCH transmission using one or more QCL properties of a first QCL type (e.g., QCL-A) and a QCL property of a second QCL type (e.g., QCL-D) associated with the unified TCI state based on (i) the second DCI and (ii) a time duration, between the reception of the second DCI and the scheduled PDSCH transmission, being less than, or equal to, the indicated capability of the WTRU.

In one embodiment, a WTRU may receive configuration information including (i) a first TCI state and a second TCI state which are associated with far field operation, (ii) an AP CSI-RS configuration that includes a set of AP CSI-RS trigger states, wherein each AP CSI-RS trigger state is associated with a respective AP CSI-RS resource, and (iii) a TCI state indicator associated with physical downlink control channel (PDCCH) reception. The WTRU may receive a first PDCCH transmission that includes a first DCI, wherein the first DCI includes information indicating the first TCI state and the second TCI state (e.g., as a unified TCI state). The WTRU may receive a second PDCCH transmission using one of the first TCI state and/or the second TCI state based on the TCI state indicator. The second PDCCH transmission may include a second DCI that includes (i) information scheduling a PDSCH transmission, (ii) a CSI trigger state indicator indicating an AP CSI-RS trigger state of the set of AP CSI-RS trigger states, (iii) a QCL indicator, and (iv) a TCI selection field. The WTRU may estimate one or more QCL properties of a first QCL type (e.g., QCL-A) using the respective AP CSI-RS resource associated with the indicated AP CSI-RS trigger state and the first TCI state as indicated by the TCI selection field. The WTRU may receive the PDSCH transmission using the estimated one or more QCL properties of the first QCL type and a QCL property of a second QCL type (e.g., QCL-D) associated with the first TCI state. For example, the one or more QCL properties (e.g., of the first QCL type) may be associated with one of (e.g., the source RS of) the first TCI state or the respective AP CSI-RS resource indicated by the QCL indicator.

In one embodiment, a WTRU may receive configuration information including a first TCI state, and (e.g., anchoring) information indicating the first TCI state is anchored with a second TCI state for a first QCL type (e.g., QCL-A), and the first TCI state is anchored with a third TCI state for a second QCL type (e.g., QCL-D). The WTRU may receive a first PDCCH transmission that includes a first DCI. For example, the first DCI may include information indicating the third TCI state as a unified TCI state (e.g., for PDCCH and PDSCH reception). The WTRU may receive a second PDCCH transmission using the unified TCI state. For example, the second PDCCH transmission may include a second DCI that includes information scheduling a PDSCH transmission. The WTRU may determine, based on a TCI status of the second TCI state, to apply one of the first TCI state or the third TCI state for the reception of the PDSCH transmission. The WTRU may receive the PDSCH transmission by applying the determined one of the first TCI state or the third TCI state.

In one embodiment, a WTRU may receive configuration information including (i) a first TCI state associated with a first source RS resource for a first QCL type (e.g., QCL-A), and (ii) a second TCI state associated with a second source RS resource for the first QCL type and a third source RS resource for a second QCL type (e.g., QCL-D). The WTRU may receive a MAC CE including information indicating (i) the first TCI state and the second TCI state are activated, and (ii) the first TCI state is anchored with the second TCI state for the second QCL type. The WTRU may receive a first PDCCH transmission that includes a first DCI. For example, the first DCI may include information scheduling a PDSCH transmission (e.g., using the first TCI state). The WTRU may receive, based on the configuration information and the MAC CE, the PDSCH transmission using (i) one or more QCL properties of the first QCL type associated with the first source RS resource and (ii) one or more QCL properties of the second QCL type associated with the third source RS resource. The WTRU may receive, based on the configuration information, the MAC CE, and the first DCI, a second PDCCH transmission using the second TCI state (e.g., (i) the one or more QCL properties associated with the second source RS resource and (ii) one or more QCL properties associated with the third source RS resource).

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 2 is a general diagram showing an example of the unified TCI framework and how a unified TCI state may be signaled for a multi-TRP scenario, according to one or more embodiments of the present disclosure;

FIG. 3 is a general diagram illustrating an example configuration of AP CSI-RS trigger states, according to one or more embodiments of the present disclosure;

FIG. 4 is a timing diagram illustrating an example use of an AP CSI-RS trigger state, according to one or more embodiments of the present disclosure;

FIG. 5 is a general diagram illustrating an example mobility scenario of a WTRU moving from the FF to the NF, according to one or more embodiments of the present disclosure;

FIG. 6 is a transmission diagram illustrating an example of NF, FF and hybrid zones, according to one or more embodiments of the present disclosure;

FIG. 7 is a timing diagram illustrating an example of TCI switching delay, according to one or more embodiments of the present disclosure;

FIG. 8 is a timing diagram illustrating an example of triggering an AP CSI-RS for PDSCH reception, according to one or more embodiments of the present disclosure;

FIG. 9 is a source RS determination diagram illustrating examples of ways in which source RSs may be anchored for estimation of a QCL type A property, according to one or more embodiments of the present disclosure;

FIG. 10 is a timing diagram showing various examples of how the QCL properties may be determined, according to one or more embodiments of the present disclosure;

FIG. 11 is a general diagram illustrating another example configuration of AP CSI-RS trigger states, according to one or more embodiments of the present disclosure;

FIG. 12 is a timing diagram illustrating various examples of time durations associated with AP-CSI RS triggering and PDSCH reception;

FIG. 13 is a procedural diagram illustrating an example procedure to determine whether or not to apply a unified TCI state, according to one or more embodiments of the present disclosure;

FIG. 14 is a procedural diagram illustrating an example procedure to determine whether or not to apply a source RS of a unified TCI state, according to one or more embodiments of the present disclosure;

FIG. 15 is a procedural diagram illustrating an example procedure for determining an RS to be applied for QCL property estimation, according to one or more embodiments of the present disclosure;

FIG. 16 is a procedural diagram illustrating an example procedure to determine whether to apply a unified TCI state, to apply a (e.g., triggered) AP CSI-RS, and/or to apply a previous AP CSI-RS, according to one or more embodiments of the present disclosure;

FIG. 17 is a procedural diagram illustrating an example procedure to determine whether to apply one or more estimated QCL properties, according to one or more embodiments of the present disclosure;

FIG. 18 is a system diagram illustrating an example unified TCI state for a multi-TRP scenario, according to one or more embodiments of the present disclosure;

FIG. 19 is a timing diagram illustrating an example procedure to determine a source RS for a multi-TRP scenario, according to one or more embodiments of the present disclosure;

FIG. 20 is an indication diagram illustrating an example two-stage indication for source RS determination, according to one or more embodiments of the present disclosure;

FIG. 21 is a procedural diagram illustrating an example procedure for determining QCL properties for receiving a downlink transmission, according to one or more embodiments of the present disclosure;

FIG. 22 is a procedural diagram illustrating another example procedure for determining QCL properties for receiving a downlink transmission, according to one or more embodiments of the present disclosure;

FIG. 23 is a procedural diagram illustrating another example procedure for determining QCL properties for receiving a downlink transmission, according to one or more embodiments of the present disclosure;

FIG. 24 is a procedural diagram illustrating another example procedure for determining QCL properties for receiving a downlink transmission, according to one or more embodiments of the present disclosure;

FIG. 25 is a procedural diagram illustrating another example procedure for determining QCL properties for receiving a downlink transmission, according to one or more embodiments of the present disclosure;

FIG. 26 is a procedural diagram illustrating another example procedure for determining QCL properties for receiving a downlink transmission, according to one or more embodiments of the present disclosure;

FIG. 27 is a procedural diagram illustrating another example procedure for determining QCL properties for receiving a downlink transmission, according to one or more embodiments of the present disclosure;

FIG. 28 is a procedural diagram illustrating another example procedure for determining QCL properties for receiving a downlink transmission, according to one or more embodiments of the present disclosure;

FIG. 29 is a procedural diagram illustrating an example procedure for determining QCL properties for receiving a downlink transmission, according to one or more embodiments of the present disclosure; and

FIG. 30 is a procedural diagram illustrating an example procedure for determining QCL properties for receiving a downlink transmission, according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

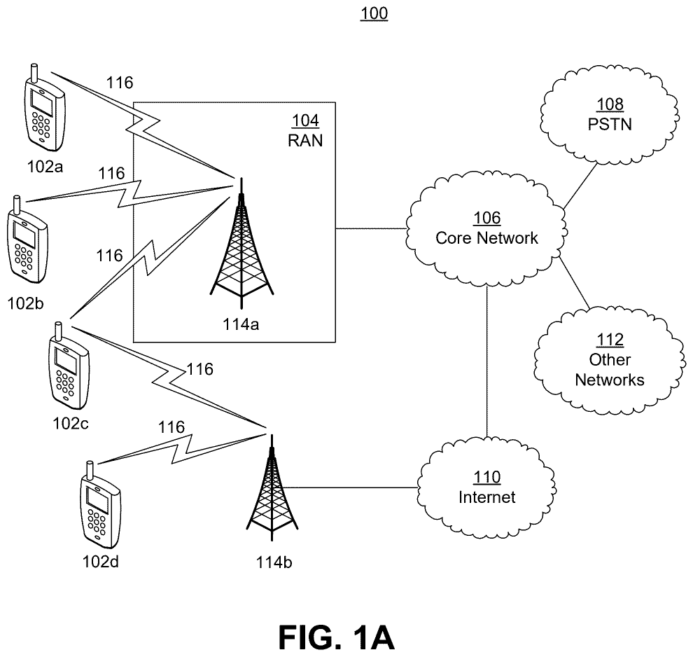

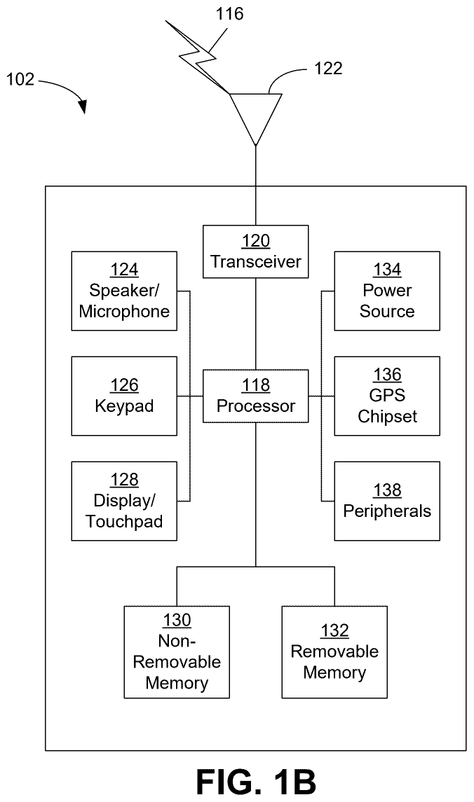

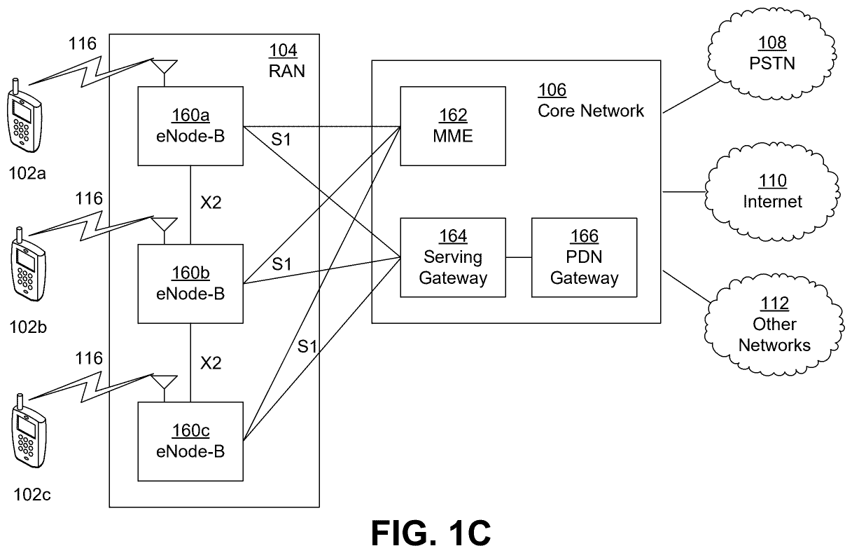

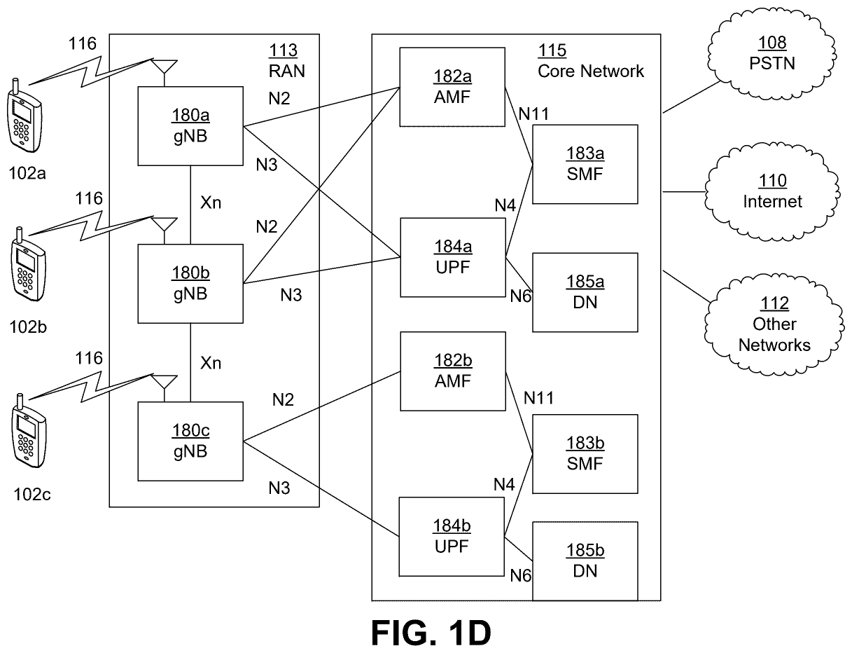

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

For purposes of QCL property (e.g., Doppler shift, delay spread) estimation on channel(s) transmitted through (e.g., NF and/or spot) beams, a gNB 180 may transmit individual source RSs corresponding to each TCI state for different (NF and/or spot) beams. For example, a TCI state may include information that indicates a source RS for a first QCL type (e.g., QCL type A) and another source RS for a second QCL type (e.g., QCL type D). As an example, the source RS for QCL type A may be different from the source RS for QCL type D. A CSI-RS can be configured with different time-domain properties, such as Periodic (P), Aperiodic (AP) or Semi-persistent (SP). For example, the activation and deactivation of a SP CSI-RS may be done via a (e.g., dedicated DL) MAC CE.

A Unified TCI framework was introduced in 3GPP Rel. 17 for NR, which allowed a gNB 180 to efficiently indicate a (e.g., common) TCI state to be applied for different channels, such as the physical downlink control channel (PDCCH) and physical downlink shared channel (PDSCH). That is, in the unified TCI framework, PDCCH and PDSCH transmission/reception will apply the same (e.g., joint or DL) TCI state, which is indicated via DCI. In 3GPP Rel. 18, a unified TCI framework for multiple transmission/reception points (multi-TRP) was introduced for NR, in which the gNB and WTRU 102 may support transmission/reception from/to two TRPs. Two (e.g., joint or DL) TCI states, each corresponding to a TRP, may be activated for a TCI codepoint which is then indicated by a DCI. Which of the two TCI states, or both, used for the PDCCH is determined based on RRC configuration (e.g., applyIndicatedTCI-State IE). Which of the two TCI states, or both, used for the PDSCH is determined based on the DCI that schedules the PDSCH (e.g., TCI selection field).

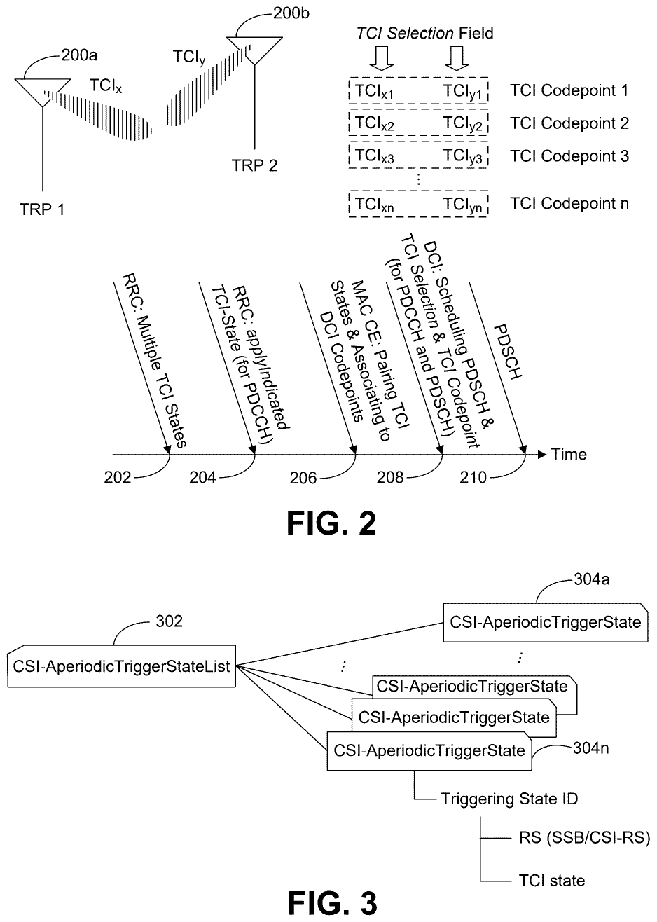

FIG. 2 is a general diagram showing an example of the unified TCI framework and how a unified TCI state may be signaled for a multi-TRP scenario, according to one or more embodiments of the present disclosure. As shown in FIG. 2, multiple TCI states (e.g., TCIₓ₁ to TCIₓₙ and TCI_{y1} to TCI_{yn}) may be configured by RRC at 202 and 204. The TCI states may be paired by MAC CE using TCI codepoints 1 to n at 206. At 208, a DCI may indicate a pair of TCI states for a TRP 1 200a and a TRP 2 200b (e.g., via a TCI codepoint) and may indicate either one or both of the pair of TCI states (e.g., via TCI selection field). As shown in FIG. 2, the TRP 1 may use the indicated TCI state TCIₓ for PDSCH transmission at 210 and the TRP may use the indicated TCI state TCI_{y} for PDSCH transmission at 210. For example, the TCI state TCIₓ may be one of multiple TCI states (e.g., TCIₓ₁ to TCIₓₙ) which were paired by MAC CE. For example, the TCI state TCI_{y} may be one of multiple TCI states (e.g., TCI_{y1} to TCI_{yn}) which were paired by MAC CE.

FIG. 3 is a general diagram illustrating an example configuration of AP CSI-RS trigger states, according to one or more embodiments of the present disclosure. In certain representative embodiments, a WTRU 102 can be configured with multiple AP CSI-RS trigger states (e.g., via CSI-AperiodicTriggerState IEs) of which each can indicate a RS (e.g., set), such as a SSB or CSI-RS resource, and a TCI state corresponding to the RS, such as (e.g., only) for AP CSI-RS. As shown in FIG. 3, a CSI-AperiodicTriggerStateList 302 may be used to configure multiple AP CSI-RS trigger states (e.g., via CSI-AperiodicTriggerState IEs 304a to 304n). An AP CSI-RS trigger state may be identified by a triggering state ID. For example, the triggering state ID may associate a RS resource and a TCI state. In other representative embodiments, AP trigger states may be configured in a similar way for other RSs. For example, a respective TCI state may include information that indicates a source (e.g., RS) for a first QCL type (e.g., QCL type A, B, or C) and another source (e.g., RS) for a second QCL type (e.g., QCL type D).

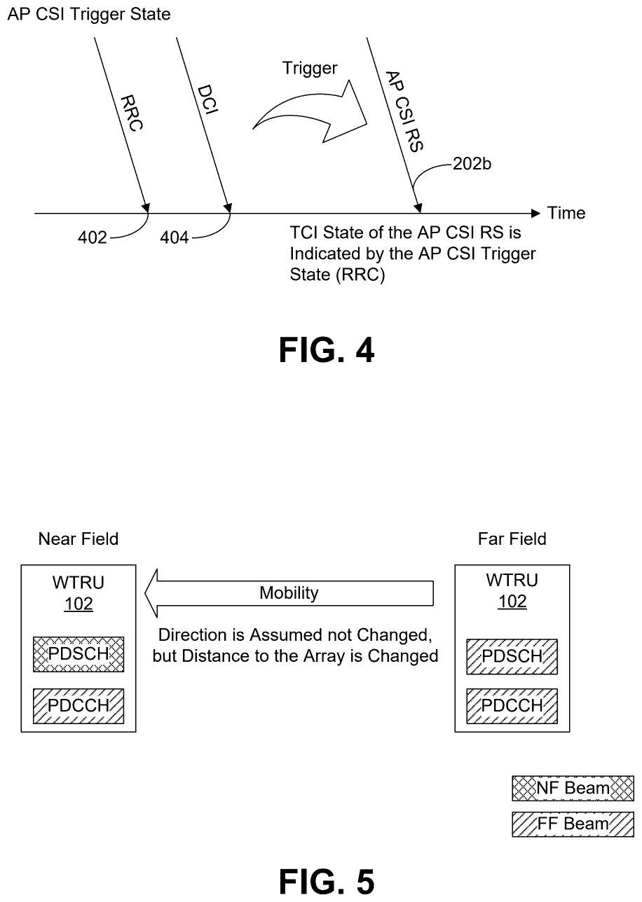

FIG. 4 is a timing diagram illustrating an example use of an AP CSI-RS trigger state, according to one or more embodiments of the present disclosure. As shown in FIG. 4, one or more AP CSI trigger states may be configured by RRC (e.g., messaging) at 402. An AP CSI-RS of an AP CSI trigger state may be transmitted after the AP CSI trigger state is triggered by layer 1 (L1) signaling, such as DCI at 404, as illustrated FIG. 4. The WTRU 102 may apply the TCI state configured in the AP CSI-RS trigger state to receive the AP CSI-RS at 406. It is noted that, an AP CSI-RS may be transmitted with WTRU-specific beamforming. For example, the network may determine a suitable (e.g., NF) beam for the AP CSI-RS, such as based on prior WTRU beam reporting and/or SRS transmission.

In certain representative embodiments, it should be beneficial to provide for PDCCH transmissions, or other control transmissions, to be served by FF beams, such as to provide robustness, and to provide for PDSCH transmission, or other data transmissions, to be served by different types of beams, such as to provide high SNR, depending on whether a WTRU 102 is located in the NF, the FF, or a hybrid region.

FIG. 5 is a general diagram illustrating an example mobility scenario of a WTRU moving from the FF to the NF, according to one or more embodiments of the present disclosure. As shown in FIG. 5, in the FF, a WTRU 102 may receive PDCCH and PDSCH transmissions using FF beams. Due to mobility, the WTRU 102 may move to the NF, such as where the direction to a gNB 180 or TRP does not change but the distance changes. The WTRU 102 may receive PDCCH transmissions using the FF beams and receive the PDSCH transmission using NF beams. That is, in NF, to keep robustness for the PDCCH and to achieve high SNR for the PDSCH, a gNB 180 may serve these two channels via different types of beams. Hence, a WTRU 102 may need to be indicated, such as via the unified TCI framework, with different TCI states each for PDCCH and PDSCH, respectively.

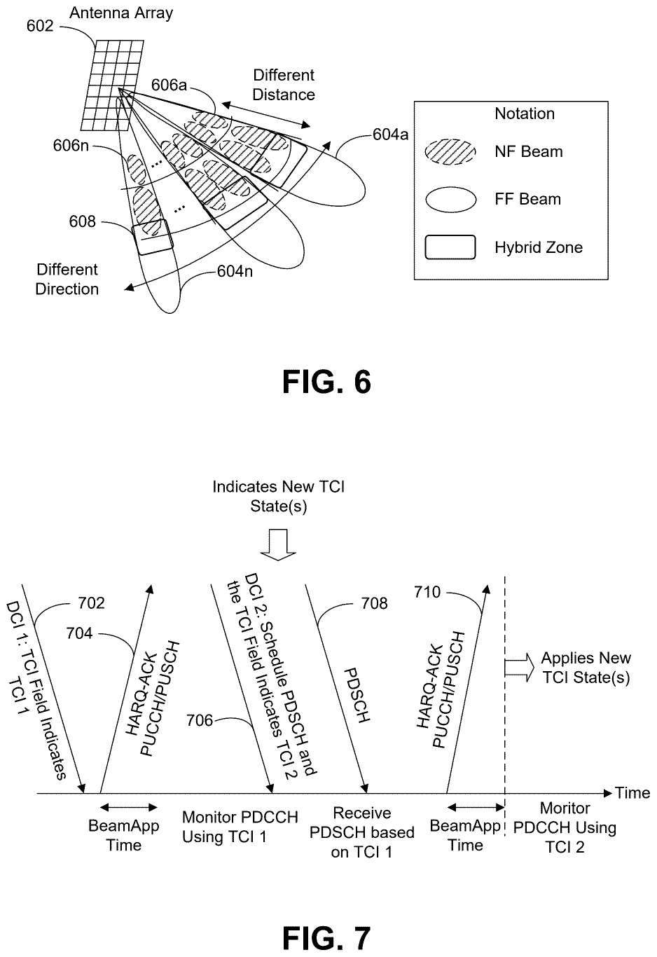

FIG. 6 is a transmission diagram illustrating an example of NF, FF and hybrid zones, according to one or more embodiments of the present disclosure. As shown in FIG. 6, an antenna array 602 may operate using a plurality of FF beams 604a to 604n, and a plurality of NF beams. For example, multiple NF beams may be located within the width of a FF beam. A hybrid zone 608 may be present in a region at an edge of the NF beams (e.g., relative to a FF beam).

In view of mobility, a WTRU 102 may frequently move in and out of the NF and FF within a hybrid field which is between the edges of the NF and FF as in FIG. 6. Hence, a NF TCI state may need to be activated and/or deactivated according to the frequency at which the mobility transitions between the areas in FIG. 6.

Further, the TCI state configurations, (de)activation and indications corresponding to signaling overhead may be high in such scenarios. Frequent TCI state adjustment bring challenges to the unified TCI framework, such as in terms of TCI states pairing overhead and unified TCI state update overhead.

To support accurate QCL property (e.g., Doppler shift, Doppler spread, average delay, delay spread) estimation for the PDSCH transmitted via NF beams, the overhead of RS transmissions corresponding to the NF beams is high (e.g., due to the larger amount of NF beams as compared to the FF beams).

In the hybrid zones, both the gNB 180 and the WTRU 102 may need to spend much more effort to frequently maintain and switch to proper TCI states, such as for PDCCH and PDSCH.

To switch TCI states for multiple channels (e.g., PDCCH and PDSCH) in the unified TCI framework, a gNB 180 can indicate (e.g., new) TCI state(s) via DCI. However, the WTRU 102 cannot apply the indicated TCI state(s) for the channels before corresponding hybrid automatic repeat request (HARQ) feedback is provided.

FIG. 7 is a timing diagram illustrating an example of TCI switching delay, according to one or more embodiments of the present disclosure. As shown in FIG. 7, at 702, a first DCI (e.g., DCI 1) may include a TCI field that indicates ‘TCI state 1’, and, at 704, a WTRU 102 may provide HARQ-ACK feedback, such as via physical uplink control channel (PUCCH) or physical uplink shared channel (PUSCH). The WTRU 102 may monitor the PDCCH using TCI state 1, and receive a second DCI (e.g., DCI 2) that schedules a PDSCH transmission and includes a TCI field that indicates ‘TCI state 2’. At 708, the WTRU 102 may receive the PDSCH transmission using TCI state 1. At 710, the WTRU 102 may provide HARQ-ACK feedback. After a beam application time (e.g., due to beam switching capabilities of the WTRU 102), the WTRU 102 may apply TCI state 2. For example, the WTRU 102 may monitor the PDCCH using TCI state 2 to receive further DCI.

In the unified TCI framework, the latency of switching TCI states for channels may be relatively high.

In the unified TCI framework, the gNB 180 cannot make timely adjustments to the TCI state for PDSCH while keeping the TCI state for PDCCH unchanged, such as due to FF and NF switching in the hybrid zones and/or FF beam switching.

In addition, the WTRU 102 may not be indicated with a proper source RS for accurate QCL-A property estimation for PDSCH reception.

In certain representative embodiments, enhancements to the unified TCI framework may to reduce source RS transmission and signaling overhead while keeping the flexibility of supporting the PDCCH to be transmitted via FF beams for robustness and the PDSCH to be transmitted either via NF beam for high SNR or via the FF beam as a fallback for the hybrid field (e.g., hybrid zones).

For example, a PDSCH transmission using a spot (e.g., NF) beam may be characterized by higher spectral efficiency, but lower robustness, than a PDSCH transmission with a FF beam. It may be beneficial for the network to dynamically switch between NF beam PDSCH (e.g., eMBB traffic) and FF beam PDSCH (e.g., control plane traffic) transmissions. Further, if the PDSCH transmissions using spot beams results in errors, dynamic fallback to FF beams, such as for retransmissions, may be advantageous.

### Overview

In certain representative embodiments, a source (e.g., for QCL assumptions) may be indicated via AP CSI triggering (e.g., as a unified TCI framework enhancement). For example, this may provide an individual source RS for QCL (e.g., QCL type A) property estimation for the PDSCH via AP CSI-RS in order to reduce source RS transmission overhead.

As an example, an AP CSI trigger state may be triggered via a DCI scheduling a PDSCH transmission and, upon receive the DCI, a WTRU may determine to apply a (e.g., current or previous) AP CSI RS for QCL-A property estimation for the PDSCH reception. For example, a DCI format 1_X may be used to schedule PDSCH reception and may carry a triggering state indicator. The WTRU 102 may apply a RS of the indicated triggering state (e.g., as a source) for receiving the PDSCH transmission.

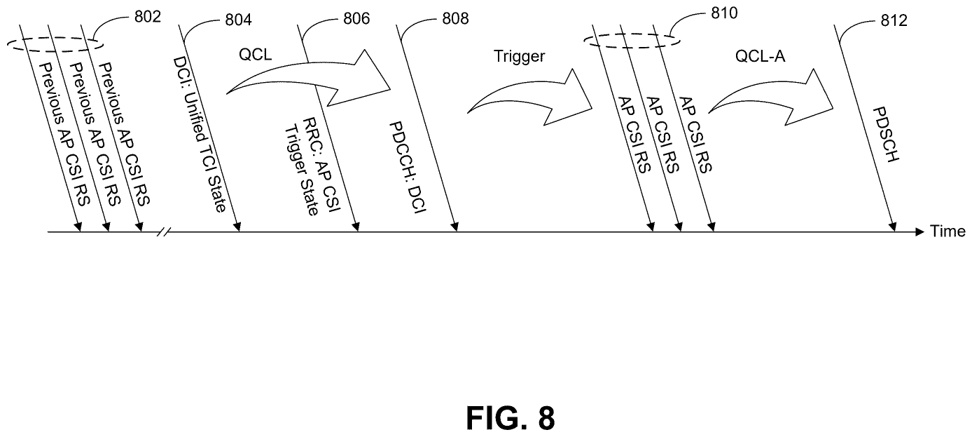

FIG. 8 is a timing diagram illustrating an example of triggering an AP CSI-RS for PDSCH reception, according to one or more embodiments of the present disclosure. As shown in FIG. 8, a WTRU 102 may (e.g., optionally) receive one or more AP CSI-RS transmissions at 802. For example, the WTRU may determine (e.g., estimate) one or more QCL type A properties of the AP CSI-RS transmissions. After, the WTRU 102 may receive a DCI which includes information indicating a unified TCI state at 804. The WTRU 102 may receive an RRC configuration that includes information indicating an AP CSI-RS trigger state at 806. The WTRU 102 may monitor for a PDCCH transmission using the unified TCI state. For example, the WTRU 102 may apply first and second QCL types of the unified TCI state when monitoring the PDCCH. The PDCCH transmission at 808 may carry a DCI that includes information scheduling PDSCH reception and identifying the AP CSI-RS trigger state. Based on triggering of the AP CSI-RS associated with the AP CSI-RS trigger state, the WTRU 102 may may receive one or more AP CSI-RS transmissions at 810. For example, the WTRU may determine (e.g., estimate) one or more QCL type A properties of the AP CSI-RS transmissions. The WTRU 102 may receive the PDSCH transmission at 812 by applying the determined one or more QCL type A properties of the AP CSI-RS. For example, the determined one or more QCL type A properties of the AP CSI-RS may be used as a source for the TCI state associated with the indicated AP CSI-RS trigger state.

In certain representative embodiments, a source determination may be dynamically provided (e.g., as a unified TCI framework enhancement). For example, different sources (e.g., RSs) for QCL (e.g., QCL type A) property estimation, such as for PDSCH, may be dynamically indicated.

For example, a WTRU 102 may dynamically determine to apply different source RS(s) for a PDSCH transmission scheduled by a DCI. A source RS may be determined to be any of a particular QCL type source RS of a specific (e.g., FF) TCI state, an AP-CSI-RS triggered by the DCI, or an AP-CSI-RS triggered previously. The WTRU 102 may determine the source RS based on any of an AP CSI trigger state trigger indicated (e.g., carried) by the DCI, and/or a previous CSI-RS indicator carried by the DCI.

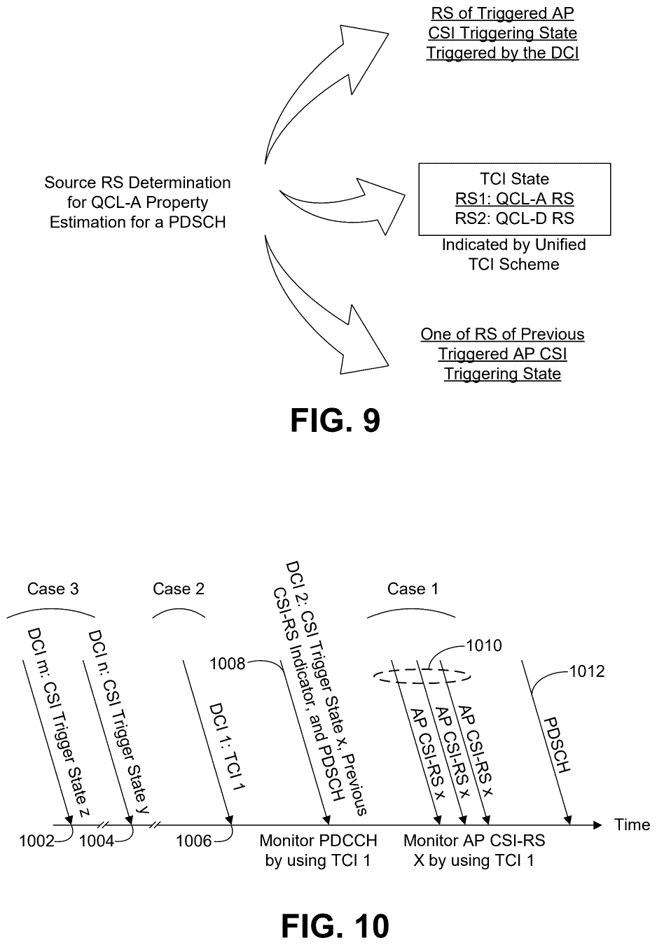

FIG. 9 is a source RS determination diagram illustrating examples of ways in which source RSs may be anchored for estimation of a QCL type A property, according to one or more embodiments of the present disclosure. As shown in FIG. 9, a source RS may be determined to be used for QCL type A property estimation by being anchored to the RS of a triggered AP CSI-RS triggering state which is triggered by DCI. As another example, a source RS may be determined to be used for QCL type A property estimation by being anchored to a unified TCI state. As another example, a source RS may be determined to be used for QCL type A property estimation by being anchored to the RS of a previously triggered AP CSI-RS.

For example, a previous CSI-RS indicator carried by a DCI scheduling PDSCH reception may indicate the source RS to be used for receiving the PDSCH. The previous CSI-RS indicator may indicate to the WTRU 102 to apply either the unified TCI state (e.g., indicated via R17 or R18 scheme unified TCI framework) or the RS of a previously triggered AP CSI state (e.g., for QCL-A property estimation for receiving another PDSCH).

In certain representative embodiments, a WTRU 102, taking the unified TCI framework as a baseline, may be configured with AP CSI-RS triggering states which can be triggered for QCL property estimation for PDSCH reception. The WTRU 102 may dynamically determine to apply either the triggered AP CSI-RS, the source RS of the Unified TCI state, or one of previous triggered AP CSI-RS as the source for receiving the PDSCH transmission.

For example, a WTRU 102 may report information indicating a flexible source RS determination related capability of the WTRU 102. For example, the capability may include a maximum number and/or types of estimated QCL properties the WTRU may store.

For example, the WTRU 102 may receive configuration information (e.g., via RRC) that includes information indicating multiple TCI states and an AP CSI trigger state configuration. The AP CSI trigger state configuration may include information indicating one or more AP CSI-RS trigger states. Each AP CSI-RS trigger state may be associated with (e.g., via a trigger state ID) an AP CSI-RS (e.g., for QCL-A). Any (e.g., each) AP CSI-RS trigger state may also be associated with (e.g., via a trigger state ID) a TCI state.

For example, the WTRU 102 may receive a first DCI that indicates a (e.g., unified) TCI state from the multiple TCI states.

For example, the WTRU 102 may receive a PDCCH transmission by applying the TCI state indicated by the first DCI. For example, the WTRU may use the QCL properties of the sources indicated by the applied TCI state to receive the PDCCH transmission.

For example, the WTRU 102 may receive, via the PDCCH transmission, a second DCI scheduling a PDSCH reception. The second DCI may include information indicating (i) a CSI trigger state indicator and/or (ii) a previous CSI-RS indicator. The CSI trigger state indicator may indicate whether an AP CSI-RS trigger state is triggered and, if so, which of the AP CSI-RS trigger states from the configured AP CSI-RS trigger states is triggered. As an example, if an AP CSI-RS trigger state is triggered, the CSI trigger state indicator indicates one of the configured AP CSI-RS trigger states. As an example, the previous CSI-RS indicator may indicate either a previous or one of multiple previous triggered AP CSI-RSs.

For example, the WTRU 102 may determine, based on the CSI trigger state indicator, whether an AP CSI trigger state is triggered. If an AP CSI trigger state is indicated, the WTRU 102 may receive the AP CSI-RS of the triggered state (e.g., by applying the unified TCI state) and determine one or more QCL properties of the received AP CSI-RS. If no AP CSI trigger state is indicated, the WTRU 102 may determine, based on the previous CSI-RS indicator, to apply either the unified TCI state or one of the previously triggered AP CSI (e.g., which was triggered for a previous PDSCH by a previous DCI 1_x) for QCL property determination (e.g., estimation).

For example, the WTRU 102 may receive the PDSCH transmission based on the determined QCL properties. As an example, the WTRU 102 may receive the PDSCH transmission using the determined QCL properties for a first QCL type (e.g., QCL-A) and the unified TCI state for a second QCL type (e.g., QCL-D).

FIG. 10 is a timing diagram showing various examples of how the QCL properties may be determined, according to one or more embodiments of the present disclosure. As shown in FIG. 10, a WTRU 102 may receive a DCI ‘m’ that includes information indicating that an AP CSI-RS trigger state ‘z’ is triggered at 1002. For example, the DCI may also schedule a respective PDSCH reception (e.g., which may be received using QCL properties determined based on the triggered AP CSI-RS trigger state ‘z’). The WTRU 102 may also receive a DCI ‘n’ that includes information indicating that an AP CSI-RS trigger state ‘y’ is triggered at 1004. For example, the DCI may also schedule a respective PDSCH reception (e.g., which may be received using QCL properties determined based on the triggered AP CSI-RS trigger state ‘y’). The WTRU 102 may receive a DCI ‘1’ (e.g., a first DCI) that includes information indicating a TCI state ‘1’ at 1006. The WTRU 102 may receive a DCI ‘2’ by monitoring the PDCCH by applying TCI state ‘1’ at 1008. The DCI ‘2’ may include information scheduling a respective PDSCH reception and may include information indicating a CSI trigger state ‘x’and a previous CSI-RS indicator.

In FIG. 10, as a first example, the WTRU 102 may receive the DCI ‘1’ that indicates that the AP CSI-RS trigger state ‘x’ is triggered (e.g., by the CSI trigger state indicator) at 1006. The WTRU 102 may then determine to monitor, by applying the indicated TCI state ‘1’, and receive one or more transmissions of AP CSI-RS ‘x’ at 1010 which is associated with the CSI trigger state ‘x’. The WTRU 102 may determine one or more QCL properties from the reception of the AP CSI-RS ‘x’. The WTRU 102 may receive the PDSCH transmission at 1012 using (e.g., at least) the determined QCL properties from the reception of the AP CSI-RS ‘x’ for a first QCL type (e.g., QCL-A).

In FIG. 10, as a second example, the WTRU 102 may receive the DCI ‘1’ that indicates that no AP CSI-RS trigger state is triggered (e.g., by the CSI trigger state indicator) at 1006. Based on the previous CSI-RS indicator included in DCI ‘1’, the WTRU 102 may then determine to receive the PDSCH transmission at 1012 using the indicated TCI state ‘1’.

In FIG. 10, as a third example, the WTRU 102 may receive the DCI ‘1’ that indicates that no AP CSI-RS trigger state is triggered (e.g., by the CSI trigger state indicator) at 1006. Based on the previous CSI-RS indicator included in DCI ‘1’, the WTRU 102 may determine to (e.g., reuse) one or more QCL properties which were determined for CSI trigger state ‘y’ and/or ‘z’. The WTRU 102 may receive the PDSCH transmission at 1012 using (e.g., at least) the determined QCL properties for a first QCL type (e.g., QCL-A).

In certain representative embodiments, a WTRU 102 may monitor a RS and estimate at least one QCL property for a channel, which may entail the WTRU 102 receiving the RS using associated resources and determining (e.g., measuring) each QCL property for the channel from the received RS.

### Terminology

“FF Beamforming” may be used herein to refer to a multi-antenna transmission/reception schemes that focus transmitted/received energy to/from an angular direction in the far field.
“FF beam” may be used herein to refer to a beam (e.g., in the FF) applying FF beamforming.
“gNB” may be used herein to refer to a network node, base station, or other access point. The node may, for instance, configure, control, and communicate with a WTRU 102. The node may terminate a communication protocol with the WTRU 102. Even though this term is used in 5G systems, the solutions described herein are not limited to 5G NR systems. “NF Beam-focusing” may be used herein to refer to multi-antenna transmission/reception schemes that focus transmitted/received energy to/from an angular direction and focus distance in the near-field.
“NF beam” may be used herein to refer to a beam (e.g., in the NF) to which NF beam-focusing is applied. NF beam and spot beam may be used interchangeably.
“TCI state” may be used herein to refer to (e.g., information indicating) which source (e.g., RS and/or channel) should be applied by a WTRU 102 for at least one specific type of QCL property and/or parameter estimation for a target (e.g., RS and/or channel) reception and/or transmission.
“TCI status” may be used herein to refer to a logical status of a TCI state which may be indicated by a gNB 180 and/or determined by a WTRU 102. The TCI status may be used by the WTRU 102 for determining whether to perform RS monitoring and for TCI state indicator interpretation.
“Source RS” may be used herein to refer to a (e.g., set of) RS (e.g., resources) associated with a TCI state, wherein the RS may include any of CSI-RS, SSB, SRS, DMRS, etc. For example, CSI-RS, SSB, SRS, and DMRS may be used interchangeably. The (e.g., set of) RS may be assumed to be QCL'ed with one or more target RSs. The one or more target RSs may be associated with a target channel (e.g., PDCCH, PDSCH, PUCCH, PUSCH, etc.). The target channel may be a channel that, or the associated target RS, has been indicated to be received/transmitted based on the TCI state. A source RS may be periodic, in which case an occasion to receive the source RS occurs periodically. A source RS may be semi-persistent, in which case an occasion to receive the source RS occurs periodically (e.g., as long as the source RS is activated). A source RS may be aperiodic, in which case an occasion to receive the source RS occurs aperiodically (e.g., following a trigger received by the WTRU 102). It is noted that, in the present disclosure, a WTRU 102 which is configured with (e.g., receives configuration information indicating) a source RS via a source RS configuration may be interpreted as the WTRU 102 being configured with a set of source RSs via the source RS configuration.
“Source RS monitoring” may be used herein to refer to WTRU 102 reception of one or more occasions of the source RS, or a subset of a set of source RSs. In some cases, such as during a time period, or for relatively infrequent occasions, the WTRU 102 receives the source RS on each occasion. In some cases, such as during a time period, or for relatively frequent occasions, the WTRU 102 receives the source RS on a first subset of the occasions but skips source RS reception in a second subset of the occasions. For example, the WTRU 102 may monitor a source RS to meet an application delay requirement for a TCI state that is in active status and that comprises the source RS. The WTRU 102 may need to monitor a source RS of the TCI state for particular QCL property estimation (e.g., any QCL type A property and/or QCL type D property). The application delay may be defined as the time between the WTRU 102 being indicated to apply the TCI state for a downlink channel reception, and the time the WTRU 102 is ready to apply the TCI state for the downlink channel reception. In some cases, the source RS monitoring may be interpreted as the WTRU 102 monitoring an AP CSI-RS to estimate a QCL property (e.g., the WTRU 102 performs reception of one or more occasions of an aperiodic CSI-RS resource or aperiodic CSI-RS resources triggered by an aperiodic CSI trigger state). That is, in some cases, the source RS may not be limited to be a source RS of a TCI state. For example, it may be represented as an AP CSI-RS triggered for the QCL property estimation.
“QCL-A property” and “QCL type A property” may be used interchangeably herein and may refer to one or more of Doppler shift, Doppler spread, Average delay and/or delay spread.
“QCL-A” and “QCL type A” may be used interchangeably herein.
“QCL-D property” and “QCL type D property” may be used interchangeably herein and may refer to spatial parameters (e.g., for reception). In one example, the spatial parameter may correspond to a spatial domain filter, such as a spatial reception filter and/or a spatial transmission filter. In one example, the spatial parameter may correspond to a WTRU 102 (e.g., transmit and/or receive) beam.
“QCL-D” and “QCL type D” may be used interchangeably herein.
“TCI state application delay” and “Beam Application Time (BAT)” and “TCI state switching delay” may be used interchangeably herein and may refer to a time interval between when the WTRU 102 receives a command to apply an activated TCI state and when the WTRU 102 is ready (e.g., capable) to apply the indicated TCI state.
“Active status” and “activated status” may be used interchangeably herein and may refer to a first TCI status of a TCI state. A TCI state in active status may be indicated to apply for downlink (e.g., RS and/or channel) reception and/or uplink (e.g., RS and/or channel) transmission. After a WTRU 102 receives a TCI state indicator indicating an active TCI state, the WTRU 102 should be able to apply the active TCI state within a TCI state application delay. The status may also be called an activated status.
“De-active status” and “deactivated status” may be used interchangeably herein and may refer to a second TCI status of a TCI state. A TCI state in de-active status can typically downlink (e.g., RS and/or channel) reception and/or uplink (e.g., RS and/or channel) transmission. That is, a WTRU 102 may not expect a de-active status TCI state to be indicated to apply for any downlink reception and/or uplink transmission.
“Semi-active status” and “semi-activated status” may be used interchangeably herein and may refer to a third TCI status of a TCI state. A TCI status switching delay for a TCI state from semi-active to active status may be shorter than from de-active to active.
“NF TCI state” may be used herein to refer to a first type of TCI state. For example, an NF TCI state may be a TCI state with a source (e.g., RS) that is associated with and/or transmitted by a NF beam. It is noted that, a WTRU 102 may determine a TCI state is a NF TCI state based on RRC configuration and/or via an implicit indication (e.g., according to the RS ID).
“FF TCI state” may be used herein to refer to a second type of TCI state. For example, a FF TCI state may be a TCI state with a source (e.g., RS) that is associated and/or transmitted with a FF beam. It is noted that, a WTRU 102 may determine a TCI state is a FF TCI state based on RRC configuration and/or via an implicit indication (e.g., according to the RS ID).
“Time duration”, “time interval” and “time period” may be used interchangeably herein and may be provided in units of radio frames, sub-frames, slots, sub-slot, symbols, seconds, and/or milliseconds.

### Configuration of AP CSI-RS for QCL Property Estimation

In certain representative embodiments, a WTRU 102 may receive configuration information indicating a plurality of AP CSI-RS trigger states (e.g., for QCL property estimation).

For example, to have accurate beam related information for a PDSCH reception, a WTRU 102 may need to perform QCL property estimation based on a source RS of the TCI state(s) indicated for the PDSCH reception. The source RS may be expected to be transmitted periodically when the source RS corresponding the TCI state is in active status (e.g., and semi-active status). Instead of periodically transmitting the source RS, to save source RS transmission overhead, a WTRU 102 may be configured with one or multiple AP CSI-RS trigger states for a (e.g., specific) QCL type (e.g., QCL-A) and/or property estimation. As examples, the one or more AP CSI-RS trigger states may be configured by broadcast, RRC and/or other lower layer signaling. One or more of the AP CSI-RS trigger state(s) may be triggered by the gNB 180 before a PDSCH reception. The WTRU 102 may apply the RS (e.g., CSI-RS) associated with the triggered AP CSI-RS trigger state for the (e.g., specific) QCL type property estimation. As an example, the WTRU 102 may perform a specific QCL type property estimation based on a CSI-RS of the triggered AP CSI-RS trigger state and then use the estimated result to receive the PDSCH. As an example, the WTRU 102 may determine to apply the CSI-RS of the triggered AP CSI-RS trigger state for the specific QCL type property estimation based on at least the configured AP CSI-RS trigger states.

In certain representative embodiments, a WTRU 102 may be configured with multiple AP CSI-RS trigger states for (e.g., a specific) QCL type property estimation. Which of the multiple AP CSI-RS trigger states is applied (e.g., for a PDSCH reception) may be dynamically indicated by the gNB 180 (e.g., before the PDCSH reception).

In certain representative embodiments, a WTRU 102 may be configured with a first set of (e.g., multiple) AP CSI-RS trigger states for a first QCL type property estimation, and configured with a second set of (e.g., multiple) AP CSI-RS trigger states for a second QCL type property estimation. The WTRU 102 may be indicated with which of the first AP CSI-RS trigger states is or are applied for the first QCL type property estimation and may be indicated with which of the second AP CSI-RS trigger states is or are applied for the second QCL type property estimation.

In certain representative embodiments, a WTRU 102 may be configured with a set of (e.g., multiple) AP CSI-RS trigger states. For example, the AP CSI-RS trigger states may not be associated with (e.g., only) specific (e.g., dedicated) QCL type properties estimation. One of more of the AP CSI-RS trigger states may be (e.g., dynamically) indicated, by the gNB 180, to be applied for (e.g., different) QCL types and/or properties estimation.

For example, a first one of the AP CSI-RS trigger states may be indicated for a first QCL type, and a second one of the AP CSI-RS trigger states may be indicated for a second QCL type.

For example, one of the AP CSI-RS trigger states may be indicated for both of a first QCL-type and a second QCL type.

In certain representative embodiments, a WTRU 102 may determine a subset of configured AP CSI-RS trigger states are to be applied for QCL property estimation.

For example, a WTRU 102 may be configured with a first amount of AP CSI-RS trigger states by the network (e.g., gNB 180). Within the first amount of AP CSI-RS trigger states, (e.g., only) a subset (e.g., a second amount) of AP CSI-RS trigger states may be applied for QCL property estimation. The second amount is equal to or less than the first amount. For example, the subset of the of AP CSI-RS trigger states may, but are not limited to, being explicitly indicated by the gNB based on RRC configuration. For example, while configuring each AP CSI-RS trigger state, the gNB 180 may indicate whether the configured AP CSI-RS trigger state belongs to the subset or not. In other words, WTRU 102 may be indicated, by the gNB 180, with information indicating which of the configured AP CSI-RS trigger states are for QCL property estimation.

In certain representative embodiments, a configured AP CSI-RS trigger state may be indicated to be applied for QCL property estimation by an explicit indicator (e.g., a QCL_Applied IE) carried by a RRC IE (e.g., CSI-AperiodicTriggerState IE) which configured the AP CSI-RS trigger state. That is, the WTRU 102 may determine an AP CSI-RS trigger state configured by a CSI-AperiodicTriggerState IE is for QCL property estimation if the CSI-AperiodicTriggerState IE carries a QCL_Applied IE.

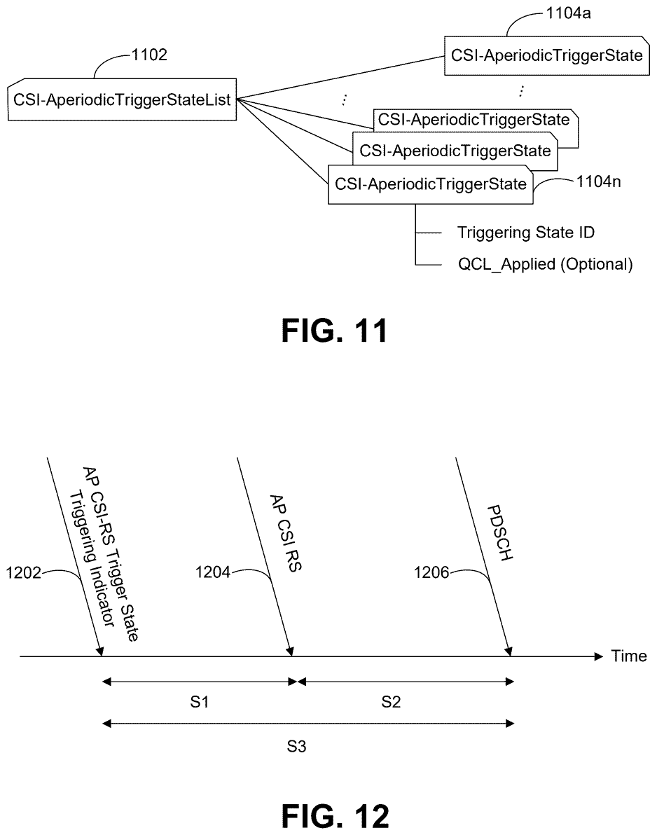

FIG. 11 is a general diagram illustrating another example configuration of AP CSI-RS trigger states, according to one or more embodiments of the present disclosure. In certain representative embodiments, a WTRU 102 can be configured with multiple AP CSI-RS trigger states (e.g., via CSI-AperiodicTriggerState IEs) of which each can indicate a RS (e.g., set), such as a SSB or CSI-RS resource, and a TCI state corresponding to the RS, such as (e.g., only) for AP CSI-RS. As shown in FIG. 11, a CSI-AperiodicTriggerStateList 1102 may be used to configure multiple AP CSI-RS trigger states (e.g., via CSI-AperiodicTriggerState IEs 1104a to 1104n). An AP CSI-RS trigger state may be identified by a triggering state ID. For example, the triggering state ID may associate a RS resource and a TCI state. As shown in FIG. 11, the AP CSI-RS trigger states (e.g., via CSI-AperiodicTriggerState IEs) may be indicates as being applicable for QCL property estimation by QCL_Applied IE.

In certain representative embodiments, the QCL_Applied IE may further indicate to the WTRU 102 which type of QCL property the WTRU 102 may estimate based on the AP CSI-RS trigger state. In other words, the QCL_Applied IE associated with an CSI-AperiodicTriggerState IE may indicate to WTRU 102 to determine a type of QCL property. An AP CSI-RS trigger state configured by the CSI-AperiodicTriggerState IE may be applied for the type of QCL property estimation.

In certain representative embodiments, a QCL_Applied IE may indicate to the WTRU 102 more than one QCL type. That is, an AP CSI-RS trigger state may be configured by a CSI-AperiodicTriggerState IE. The CSI-AperiodicTriggerState IE carries a QCL_Applied IE which may indicate more than one QCL type. The AP CSI-RS trigger state may be applied for more than one type of QCL property estimation.

As described herein, an AP CSI-RS trigger state may be applied for a type of QCL property estimation. For example, this may refer to the RS (i.e., CSI-RS) indicated by the AP CSI-RS trigger state being or is to be applied for the type of QCL property estimation.

In certain representative embodiments, a WTRU 102 may use a L1 codepoint to map to QCL-specific AP CSI-RS trigger states.

For example, after an AP CSI-RS trigger state is configured by the network (e.g., gNB 180), the AP CSI-RS trigger state may be indicated (e.g., by a CSI_Applied field carried by a DCI) to be applied for a specific type of QCL property estimation (e.g., for a PDSCH reception). The CSI-RS trigger state may be identified by a codepoint of the CSI_Applied field.

In certain representative embodiments, the codepoint of the CSI_Applied field may be associated with a triggering state ID of the AP CSI-RS trigger state. For example, the codepoint of the CSI_Applied field may be associated with a triggering state ID of the AP CSI-RS trigger state which is indicated with a QCL_Applied IE. For example, to save bit-width of the CSI_Applied field, the codepoint of the CSI_Applied field may be associated with a triggering state ID of the AP CSI-RS trigger state which is indicated with a QCL_Applied IE, and the AP CSI-RS trigger state may be indicated by a specific MAC CE (e.g., AP CSI Trigger for QCL MAC CE).

The triggering state ID may be an identity of the AP CSI-RS trigger state. The triggering state ID of an AP CSI-RS trigger state may be configured by a triggering state ID IE which is associated with the AP CSI-RS trigger state. For example, a triggering state ID of an AP CSI-RS trigger state may be configured by a triggering state ID IE which is carried by a CSI-AperiodicTriggerState IE of the AP CSI-RS trigger state.

In certain representative embodiments, each codepoint of a CSI_Applied field in the DCI is (e.g., one-to-one) associated with a configured AP CSI-RS trigger state. For example, each codepoint of the CSI_Applied field in the DCI may have a one-to-one association with a configured AP CSI-RS trigger state which indicated by an AP CSI Trigger for QCL MAC CE. That is, the WTRU 102 may be configured with multiple AP CSI-RS trigger states by RRC. One or more of the multiple AP CSI-RS trigger states may be indicated by the AP CSI Trigger for QCL MAC CE. Each of the one or more of the multiple AP CSI-RS trigger states indicated by the AP CSI Trigger for QCL MAC CE may be associated with one codepoint of the CSI request field.

In certain representative embodiments, a WTRU 102 may be configured with a first list of AP CSI-RS trigger states. Within the first list of AP CSI-RS trigger states, a second list of AP CSI-RS trigger states may be indicated to be applied for QCL property estimation by corresponding QCL_Applied IEs. The amount AP CSI-RS trigger states in the second list may be equal to or less than the amount of AP CSI-RS trigger state in the first list. That is, the AP CSI-RS trigger states in the second list are for QCL property estimation, but the AP CSI-RS trigger states in the first list which do not belong to the second list may be for other (e.g., general) usages (e.g., CSI measurement reporting). The codepoints of a CSI request field (e.g., as defined in 3GPP TS 38.212) in a DCI may be associated with AP CSI-RS trigger states which are not configured for QCL property estimation, and the AP CSI-RS trigger states are indicated by a Aperiodic CSI Trigger State Subselection MAC CE (e.g., as defined in 3GPP TS 38.321).

For example, each codepoints of a CSI request field in a DCI may be associated with an AP CSI-RS trigger state which is configured by a CSI-AperiodicTriggerState IE and the CSI-AperiodicTriggerState IE does not include a QCL_Applied IE. For example, each codepoint of a CSI request field in a DCI may be associated with a AP CSI-RS trigger state which is configured by a CSI-AperiodicTriggerState IE and the CSI-AperiodicTriggerState IE may not include a QCL_Applied IE, and the AP CSI-RS trigger state may be indicated by a Aperiodic CSI Trigger State Subselection MAC CE.

In certain representative embodiments, an AP CSI-RS trigger state may be configured by the network (e.g., gNB 180), and the AP CSI-RS trigger state may be configured to be applied for a specific serving cell, BWP, component carrier, and/or other resources and/or channels (e.g., PDSCH). A CSI_Applied field carried by a DCI may indicate to the WTRU 102 whether to apply the AP CSI-RS trigger state for the PDSCH reception.

In certain representative embodiments, the WTRU 102 may receive configuration information which indicates a pool of general AP CSI-RS Trigger states and QCL specific AP CSI-RS trigger states. In other representative embodiments, general AP CSI-RS Trigger states and QCL specific AP CSI-RS trigger states may be separately configured.

In certain representative embodiments, a WTRU 102 may track and/or determine a validity duration of any (e.g., stored) estimated QCL properties.

For example, a WTRU 102 may be configured by a gNB 180 with a QCL valid duration (e.g., one or multiple radio frames, sub-frames, slots, sub-slot, symbols, seconds, milliseconds) for (e.g., any) estimated QCL property which is stored by the WTRU 102. That is, the WTRU 102 may determine whether a QCL property valid to be applied based on at least the QCL valid duration.

For example, a WTRU 102 may be configured with a first QCL valid duration to be applied for a first type of QCL property validity determination and a second QCL valid duration to be applied for a second type of QCL property validity determination.

### UE Capability for Flexible Source RS Determination

In certain representative embodiments, a WTRU 102 may send (e.g., report) capability information to the network (e.g., gNB 180, TRP, or other base station). The capability information may indicate one or more capabilities of the WTRU 102 which relate to source RS determination (e.g., for determining one or more properties of one or more QCL types). For example, the WTRU 102 may indicate whether the WTRU 102 supports dynamic RS determination.

In certain representative embodiments, a WTRU 102 may send capability information such as a hybrid field operation corresponding capability (e.g., to the gNB 180). For example, the capability information related to hybrid field operation may include information indicating any of the following.

For example, the WTRU 102 may send hybrid field operation corresponding capability information which indicates support of estimating (e.g., particular) type(s) of uplink and/or downlink QCL properties, such as for a downlink channel reception (e.g., PDSCH) based on AP CSI-RS.

For example, the WTRU 102 may send hybrid field operation corresponding capability information which indicates support of estimating (e.g., particular) type(s) of QCL properties for PDSCH reception based on triggered and/or transmitted AP CSI-RS(s).

For example, the WTRU 102 may send hybrid field operation corresponding capability information which indicates a (e.g., maximum) number of serving cells, bandwidth parts (BWPs), component carriers, and/or other resources or channels that are supported for estimating (e.g., particular) type(s) of QCL properties, such as for downlink channel reception (e.g., PDSCH). In some embodiments, the estimation (e.g., determination and/or measurement) of the QCL properties may be based on (e.g., triggered and/or transmitted) AP CSI-RS(s).

For example, the WTRU 102 may send hybrid field operation corresponding capability information which indicates a (e.g., maximum) number of serving cells, BWPs, component carriers, and/or other resources or channels that can simultaneously enable the estimating (e.g., particular) type(s) of QCL properties, such as for a downlink channel reception (e.g., PDSCH). In some embodiments, the estimation (e.g., determination and/or measurement) of the QCL properties may be based on (e.g., triggered and/or transmitted) AP CSI-RS(s).

For example, the WTRU 102 may send hybrid field operation corresponding capability information which indicates support of estimating (e.g., particular) type(s) of QCL properties, such as for a PDSCH reception, based on AP CSI-RS which is triggered at a particular time duration before the downlink channel reception.

For example, the WTRU 102 may send hybrid field operation corresponding capability information which indicates support of estimating (e.g., particular) type(s) of QCL properties, such for a PDSCH reception, based on AP CSI-RS which is triggered at a particular time duration before a scheduling DCI (e.g., for downlink channel reception).

For example, the WTRU 102 may send hybrid field operation corresponding capability information which indicates a minimum time duration (e.g., S1), and/or maximum time duration, between a reception of an AP CSI-RS trigger state triggering indicator and a reception of the AP CSI-RS of the triggered AP CSI-RS trigger state.

For example, the WTRU 102 may send hybrid field operation corresponding capability information which indicates a minimum time duration (e.g., S2), and/or maximum time duration, between a reception of an AP CSI-RS of a triggered AP CSI-RS trigger state and PDSCH reception.

For example, the WTRU 102 may send hybrid field operation corresponding capability information which indicates a minimum time duration (e.g., S3), and/or maximum time duration, between a reception of an AP CSI-RS trigger state triggering indicator and PDSCH reception.

FIG. 12 is a timing diagram illustrating various examples of time durations associated with AP-CSI RS triggering and PDSCH reception, according to one or more embodiments of the present disclosure. As shown in FIG. 12, a WTRU 102 may receive (e.g., in DCI scheduling PDSCH reception) an AP CSI-RS trigger state triggering indicator at 1202. The WTRU 102 may support a minimum time duration between the reception of an AP CSI-RS trigger state triggering indicator and a reception at 1204 of the AP CSI-RS of the triggered AP CSI-RS trigger state. This minimum time duration may be WTRU-specific and/or may be referred to as S1 as in FIG. 12. As another example, the WTRU 102 may support a minimum time duration between a reception at 1204 of the AP CSI-RS of the triggered AP CSI-RS trigger state and PDSCH reception at 1206. This minimum time duration may be WTRU-specific and/or may be referred to as S2 as in FIG. 12. As another example, the WTRU 102 may support a minimum time duration between the reception at 1202 of the AP CSI-RS trigger state triggering indicator and PDSCH reception. At 1206 This minimum time duration may be WTRU-specific and/or may be referred to as S3 as in FIG. 12.

In certain representative embodiments, a WTRU 102 may take into consideration any of the time durations in FIG. 12 (e.g., any of S1, S2, and/or S3) when determining an applicable (e.g., source) RS to use for QCL properties to apply when receiving a downlink (e.g., PDSCH) transmission, and/or sending an uplink transmission.

In certain representative embodiments, a WTRU 102 may send (e.g., report) capability information indicating an amount (e.g., quantity) of QCL estimation results, and/or time information associated therewith, that are supported (e.g., stored at the WTRU 102).

For example, a WTRU 102 may be indicated to apply an AP CSI-RS for QCL property estimation for a PDSCH reception. The AP CSI-RS may be associated with an AP CSI-RS trigger state which may be triggered before the PDSCH reception. That is, the AP CSI-RS may be transmitted before the PDSCH, and the WTRU 102 may perform QCL property estimation based on the AP CSI-RS. One or more of the estimated QCL properties may not only be applied for the PDSCH reception but may also be kept (e.g., stored) by the WTRU 102 for other usage(s). For example, one or more of the estimated QCL properties may be applied for a later (e.g., next) PDSCH reception.

For example, the WTRU 102 may send (e.g., report) capability information (e.g., related to hybrid field operation) which indicates any of the following.

For example, the capability information may include information indicating support of storing one or more (e.g., particular) type(s) of) QCL properties associated with AP CSI-RS trigger state.

For example, the capability information may include information indicating a (e.g., maximum) set of QCL properties the WTRU 102 can keep. As an example, the set of QCL properties may be defined as the QCL properties estimated based on an AP CSI-RS trigger state. For example, two sets of QCL properties may be correspond to the QCL properties estimated based on two AP CSI-RS trigger states, respectively.

For example, the capability information may include information indicating how long (e.g., time duration) the WTRU 102 can keep (e.g., store) the QCL properties.

### Triggering AP CSI-RS for QCL Property Estimation

In certain representative embodiments, a WTRU 102 may receive information triggering AP CSI-RS for QCL property estimation. For example, an AP CSI-RS trigger state may be used for triggering AP CSI-RS for QCL property estimation, such as for PDSCH reception. For example, a WTRU 102 may use one or more explicit indicators and/or one or more implicit indicators to determine whether an AP CSI-RS trigger state and/or an AP CSI-RS is triggered (e.g., by the network).

In certain representative embodiments, an AP CSI-RS may be triggered by any of the following. For example, an AP CSI-RS may be triggered by a DCI which schedules PDSCH reception. For example, the AP CSI-RS may be triggered by at least one field included in the DCI which schedules PDSCH reception. For example, the AP CSI-RS may be triggered by at least one field (e.g., CSI_Applied and/or CSI request) included in a DCI transmitted before PDSCH reception. For example, the AP CSI-RS may be triggered by at least one field (e.g., CSI_Applied and/or CSI request) included in a DCI which schedules the PDSCH reception.

In certain representative embodiments, a WTRU 102 may receive information explicitly indicating triggering AP CSI-RS for QCL property estimation.

In certain representative embodiments, a DCI field (e.g., CSI_Applied field) may indicate one or more triggering state IDs. A WTRU 102 may determine that an AP CSI-RS trigger state is triggered if the Triggering state ID of the AP CSI-RS trigger state is indicated by the DCI, such as carried by the CSI_Applied field.

For example, each code point of the DCI field (e.g., CSI_Applied field) may be associated with a triggering state ID of a subset of configured AP CSI-RS trigger states. The subset of configured AP CSI-RS trigger states may be configured for QCL property estimation. That is, the WTRU 102 may be configured with a first number and/or set of AP CSI-RS trigger states, and each code point of the CSI_Applied field may be associated with a triggering state ID of a second number and/or subset of AP CSI-RS trigger states. The first number of AP CSI-RS trigger states may be a subset of the second number of AP CSI-RS trigger states.

In certain representative embodiments, a WTRU 102 may receive information implicitly indicating triggering AP CSI-RS for QCL property estimation. For example, to save the AP CSI-RS trigger state triggering signaling overhead, the AP CSI-RS trigger state may be implicitly triggered, such as based on time duration(s).

In certain representative embodiments, an AP CSI-RS trigger state for QCL property estimation may be triggered by the CSI request field. For example, by setting the CSI request field as a reserved, default, or dedicated value, the CSI request field may trigger the AP CSI-RS trigger state.

In certain representative embodiments, an AP CSI-RS trigger state for QCL property estimation may be determined as triggered where the WTRU 102 received a DCI triggering the AP CSI-RS trigger state and scheduling a PDSCH reception, and the time interval between the DCI and the PDSCH reception is equal to or greater than a time duration (e.g., S3).

In certain representative embodiments, an AP CSI-RS trigger state for QCL property estimation may be determined as triggered if the WTRU 102 received a DCI triggering the AP CSI-RS trigger state and scheduling a PDSCH reception, and the time interval between the AP CSI-RS reception and the PDSCH reception is equal to or greater than a time duration (e.g., S2).

In certain representative embodiments, an AP CSI-RS trigger state for QCL property estimation may be determined as triggered if the WTRU 102 determines reception of the DCI scheduling PDSCH reception, the AP CSI-RS occasions, and the PDSCH reception satisfy a combination of time durations (e.g., any of S1, S2, and/or S3).

In certain representative embodiments, a WTRU 102 may receive information indicating QCL type-specific triggering of AP CSI-RS for QCL property estimation.

In certain representative embodiments, an AP CSI-RS trigger state may be triggered for a (e.g., specific) type of QCL property estimation, such as for a PDSCH reception. That is, the AP CSI-RS of the triggered AP CSI-RS trigger state may be determined to be applied for (e.g., only) a specific type and/or property (e.g., only QCL-A or one or more properties thereof) of QCL property estimation for the PDSCH reception. For example, the WTRU 102 may apply a different RS for one or more other types (e.g., QCL-D) of QCL property estimation for the PDSCH reception. As an example, the specific type may be explicit indicated by the DCI which triggers the AP CSI-RS trigger state and/or may be indicated by RRC configuration, such as the configuration information which configured the AP CSI-RS trigger states.

### Determination of Source for QCL-A Property Estimation

In certain representative embodiments, a WTRU 102 may determine a source (e.g., RS) for estimation of one or more QCL type A properties.

For example, taking the unified TCI framework as a baseline, a WTRU 102 may be (e.g., dynamically) indicated with a unified TCI state. For example, the unified TCI state may be interpreted as a TCI state which is indicated by the gNB 180 (e.g., via layer 2 (L2) and/or L1 signaling) to be applied for multiple channels (e.g., PDCCH and PDSCH). After the WTRU 102 is indicated with the unified TCI state, the WTRU 102 may apply the unified TCI state for the multiple channels. The unified TCI state may be (e.g., dynamically) switched by the gNB 180, such as via dynamic signaling. The WTRU 102 may need to apply the latest indicated unified TCI state for multiple channels (e.g., after a HARQ-ACK transmission in response to the received indication indicating the latest unified TCI state).

In certain representative embodiments, implementation of the unified TCI framework may have benefits of saving signaling overhead on indicating TCI states for multiple channels. That is, a gNB 180 may not need to indicate separate TCI states for multiple channels individually. Sill, the unified TCI framework may lose flexibility on indicating different TCI states for different channels (e.g., if needed). For example, a WTRU 102 may, (e.g., occasionally) in a hybrid field or NF, need to adopt a NF TCI state for PDSCH while adopting a FF TCI state for PDCCH. For example, the WTRU 102 may, in FF, need to adopt a FF TCI state for both PDSCH and PDCCH.

In certain representative embodiments, a WTRU 102 may determine whether, or not, to apply a unified TCI state.

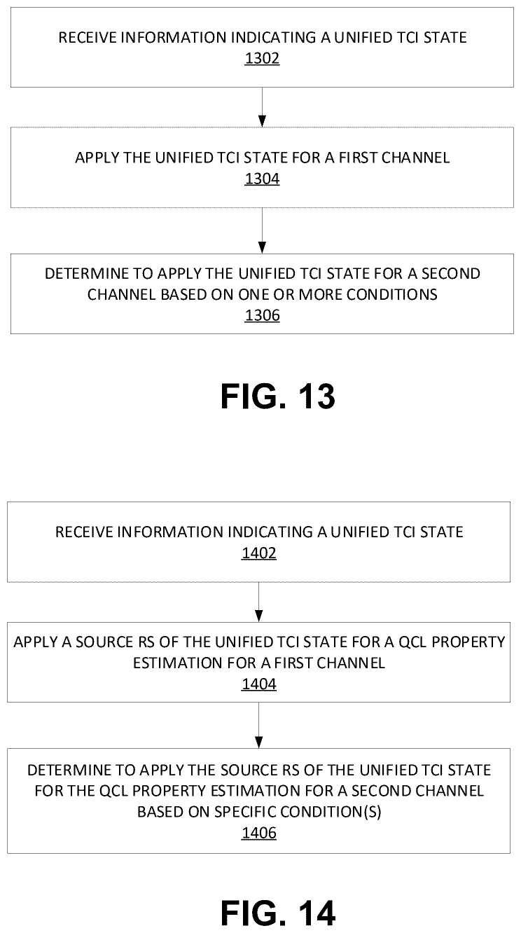

FIG. 13 is a procedural diagram illustrating an example procedure to determine whether or not to apply a unified TCI state, according to one or more embodiments of the present disclosure. As shown in FIG. 13, a WTRU 102 may receive information indicating a unified TCI state (e.g., by a gNB 180) at 1302. At 1304, the WTRU may apply the unified TCI state for a first channel. For example, the WTRU 102 may receive a transmission via (e.g., monitoring) the first channel using the applied unified TCI state. As an example, the transmission may be received using QCL source information associated with the unified TCI state. At 1306, the WTRU 102 may determine whether, or not, to apply the unified TCI state for a second channel based on one or more (e.g., specific) conditions. For example, the WTRU 102 may receive another transmission via the second channel after determining to apply unified TCI state for the second channel.

In certain representative embodiments, the unified TCI state may be applied to receive transmissions (e.g., for downlink channels). In certain other representative embodiments, the unified TCI state may be applied to send transmissions (e.g., for uplink channels).

In certain representative embodiments, a WTRU 102 may receive information indicating a FF TCI state as a unified TCI state. The WTRU 102 may apply the FF TCI state for both of PDCCH (e.g., monitoring) and PDSCH (e.g., reception). When the WTRU 102 moves into a hybrid field, or NF, the FF TCI state may not be suitable for PDSCH reception. Hence, the WTRU 102 may need to dynamically determine whether to apply the unified TCI state for the PDSCH (e.g., while applying the unified TCI sate for the PDCCH monitoring).

For example, a WTRU 102 may be indicated with a unified TCI state, and apply the unified TCI state to perform PDCCH monitoring. The WTRU 102 may receive a DCI including information scheduling a PDSCH reception. The WTRU 102 may dynamically determine whether to apply the unified TCI sate for the PDSCH reception (e.g., even when the WTRU 102 was indicated with the unified TCI state).

As an example, the WTRU 102 may determine whether to apply a source RS of the unified TCI state for QCL property estimation for the PDSCH reception. For example, the source RS may be, but is not limited to, a subset of source RSs configured to be associated with the unified TCI state.

In certain representative embodiments, a WTRU 102 may receive information indicating a unified TCI state, and apply the unified TCI state for PDCCH monitoring. The WTRU 102 may receive a DCI on the PDCCH, and the DCI schedules a PDSCH reception. The WTRU 102 may dynamically determine whether to apply the unified TCI sate for the PDSCH reception based on one or more condition(s). For example, the WTRU 102 may determine to apply the unified TCI state for the PDSCH reception, or apply both of the unified TCI state and at least one or more of other TCI states for the PDSCH reception.

In certain representative embodiments, a WTRU 102 may determine whether to apply a source RS of the unified TCI state.

FIG. 14 is a procedural diagram illustrating an example procedure to determine whether or not to apply a source RS of a unified TCI state, according to one or more embodiments of the present disclosure. As shown in FIG. 14, a WTRU 102 may receive information indicating a unified TCI state at 1402. For example, the unified TCI state may be configured (e.g., associated) with one or more source RSs for one or more type(s) of QCL property estimation. At 1404, the WTRU 102 may apply a source RS of the unified TCI state for at least one QCL property estimation for a first channel. For example, the WTRU 102 may monitor the first channel based on the estimated QCL property. The WTRU 102 may receive a transmission via the monitored first channel. At 1406, the WTRU 102 may determine to apply the source RS of the unified TCI state for the QCL property estimation for a second channel based on specific condition(s).

In certain representative embodiments, a WTRU 102 may dynamically determine whether to apply a particular (e.g., type of) source RS of the unified TCI state for a particular type of QCL property estimation for the PDSCH reception.

For example, the WTRU 102 is indicated with the unified TCI state. The unified TCI state is configured to be associated with a first source RS for a first type QCL property (e.g., QCL-A) and a second source RS for a second type QCL property (e.g., QCL-D). The WTRU 102 may dynamically determine whether to apply the first source RS for the first type QCL property estimation for the PDSCH reception.

In certain representative embodiments, a WTRU 102 may apply a subset of source RSs of the unified TCI state for a first type of QCL property estimation (e.g., for the PDSCH reception), and may (e.g., dynamically) determine whether to apply another RS for a second type of QCL property estimation for the PDSCH reception. For example, the WTRU 102 may dynamically determine whether to apply both a particular (e.g., type of) source RS of the unified TCI state and another RS for QCL properties estimation for the PDSCH reception. The determination may be based on one or more conditions.

For example, a WTRU 102 may be indicated with the unified TCI state. The unified TCI state may be associated with a first source RS for a first type of QCL property (e.g., QCL-D) and a second source RS for a second type of QCL property (e.g., QCL-A).

For example, the WTRU 102 may apply the first source RS for the first type of QCL property estimation for the PDSCH reception, and the WTRU 102 may determine whether to apply the other source RS(s) for the second type of QCL property estimation for the PDSCH reception.

For example, the WTRU 102 may dynamically determine whether to apply the first source RS for the first type of QCL property estimation and apply the other source RS for the first type QCL property estimation for the PDSCH reception.

In certain representative embodiments, a WTRU 102 may determine to apply one or more other RSs (e.g., AP CSI-RSs) for QCL property estimation (e.g., for PDSCH reception). For example, besides the source RS of the unified TCI state, the WTRU 102 may apply other RSs for QCL property estimation for PDSCH reception. That is, for example, the WTRU 102 may apply a source RS for QCL property estimation for the PDSCH reception, and the source RS may not be configured to be associated with the unified TCI state and/or other TCI state(s).

In certain representative embodiments, a WTRU 102 may apply an AP CSI-RS for QCL property estimation for PDSCH reception. The AP CSI-RS may be, but is not limited to, be configured by the network (e.g., gNB 180) via one or more configurations (e.g., in a CSI-AperiodicTriggerState IE).

For example, the WTRU 102 may determine whether to apply the AP CSI-RS for QCL property estimation for the PDSCH reception. The determination may, but is not limited to, be determined based on one or more conditions.

In certain representative embodiments, a WTRU 102 may use one or more conditions to determine whether to apply a source (e.g., RS) for QCL property estimation. For example, the one or more conditions may include any of the following.

For example, the WTRU 102 may consider whether the WTRU 102 receives information indicating to apply: (i) the unified TCI state for the PDSCH reception; (ii) a source RS of the unified TCI state for the QCL property estimation for the PDSCH reception; (iii) the QCL-A, or QCL-D, or a specific QCL type source RS of the unified TCI state for the QCL-A property estimation for the PDSCH reception, (iv) one or more of other RSs for the QCL property estimation for the PDSCH reception; and/or (v) one or more of other RSs for QCL-A, or QCL-D, or a specific QCL type property estimation for the PDSCH reception.

For example, the WTRU 102 may receive information indicating the TCI state, QCL type, source RS, and/or QCL property to be estimated via any of: (i) the DCI which scheduled the PDSCH reception; (ii) one or more field(s) in the DCI scheduling the PDSCH reception (e.g., CSI Applied field); a particular type of MAC CE (e.g., a MAC CE which enables the mapping of the source RS and a codepoint in DCI, or a MAC CE which activates the corresponding source RS); and/or (iv) one or more indicator(s) carried by the DCI scheduling the PDSCH reception.

For example, the WTRU 102 may determine whether one or more of AP CSI-RS trigger states have been triggered (e.g., by DCI).

For example, the WTRU 102 may determine whether a time duration between the DCI scheduling the PDSCH reception and the PDSCH reception satisfies a threshold.

In certain representative embodiments, a WTRU 102 may be indicated (e.g., by the DCI which schedules a PDSCH reception) to apply the unified TCI state for the PDSCH reception. For example, the WTRU 102 may be indicated by one or more fields in the DCI to apply the unified TCI state for the PDSCH reception. For example, the WTRU 102 may not apply the unified TCI state for the PDSCH reception if the one or more fields in the DCI do not indicate to apply the unified TCI state.

As an example, the DCI may include a CSI_Applied field. The CSI_Applied field may indicate at least one AP CSI-RS trigger state. The WTRU 102 may (e.g., determine to) apply the AP CSI-RS of the indicated AP CSI-RS trigger state for the PDSCH reception. The WTRU 102 may (e.g., determine to) apply the unified TCI state for the PDSCH reception if the CSI_Applied field did not indicate any AP CSI-RS trigger state or if the CSI_Applied field indicates a reserved value.

In certain representative embodiments, a WTRU 102 may be indicated (e.g., by the DCI which schedules a PDSCH reception) to apply the source RS of the unified TCI state for the PDSCH reception. The WTRU 102 may be indicated by one or more fields in the DCI. The WTRU 102 may not (e.g., determine to) apply the source RS of the Unified TCI state for the PDSCH reception if the was not indicated by the DCI.

As an example, the DCI may include a CSI_Applied field, and the CSI_Applied field may indicate at least one of AP CSI-RS trigger state. The WTRU 102 may apply the AP CSI-RS of the indicated AP CSI-RS trigger state for the PDSCH reception. The WTRU 102 may apply the source RS of the unified TCI state for the PDSCH reception if the CSI_Applied field did not indicate any AP CSI-RS trigger state, or if the CSI_Applied field indicates a reserved value. For example, one or more reserved values may be configured, pre-defined, and/or pre-specified. As an example, one or more reserved values may be specified by 3GPP technical specification(s).

In certain representative embodiments, a WTRU 102 may be indicated (e.g., by the DCI which schedules a PDSCH reception) to apply one or more of other RSs for QCL property estimation for the PDSCH reception. The WTRU 102 may be indicated by one or more field(s) in the DCI. The WTRU 102 may not apply the one or more of other RS for QCL property estimation for the PDSCCH reception if indicated to so by the DCI.

In certain representative embodiments, a WTRU 102 may be indicated (e.g., by the DCI which schedules a PDSCH reception) to apply the unified TCI state for the PDSCH reception if (e.g., as a condition) the time duration between the DCI and the PDSCH is equal to or less than a threshold (e.g., S3). The WTRU 102 may determine not to apply the Unified TCI state for the PDSCH reception if the time duration between the DCI and the PDSCH is equal to or greater than the threshold (e.g., S3).

In certain representative embodiment, a WTRU 102 may determine whether to apply a unified TCI state or to apply an AP CSI-RS. For example, the WTRU 102 may receive a DCI scheduling a PDSCH reception and may determine (e.g., before receiving the PDSCH transmission) which one or more RSs are to be applied (e.g., for each type of) QCL property estimation for the PDSCH reception.

For example, the WTRU 102 may need to determine whether to apply a source RS of the unified TCI state for particular type(s) of QCL property estimation for the PDSCH reception.

For example, the WTRU 102 may need to determine whether to apply an AP CSI-RS (e.g., of an AP CSI-RS trigger state) for particular type(s) of QCL property estimation for the PDSCH reception. The WTRU 102 may need to determine whether the AP CSI-RS trigger state is triggered.

For example, the WTRU 102 may determine to apply the AP CSI-RS of an AP CSI-RS trigger state for the PDSCH reception if a triggering state ID is carried by the DCI scheduling the PDSCH. As an example, the WTRU 102 may determine to apply the AP CSI-RS of the AP CSI-RS trigger state for the PDSCH reception if the DCI includes information indicating an AP CSI-RS trigger state which is configured for QCL property estimation.

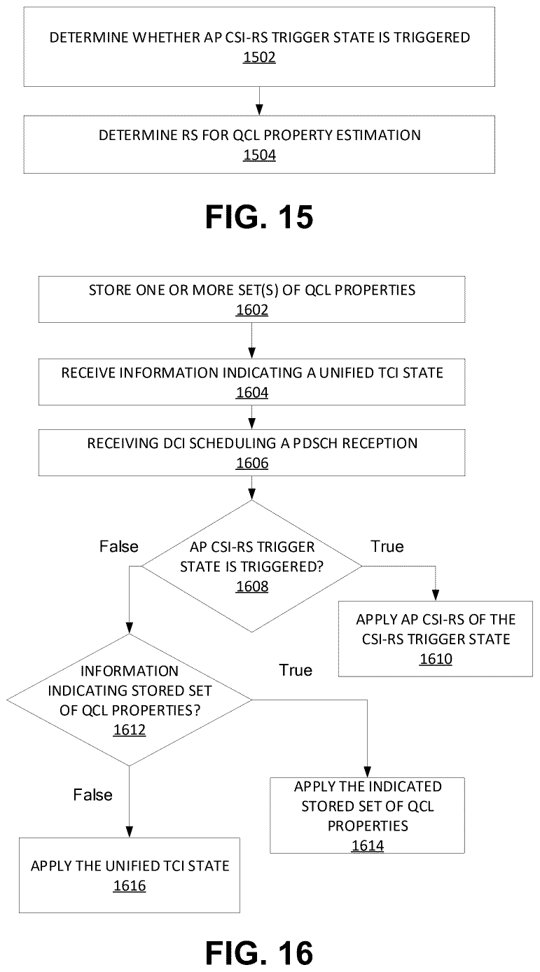

FIG. 15 is a procedural diagram illustrating an example procedure for determining an RS to be applied for QCL property estimation, according to one or more embodiments of the present disclosure. As shown in FIG. 15, a WTRU 102 may determine whether an AP CSI-RS trigger state is triggered at 1502. At 1504, the WTRU 102 may determine the (e.g., source) RS to be applied for QCL (e.g., QCL-A) property estimation (e.g., for PDSCH reception). For example, the WTRU 102 may determine which RS is to be applied for the particular type of QCL property estimation for the PDSCH reception based on whether the AP CSI-RS trigger state is triggered or not.

For example, if the AP CSI-RS trigger state is triggered, the WTRU 102 may further determine either to apply the AP CSI-RS of the AP CSI-RS trigger state or to apply the source RS of the unified TCI state for the particular type of QCL property estimation for the PDSCH reception. That is, if the AP CSI-RS trigger state is not triggered, the WTRU 102 may determine to apply the source RS of the unified TCI state for the particular type of QCL property estimation for the PDSCH reception.

For example, even if the AP CSI-RS trigger state is triggered (e.g., triggered by CSI_Applied field), the WTRU 102 may determine whether to apply the AP CSI-RS of the AP CSI-RS trigger state for the PDSCH reception. As examples, the determination may be based on one or more following: (i) one or more of indicators carried by the DCI scheduling the PDSCH reception; one or more of the indicators carried by the DCI triggering the AP CSI-RS trigger state; and/or (iii) time durations (e.g., S1, S2 and/or S3) and the corresponding WTRU 102 capabilities.

For example, the WTRU 102 may be indicated by information indicated by the DCI. A DCI field may indicate to the WTRU 102 whether to apply the AP CSI-RS of an AP CSI-RS trigger state indicated by the CSI_Applied for the PDSCH reception.

For example, the WTRU 102 may determine to apply the AP CSI-RS of an AP CSI-RS trigger state for the PDSCH reception if the time duration between the DCI and the PDSCH is equal to or greater than a threshold time duration (e.g., S3).

For example, the WTRU 102 may determine to apply the AP CSI-RS of an AP CSI-RS trigger state for the PDSCH reception if the time duration between the AP CSI-RS and the PDSCH is equal to or greater than a threshold time duration (e.g., S2).

For example, the WTRU 102 may determine to apply the AP CSI-RS of an AP CSI-RS trigger state for the PDSCH reception if the time duration between the DCI and the AP CSI-RS is equal to or greater than a threshold time duration (e.g., S1).

In certain representative embodiments, a WTRU 102 may determine whether to apply a triggered AP CSI-RS or to apply a previous (e.g., estimated) AP CSI-RS. For example, an AP CSI-RS may be triggered for a (e.g., particular) type of QCL property estimation for a PDSCH reception. In some cases, to trigger an AP CSI-RS trigger state for each PDSCH transmissions may increase the corresponding RS transmission overhead. Furthermore, the reception of a triggered AP CSI-RS prior to the PDSCH reception may also increase the WTRU 102 overhead on RS monitoring as well as the minimum delay between a PDCCH and a corresponding PDSCH. To estimate a QCL property for PDSCH reception, the WTRU 102 may at least require some preparation and/or processing time for the AP CSI-RS reception. That is, after receiving the PDCCH carrying the AP CSI-RS triggering information, the WTRU 102 may need at least a period of time to receive the AP CSI-RS, and then based on the received AP CSI-RS to receive the corresponding PDSCH. Hence, it may be beneficial for a QCL property estimated based on an AP CSI-RS of a triggered AP CSI-RS trigger state to be stored and/or reused for a later PDSCH reception.

For example, a WTRU 102 may be scheduled with a first PDSCH reception, and the reception of the first PDSCH is at least based on a first type of QCL property estimated based on an AP CSI-RS of a first AP CSI-RS trigger state. The AP CSI-RS of the first AP CSI-RS trigger state may have been applied for the first type of QCL property estimation before the first PDSCH.

For example, a WTRU 102 may be scheduled with a first PDSCH reception, and the reception of the first PDSCH may at least be based on a QCL-A property estimated based on an AP CSI-RS of a first AP CSI-RS trigger state which was triggered before the first PDSCH reception. After the first PDSCH reception, the WTRU 102 may be scheduled with a second PDSCH reception. The WTRU 102 may determine whether to apply the estimated QCL-A property (e.g., estimated based on the AP CSI-RS of the first AP CSI-RS trigger state for the first PDSCH) for the second PDSCH reception based on any one or more of following. The WTRU 102 may may determine whether, or not, to apply the estimated QCL-A property based on whether an AP CSI-RS trigger state is triggered for the second PDCSH reception. The WTRU 102 may may determine whether, or not, to apply the estimated QCL-A property based on whether the DCI scheduling the second PDSCH has indicated the WTRU 102 to apply the estimated QCL-A property (e.g., estimated based on the AP CSI-RS of the first AP CSI-RS trigger state for the first PDSCH) for the second PDSCH reception. For example, the WTRU 102 may receive a previous CSI-RS indicator which may indicate to the WTRU 102 whether to apply the estimated QCL-A property (e.g., estimated based on the AP CSI-RS of the first AP CSI-RS trigger state for the first PDSCH) for the second PDSCH reception;

In some representative embodiments, the AP CSI-RS of the first AP CSI-RS trigger state may be received by the WTRU 102 without the scheduling and/or reception of the first PDSCH. For example, the AP CSI-RS may be triggered by a DCI that does not schedule a PDSCH. In some representative embodiments, the AP CSI-RS timing in relation to the first PDSCH may be such that any QCL property estimated from the AP CSI-RS may not be able to be applied to the reception of the first PDSCH (e.g., if the AP CSI-RS is received after the first PDSCH). In certain representative embodiments, the WTRU 102 may determine to apply the QCL-A property estimated based on the AP CSI-RS of the first AP CSI-RS trigger state and to apply the QCL-D property estimated based on source RS of the unified TCI state for the PDSCH reception.

In certain representative embodiments, a WTRU 102 may determine which (e.g., one) of previous AP CSI-RSs of AP CSI-RS trigger states is to be applied. To save RS transmission overhead (e.g., further), the WTRU 102 may apply a QCL-A property estimated based on the AP CSI-RS of the first AP CSI-RS trigger state for a third PDSCH reception which is transmitted after the second PDSCH reception.

As an example, a WTRU 102 may be scheduled with a first PDSCH reception, and the reception of the first PDSCH may be at least based on a QCL property estimated based on an AP CSI-RS of an AP CSI-RS trigger state which was triggered for the first PDSCH reception. After the first PDSCH reception, the WTRU 102 may be scheduled with a second PDSCH reception. The WTRU 102 may determine to apply the estimated QCL-A property (e.g., estimated based on the AP CSI-RS of the first AP CSI-RS trigger state for the first PDCSH) for the second PDSCH reception. Afterward, the WTRU 102 may be scheduled with a third PDSCH reception, and the third PDSCH reception may be after the second PDSCH reception. The WTRU 102 may determine to apply the QCL property estimated based on the AP CSI-RS of the AP CSI-RS trigger state for the third PDSCH reception.

As another example, a WTRU 102 may be scheduled with a first PDSCH reception. The reception of the first PDSCH may be at least based on a first QCL property estimated based on an AP CSI-RS of a first AP CSI-RS trigger state which was triggered for the first PDSCH reception. After the first PDSCH reception, the WTRU 102 may be scheduled with a second PDSCH reception. The reception of the second PDSCH may be at least based on a second QCL property estimated based on an AP CSI-RS of a second AP CSI-RS trigger state which was triggered for the second PDSCH reception. Afterward, the WTRU 102 may be scheduled with a third PDSCH reception. The third PDSCH reception may be later than the second PDSCH reception. The WTRU 102 may determine to apply either one of, or both of, the QCL properties estimated based on one of, or both of, the first QCL property and the second QCL property for receiving the third PDSCH (e.g., based on one or more conditions).

For example, the one or more condition to determine which QCL property to apply may be based on any of the following. The WTRU 102 may use an explicit approach and/or an implicit approach. As one example of an explicit approach, the WTRU 102 may receive a previous CSI-RS indicator from the network (e.g., gNB 180), and the previous CSI-RS indicator may indicate to the WTRU 102 whether to apply one of the first QCL property or the second QCL property. As one example of an explicit approach, the WTRU 102 may receive a previous CSI-RS indicator from the network (e.g., gNB 180), and the previous CSI-RS indicator may indicate WTRU 102 whether to apply both of the first and the second QCL properties. As one example of an implicit approach, one or more of the codepoints of the CSI_Applied and/or the CSI request field may be reserved for the corresponding indication. For example, the WTRU 102 may determine to apply the first QCL property if the CSI_Applied and/or CSI request field is set to a first reserved codepoint, and the WTRU 102 may determine to apply the second QCL property if the CSI_Applied and/or CSI request field is set to a second reserved codepoint. For example, the first and the second codepoints may be, but are not limited to being, pre-configured by RRC or pre-defined by specification. For example, the WTRU 102 may determine to apply both the first and second QCL properties if the CSI_Applied and/or CSI request field is set to a reserved codepoint. For example, the codepoint may be, but is not limited to being, pre-configured by RRC or pre-defined by specification.

In certain representative embodiments, the previous CSI-RS indicator may be applied by the gNB 180 to indicate to the WTRU 102 whether to apply one of multiple previous estimated QCL properties for the PDSCH reception. For example, the WTRU 102 may be capable of storing multiple sets of estimated QCL properties, and the previous CSI-RS indicator may indicate to the WTRU 102 to apply one or more of the multiple sets of estimated QCL properties for the PDSCH reception.

In some representative embodiments, the previous CSI-RS indicator may be carried by a DCI. The DCI may be, but is not limited to, the DCI which scheduled the PDSCH reception. For example, the previous CSI-RS indicator may be one of the fields carried by the DCI.

In certain representative embodiments, a WTRU 102 may store multiple sets of estimated QCL properties. Each set of estimated QCL properties may contain more than one type of QCL property. The WTRU 102 may be indicated, such as by a previous CSI-RS indicator, with one of the multiple sets of estimated QCL properties. In some representative embodiments, within the indicated set of estimated QCL properties, the WTRU 102 may be further indicated, such as by a previous QCL type indicator, to apply one of the types of QCL properties for the PDSCH reception. For example, a WTRU 102 that keeps an estimated QCL property may be refer to the WTRU 102 saving the estimated QCL property in order to apply the saved estimated QCL property for later usage. For example, to apply a saved estimated QCL property for a PDSCH reception.

For example, a WTRU 102 may store a first set of QCL properties and a second set of QCL properties. The first set of QCL properties may include a first type of QCL property and/or a second type of QCL property. The second set of QCL property may include a first type of QCL property and/or a second type of QCL property. The WTRU 102 may be indicated with one of the first and/or second set of QCL properties, such as by the previous CSI-RS indicator. Within the indicated set of QCL properties, the WTRU 102 may be further indicated, such as by the previous QCL type indicator, to apply one or both of the first and second types of QCL properties.

In certain representative embodiments, a WTRU 102 may determine whether to apply a unified TCI state, to apply a (e.g., triggered) AP CSI-RS, and/or to apply a previous AP CSI-RS.

In certain representative embodiments, a WTRU 102 may WTRU 102 be scheduled by the network (e.g., gNB 180) for a PDSCH reception. Before the PDSCH reception, the WTRU 102 may determine to apply either one or more of the following for the PDSCH reception: (i) a QCL property estimated based on the source RS of the unified TCI state; (ii) a QCL property estimated based on the AP CSI-RS of the triggered AP CSI-RS trigger state; and/or (iii) one of the QCL properties of the stored set of QCL properties.

FIG. 16 is a procedural diagram illustrating an example procedure to determine whether to apply a unified TCI state, to apply a (e.g., triggered) AP CSI-RS, and/or to apply a previous AP CSI-RS, according to one or more embodiments of the present disclosure. As shown in FIG. 16, a WTRU 102 may store (e.g., keep) or more sets of one or more QCL properties which may be estimated based on AP CSI-RS(s) of triggered AP CSI-RS trigger state(s) at 1602. At 1604, the WTRU 102 may receive information indicating a unified TCI state from the network (e.g., gNB 180). For example, the WTRU 102 may apply the unified TCI state for PDCCH monitoring. The WTRU 102 may monitor the PDCCH for a transmission and receive a DCI scheduling a PDCSH reception at 1606. Based on at least the DCI, the WTRU 102 may determine whether an AP CSI-RS trigger state is triggered at 1608. If an AP CSI-RS trigger state is triggered, the WTRU 102 may apply the AP CSI-RS of the AP CSI-RS trigger state for QCL property estimation for PDSCH reception at 1610. If no AP CSI-RS trigger state is triggered (e.g., by the DCI), the WTRU 102 may determine whether one or more of the stored set of QCL properties is indicated (e.g., by the DCI) at 1612. If one or more of the stored set of QCL properties is indicated, the WTRU 102 may apply the indicated set of QCL properties for the PDSCH reception at 1614. Otherwise, the WTRU 102 may apply the unified TCI state for the PDSCH reception at 1616.

In another example procedure, an AP CSI-RS trigger state may be triggered at 1608. The WTRU 102 may further determine an applicable RS to apply for the scheduled PDSCH reception following the triggering of the AP CSI-RS trigger state. For example, the DCI which schedules the PDSCH reception at 1606 may carry information indicating to the WTRU 102 how to determine the applicable RS to apply. Various examples of indicators which may be carried by the DCI are described herein.

As one example, following the triggering of the AP CSI-RS trigger state, the WTRU 102 may determine at least one of the stored set of QCL properties is (e.g., further) indicated by the scheduling DCI and may apply the indicated stored set of QCL properties for the PDSCH reception.

As another example, following the triggering of the AP CSI-RS trigger state, the WTRU 102 may determine that the unified TCI state is (e.g., further) indicated by the scheduling DCI and may apply the unified TCI state (e.g., as both QCL-A and QCL-D properties) for the PDSCH reception.

As another example, following the triggering of the AP CSI-RS trigger state, the WTRU 102 may determine that the AP CSI-RS of the AP CSI-RS trigger state is (e.g., further) indicated for QCL property estimation. The WTRU 102 may apply the estimated QCL properties of the AP CSI-RS (e.g., as QCL-A properties) for the PDSCH reception.

As another (e.g., alternative) example, the WTRU 102 may determine a (e.g., source) RS, to apply for receiving the scheduled PDSCH transmission based (e.g., only) on a time duration between the received DCI at 1606 and the PDSCH transmission.

In certain representative embodiments, the WTRU 102 may have store one or more sets of QCL-A properties which may be estimated based on AP CSI-RS(s) of (e.g., previously) triggered AP CSI-RS trigger state(s). The WTRU 102 may be indicated with a unified TCI state by the gNB 180. The WTRU 102 may estimate one or more QCL-A properties and/or a QCL-D property based on the source RS of the unified TCI state. The WTRU 102 may monitor the PDCCH based on the QCL-A and/or QCL-D properties estimated based on the unified TCI state. The WTRU 102 may receive a DCI scheduling a PDCSH reception. Based on at least information indicated by the DCI, the WTRU 102 may determine whether an AP CSI-RS trigger state is triggered. If an AP CSI-RS trigger state is triggered, the WTRU 102 may apply at least the AP CSI-RS of the AP CSI-RS trigger state for QCL-A property estimation for PDSCH reception. For example, the WTRU 102 may receive the PDSCH transmission based on: (i) one or more QCL-A properties estimated based on the triggered AP CSI-RS trigger state; and (ii) the QCL-D property estimated based on the unified TCI state.

If no AP CSI-RS trigger state is triggered (e.g., by the DCI), or an AP CSI-RS trigger state is triggered but the time duration between the AP CSI-RS and the PDSCH is shorter than a time duration threshold (e.g., S2), the WTRU 102 may determine whether one or more of stored sets of QCL-A properties are indicated (e.g., by the DCI). If at least one stored set of QCL-A properties is indicated, the WTRU 102 may apply at least the indicated set of QCL-A properties for the PDSCH reception. That is, the WTRU 102 may receive the PDSCH based on: (i) the indicated set of QCL-A properties, and (ii) the QCL-D property estimated based on unified TCI state.

If no stored set of QCL-A properties is indicated (e.g., by the DCI), the WTRU 102 may apply the QCL-A and QCL-D properties estimated based on the unified TCI state for the PDSCH reception.

### Validity of QCL-A Properties

In certain representative embodiments, a WTRU 102 may determine the validity of a QCL property. For example, to save RS transmission overhead and/or RS measurement overhead, the WTRU 102 may store estimated QCL properties to be used for later reception and/or transmission. However, the stored QCL properties may not be valid indefinitely. For example, the WTRU 102 may have mobility, and the channel and/or channel statistics may change over time. Hence, the stored QCL properties may lose accuracy as time passes and/or due to mobility. Hence, it may be beneficial to the WTRU 102 to verify the validity of the stored estimated QCL properties before applying them (e.g., for PDSCH reception).

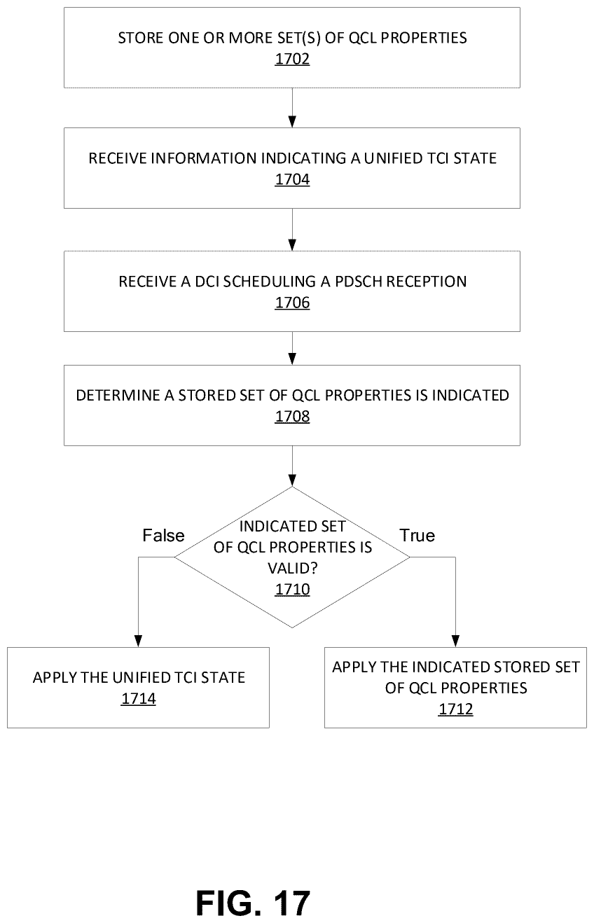

FIG. 17 is a procedural diagram illustrating an example procedure to determine whether to apply one or more estimated QCL properties, according to one or more embodiments of the present disclosure. At 1702, a WTRU 102 may store one or more sets of QCL properties, such as which may be estimated based on AP CSI-RS(s) of triggered AP CSI-RS trigger state(s). At 1704, the WTRU 102 may receive information indicating a unified TCI state by the network (e.g., gNB 180). For example, the WTRU 102 may apply the unified TCI state for PDCCH monitoring. The WTRU 102 may receive a DCI scheduling a PDCSH reception 1706. Based on at least the DCI, the WTRU 102 may determine that there is a stored set of QCL properties that is indicated (e.g., by the DCI) at 1708. Then, the WTRU 102 may determine whether the indicated set of QCL properties is valid at 1710. If it is valid, the WTRU 102 may apply the indicated set of QCL properties (e.g., for the PDSCH reception) at 1712. Otherwise, the WTRU 102 may apply the unified TCI state (e.g., for the PDSCH reception) at 1714.

In certain representative embodiments, the WTRU 102 may store one or more sets of QCL-A properties which may be estimated based on AP CSI-RS(s) of triggered AP CSI-RS trigger state(s). The WTRU 102 may be indicated with a unified TCI state by the gNB 180. For example, the WTRU 102 may be indicated with and/or apply the unified TCI state before estimating the stored sets of QCL-A properties. The WTRU 102 may estimate both a QCL-A and a QCL-D property based on a source RS of the unified TCI state. The WTRU 102 may monitor for a PDCCH transmission based on the QCL-A and QCL-D properties. The WTRU 102 may receive a DCI scheduling a PDCSH reception. Based on at least the DCI, the WTRU 102 may determine that a stored set of QCL-A properties is indicated. Then, the WTRU 102 may determine whether the indicated set of QCL properties is valid. If valid, the WTRU 102 may receive the scheduled PDSCH transmission based on: (i) the stored set of QCL-A properties which is indicated; and (ii) the QCL-D property estimated based on the unified TCI state. Otherwise, the WTRU 102 may apply the QCL-A and QCL-D estimated based on the unified TCI state for the PDSCH reception.

In certain representative embodiments, a WTRU 102 may use one or more conditions to determine whether one or more indicated QCL properties are valid. For example, the WTRU 102 may use any of the following to validate at least one stored QCL property or set thereof.

In some representative embodiments, the WTRU 102 may verify the validity of the stored QCL properties based on at least a time elapsed since the stored QCL properties have (e.g., each) been estimated (e.g., the end of corresponding AP CSI-RS transmission). For example, the WTRU 102 may determine the stored QCL properties are invalid if the time elapsed since the stored QCL properties were estimated is longer than a threshold (e.g., QCL valid duration). The WTRU 102 may determine the stored QCL properties are valid if the time elapsed since the stored QCL properties were estimated is equal to or shorter than a threshold (e.g., QCL valid duration).

In some representative embodiments, the WTRU 102 may verify the validity of the stored QCL properties based on at least whether the unified TCI state has been updated or changed since the stored QCL properties were estimated. For example, the WTRU 102 may determine that the stored QCL properties are invalid if the latest indicated or applied unified TCI state is different than an indicated or applied unified TCI state at the time the stored QCL properties were estimated. The WTRU 102 may determine the stored QCL properties are valid if the latest indicated Unified TCI state is the same as the indicated Unified TCI state at the time the stored QCL properties were estimated.

In some representative embodiments, the WTRU 102 may verify the validity of the stored QCL properties based on at least a specific type (e.g., QCL-D) of source RS of the unified TCI state. For example, the WTRU 102 may verify the validity of the stored QCL properties based on whether the specific type of source RS of the unified TCI state is same as the specific type of source RS of a unified TCI state which is indicated to be applied at the time WTRU 102 estimated the stored QCL properties. For example, the WTRU 102 may be indicated to apply a first unified TCI state which is associated with at least a first QCL-D source RS. Then, the WTRU 102 may be indicated that a first AP CSI-RS trigger state is triggered. The WTRU 102 estimates QCL-A properties based on a first AP CSI-RS of the first AP CSI-RS trigger state. Afterward, the WTRU 102 may keep the estimated QCL-A properties (e.g., in a buffer or as a list). In case the WTRU 102 needs to verify the validity of the stored estimated QCL properties, the WTRU 102 may determine whether the latest unified TCI state is either the same as the first unified TCI state or the latest unified TCI state is associated with a second QCL-D source RS and the second QCL-D source RS is same as the first QCL-D source RS. If this is true, the WTRU 102 may determine that the stored QCL properties are valid, otherwise the WTRU 102 may determine the stored QCL properties are invalid.

In some representative embodiments, the WTRU 102 may verify the validity of the stored QCL properties based on at least a Kept QCL validity indicator received from the gNB 180. The Kept QCL validity indicator may indicate to the WTRU 102 whether one, some, or all of the stored sets of QCL properties are valid or not. For example, the WTRU 102 may determine whether one, some, or all of the stored sets of QCL properties are invalid if the Kept QCL validity indicator indicates a first value. The WTRU 102 may determine whether one, some, or all of the stored sets of QCL properties are valid if the Kept QCL validity indicator indicates a second value. For example, the Kept QCL validity indicator may be carried by a DCI. As an example, the Kept QCL validity indicator may be, but is not limited to being, carried by the DCI which schedule the PDSCH reception.

In some representative embodiments, the Kept QCL validity indicator may be implicitly implemented by one or more fields in the DCI. For example, the WTRU 102 may determine whether one, some, or all of the stored sets of QCL properties are invalid, or not, if the CSI_Applied field is set to a particular value.

In certain representative embodiments, a WTRU 102 may manage the stored QCL properties. For example, after the WTRU 102 determines a stored QCL property is invalid, the WTRU 102 may clear and/or discard the QCL property.

As an example, the WTRU 102 may receive a (e.g., specific) indication from the gNB 180 to clear a specific stored set of QCL properties. After receiving the indication, the WTRU 102 may clear the set of QCL properties which are identified by the indication.

As an example, the WTRU 102 may receive a (e.g., specific) indication from the gNB 180 to clear any (e.g., all) of the sets of QCL properties. After receiving the indication, the WTRU 102 may clear any (e.g., all) of the sets of QCL properties.

In certain representative embodiments, a WTRU 102 may report information associated with the stored QCL properties.

For example, in response to the WTRU 102 determining that one or more stored (e.g., sets of) QCL properties are invalid, the WTRU 102 may report the determination result to the gNB 180. The WTRU 102 may report the determination result to the gNB 180 after the WTRU 102 clears (e.g., discards) the stored QCL properties.

For example, in response to the WTRU 102 receiving a Kept QCL validity indicator indicating a stored QCL property is invalid, the WTRU 102 may report to the gNB 180 after the WTRU 102 clears after the WTRU 102 clears (e.g., discards) the indicated QCL properties.

### Anchoring a TCI State with Another TCI State

In certain representative embodiments, a WTRU 102 may receive information indicating a TCI state is anchored with another TCI state. For example, the WTRU 102 may receive configuration information indicating anchoring information associated with one or more TCI states.

In certain representative embodiments, a WTRU 102 may receive configuration information indicating a TCI state is anchored for QCL property estimation. For example, to facilitate the RS transmission and/or the RS monitoring management for a WTRU 102, the WTRU 102 may be indicated to anchor a first TCI state to a second TCI state. For example, anchoring a first TCI state to a second TCI state may refer to associating the first TCI state with the second TCI state. For example, the configuration information may be, or included, may be received by RRC signaling (e.g., a RRC configuration).

In certain representative embodiments, a WTRU 102 may be configured by the network (e.g., gNB 180), such as via RRC, to associate a first TCI state to another TCI state from a source RS perspective. That is, for example, the WTRU 102 may be indicated by the gNB to anchor a first TCI state to a second TCI state for a particular QCL type of source RS. After the anchoring relationship between multiple TCI states is indicated by the gNB, an estimated (e.g., particular) type of QCL property may be shared and/or reused for the multiple TCI state (e.g., in some situations).

In certain representative embodiments, a WTRU 102 may receive information indicating that a first TCI state may be anchored to a second TCI state. A QCL-A property estimated based on a QCL-A source RS of the second TCI state may be used by the first TCI state. That is, for example, the WTRU 102 may be indicated by the gNB to apply the first TCI state, such as for a PDSCH reception. The WTRU 102 may apply (e.g., according to the anchoring information) the estimated QCL-A property which has been estimated based on the second TCI state, such as for the PDSCH reception.

In certain representative embodiments, a WTRU 102 may be configured (e.g., by the gNB 180) to anchor a first TCI state to a second TCI state for a first type of QCL property and anchor the first TCI state to a third TCI state for a second type of QCL property. Afterward, the WTRU 102 may be indicated to apply the first TCI state, such as for a PDSCH reception. Then, the WTRU 102 may (e.g., according to the anchoring information) apply the first type of QCL property estimated based on the second TCI state and apply the second type of QCL property estimated based on the third TCI state, such as for the PDSCH reception.

In certain representative embodiments, a WTRU 102 may be configured (e.g., by the gNB 180) with a first TCI state, a second TCI state, and a third TCI state. The WTRU 102 may be (e.g., further) indicated (e.g., via RRC configuration) that the first TCI state may be anchored with the second TCI state for a QCL-A source RS and the first TCI state may be anchored with the third TCI state for a QCL-D source RS. That is, the WTRU 102 may be configured by the gNB 180 with a QCL type which depends on anchoring information (e.g., an indication) for a TCI state. For example, based on a QCL type dependent anchoring indication, the WTRU 102 may determine a TCI state is anchored with another TCI state for a particular type of QCL source RS.

In certain representative embodiments, a WTRU 102 may be configured (e.g., by the gNB 180) with a first TCI state, a second TCI state, and a third TCI state (e.g., via a RRC configuration). The first TCI state may be anchored with the second TCI state for a QCL-A source RS and the first TCI state may be anchored with the third TCI state for a QCL-D source RS. The WTRU 102 may monitor the QCL-A source RS of the second TCI state for the QCL-A property for the first TCI state. That is, the WTRU 102 may estimate the QCL-A property for the first TCI state based on (e.g., using) the QCL-A source RS of the second TCI state. The WTRU 102 may monitor the QCL-D source RS of the third TCI state for QCL-D property for the first TCI state. That is, the WTRU 102 may estimate the QCL-D property for the first TCI state based on (e.g., using) the QCL-D source RS of the third TCI state.

In certain representative embodiments, a WTRU 102 may be configured with one-to-many anchoring information (e.g., by RRC). For example, to enable the flexibility of anchoring TCI states, a WTRU 102 may be configured (e.g., by the gNB 180) to anchor a TCI state with more than one other TCI state, such as for a particular type of QCL property. After the configuration, the WTRU 102 may be dynamically indicated to apply different anchored TCI states, such as for the particular type of QCL property.

For example, a WTRU 102 may be configured with a first TCI state which is associated with a first source RS, a second TCI state which is associated with a second source RS, and a third TCI state which is associated with a third source RS. The WTRU 102 may be further configured (e.g., by the gNB 180) that the first TCI state is anchored with both the second TCI state and the third TCI state (e.g., for a type of QCL). The WTRU 102 may be further (e.g., dynamically) indicated to apply either the second TCI state or the third TCI state for the type of QCL property. As an example, the WTRU 102 may be dynamically indicated by the gNB, via either MAC CE or DCI, to apply the second source RS or the third source RS for the type of QCL property estimation.

For example, the WTRU 102 may be configured to anchor a TCI state with a first set of TCI states for a first type of QCL property, and anchor the TCI state with a second set of TCI states for a second type of QCL property. The WTRU 102 may be (e.g., dynamically) indicated to apply one of the first set of TCI states for a first type of QCL property estimation and be indicated to apply one of the second set of TCI states for a second type of QCL property estimation.

In certain representative embodiments, a WTRU 102 may receive anchoring information based on L2 signaling. For example, a WTRU 102 may be indicated that a first TCI state is anchored with a second TCI state by an Anchoring MAC CE. For example, the Anchoring MAC CE may carry information indicating a first TCI state ID of the first TCI state, a second TCI state ID of the second TCI state, and one or more indicators (e.g., that indicate at least one QCL type and/or at least one TCI status). For example, the WTRU 102 may be indicated that the first TCI state is anchored with the second TCI state. As an example, the L2 signaling may include a QCL type indicator that indicates at least one QCL type. As an example, the L2 signaling may include an Applicable TCI status indicator that indicates at least one TCI status.

In certain representative embodiments, a WTRU 102 may receive an Anchoring MAC CE that includes information indicating a first TCI state ID, a second TCI state ID, and a QCL type indicator. The WTRU 102 may determine that a first TCI state is anchored with a second TCI state for a type of QCL, or property thereof, which is identified by the QCL type indicator. For example, the first TCI state may be identified by the first TCI state ID and the second TCI state may be identified by the second TCI state ID.

In certain representative embodiments, a WTRU 102 may receive an Anchoring MAC CE that includes information indicating a first TCI state ID, a second TCI state ID and an Applicable TCI status indicator. The WTRU 102 may determine that a first TCI state is anchored with a second TCI state if the second TCI state is in a (e.g., specific) TCI status. The first TCI state may be identified by the first TCI state ID and the second TCI state may be identified by the second TCI state ID. The TCI status may be identified by the Applicable TCI status indicator.

In certain representative embodiments, a WTRU 102 may receive an Anchoring MAC CE that includes information indicating a first TCI state ID, a second TCI state ID, a QCL type indicator, and an Applicable TCI status indicator. The WTRU 102 may determine that a first TCI state is anchored with a second TCI state for a type of QCL, or property thereof, if the second TCI state is in a (e.g., specific) TCI status. The first TCI state may be identified by the first TCI state ID and the second TCI state may be identified by the second TCI state ID. The TCI status may be identified by the Applicable TCI status indicator. The type of QCL property may be identified by the QCL type indicator.

In certain representative embodiments, a WTRU 102 may perform QCL property estimation which is dependent on TCI status.

In certain representative embodiments, a WTRU 102 may be configured with a first TCI state, a second TCI state, and a third TCI state, such as by the gNB (e.g., via a RRC configuration). The first TCI state may be configured (e.g., associated) with at least a first source RS for QCL-A property estimation, and a second source RS for QCL-D property estimation. The second TCI state may be configured with at least a third source RS for QCL-A property estimation. The third TCI state may be configured with at least a fourth source RS for QCL-D property estimation. The WTRU 102 may be indicated (e.g., based on the RRC configuration) that the first TCI state is anchored with the second TCI state for QCL-A and/or the first TCI state is anchored with the third TCI state for QCL-D. The WTRU 102 may monitor the third source RS to determine (e.g., gather) the QCL-A property for the first TCI state if the second TCI state is in a first TCI status (e.g., active status).

For example, the WTRU 102 may monitor the first source RS to determine (e.g., gather) the QCL-A property for the first TCI state if the second TCI state is in a second TCI status (e.g., semi-active and/or inactive status). As an example, the WTRU 102 may estimate the QCL-A property for the first TCI state based on the QCL-A source RS of the second TCI state if the second TCI state is in the first TCI status. In other words, the WTRU 102 may estimate the QCL-A property for the first TCI state based on the QCL-A source RS of the first TCI state if the second TCI state is in the second TCI status.

For example, the WTRU 102 may monitor the fourth source RS for QCL-D property for the first TCI state if the third TCI state is in a first TCI status (e.g., active status). The WTRU 102 may monitor the second source RS for QCL-D property for the first TCI state if the third TCI state is in a second TCI status (e.g., semi-active and/or inactive status). As an example, the WTRU 102 may estimate QCL-D property for the first TCI state based on the QCL-D source RS of the third TCI state if the third TCI state is in the first TCI status. The WTRU 102 may estimate QCL-D property for the first TCI state based on the QCL-D source RS of the first TCI state if the second TCI state is in the second TCI status.

In certain representative embodiments, a WTRU 102 may determine to apply an anchored TCI state based on a TCI status. For example, a WTRU 102 may be configured with a first TCI state, a second TCI state and a third TCI state (e.g., by the gNB 180 via a RRC configuration). The WTRU 102 may receive configuration information that indicates to the WTRU 102 that the first TCI state is associated with at least a first source RS, the second TCI state is associated with at least a second source RS, and the third TCI state is associated with at least a third source RS. The configuration information may also indicate to the WTRU 102 the first TCI state is anchored with the second TCI state for a first type of QCL, or property thereof, and the first TCI state is anchored with the third TCI state for a second type of QCL, of property thereof.

As an example, the WTRU 102 may be indicated that the second TCI state is the unified TCI state. After, the WTRU 102 may apply the second TCI state for PDCCH monitoring. The WTRU 102 may receive a DCI via the monitoring of the PDCCH, and the DCI may include information scheduling a PDSCH reception. The WTRU 102 may determine to apply either the second TCI state (e.g., the unified TCI state) or the first TCI state for the PDSCH reception based on the TCI status. The WTRU 102 may determine to apply the first TCI state for the PDSCH reception if the third TCI state is in a first TCI status (e.g., active). The WTRU 102 may determine to apply the second TCI state for the PDSCH reception if the third TCI state is in a second TCI status (e.g., semi-active or inactive).

As an example, a first TCI state (e.g., ‘TCI 1’) may be anchored with a second TCI state (e.g., ‘TCI 2’) for a first QCL type (e.g., QCL-D). The first TCI state may be anchored with a third TCI state (e.g., ‘TCI 3’) for a second QCL type (e.g., QCL-A). A WTRU may receive information that TCI 2 is indicated as the unified TCI state (e.g., for PDCCH and PDSCH). The WTRU 102 may apply the second TCI state for PDCCH monitoring. The WTRU 102 may determine to apply either the first TCI state or the second TCI state for PDSCH depending on the TCI status of the third TCI state.

### Multi-TRP Scenarios

In certain representative embodiments, a WTRU 102 may operate in a multi-TRP system. For example, the WTRU 102 may perform a two-stage RS determination for QCL property estimation.

In certain representative embodiments, a WTRU 102 may apply the unified TCI framework for a multi-TRP scenario. For example, a WTRU 102 may (e.g., dynamically) determine to apply either a triggered AP CSI-RS (e.g., the AP CSI-RS of a triggered AP CSI-RS trigger state) or a source RS of the unified TCI state of different TRPs for PDSCH reception (e.g., based on a gNB indication). For example, a unified TCI state of a TRP may refer to the unified TCI state which is associated with the TRP.

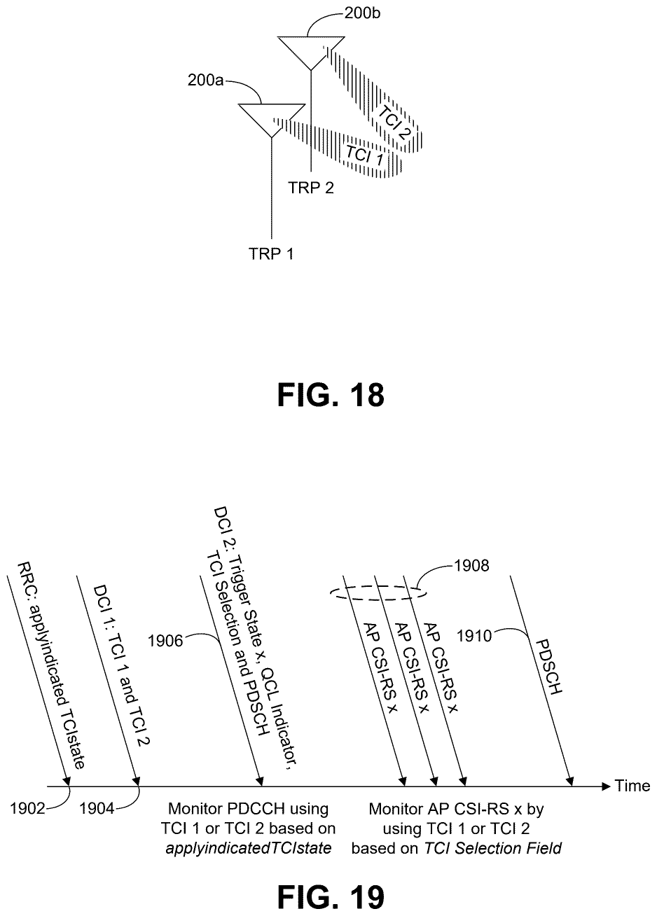

FIG. 18 is a system diagram illustrating an example unified TCI state for a multi-TRP scenario, according to one or more embodiments of the present disclosure. As shown in FIG. 18, a WTRU 102 may perform multi-TRP communication where a first TRP (e.g., ‘TRP 1’) 200a uses a first TCI state (e.g., ‘TCI 1) and a second TRP (e.g., ‘TRP 2’) 200b uses a second TCI state (e.g., ‘TCI 2’) as a unified TCI state. For example, the unified TCI state may be implicitly indicated to be associated with the TRPs.

In certain representative embodiments, the WTRU 102 may only identify which TCI state is indicated to be applied may not be (e.g., configured to) identify which TRP the TCI state is associated with.

In certain other representative embodiments, the WTRU 102 may be indicated with multiple TCI states to be applied. Each of the multiple TCI states may be implicitly associated with different TRPs (e.g., which may not be visible to the WTRU 102). For example, multiple TCI states corresponding to a TCI field codepoint may be ordered (e.g., a first TCI state and a second TCI state where the first TCI state may correspond to a first TRP and the second TCI state may correspond to a second TRP).

In certain representative embodiments, a WTRU 102 may determine to apply either the source RS of the unified TCI state or apply the AP CSI-RS of a triggered AP CSI-RS trigger state, such as for a scheduled PDSCH reception. For example, the WTRU 102 may determine, based on information (e.g., one or more indicators) carried by a DCI, to apply either the source RS of the Unified TCI state or apply the AP CSI-RS of a triggered AP CSI-RS trigger state for a PDSCH scheduled by the DCI.

In some representative embodiments, the one or more indicators may include a QCL indicator field. For example, a first value of the QCL indicator field may indicate to the WTRU 102 to either apply the source RS of the unified TCI state for the PDSCH reception, and a second value of the QCL indicator field may indicate to the WTRU 102 to apply the AP CSI-RS of the triggered AP CSI-RS trigger state for the PDSCH reception. Various examples of the determination to apply either the source RS of the Unified TCI state or apply the AP CSI-RS of a triggered AP CSI-RS trigger state are described elsewhere herein.

In certain representative embodiments, a WTRU 102 may determine a TCI state to be applied for monitoring the AP CSI-RS of a triggered AP CSI-RS trigger state. For example, the WTRU 102 may determine a TCI state and apply a QCL property, which is estimated based on at least a source RS of the determined TCI state, to monitor the AP CSI-RS of a triggered AP CSI-RS trigger state for the PDSCH reception.

FIG. 19 is a timing diagram illustrating an example procedure to determine a source RS for a multi-TRP scenario, according to one or more embodiments of the present disclosure. As shown in FIG. 19, a WTRU may receive (e.g., from a gNB 180) configuration information indicating a first TCI state and a second TCI state (e.g., via RRC) at 1902. The WTRU 102 may receive a first DCI indicating the first TCI state and the second TCI state are a unified TCI state (e.g., for the multi-TRP scenario) at 1904. As another example, the WTRU 102 may receive a RRC message carrying an applyindicatedTCIstate indicator to indicate to apply either the first TCI state, the second TCI state, or both the first and second TCI state for PDCCH monitoring. In FIG. 19, it is assumed that the applyindicatedTCIstate indicator indicates to the WTRU 102 to apply both the first and second TCI states for PDCCH monitoring. The WTRU 102 may monitor for a PDCCH transmission by applying both the first and the second TCI states, which may correspond to PDCCH reception from two TRPs. The WTRU 102 may receive (e.g., via the monitored PDCCH) a second DCI scheduling a PDSCH reception at 1906, and the WTRU 102 may determine whether an AP CSI-RS trigger state is triggered or not. For example, if the AP CSI-RS trigger state is triggered, the WTRU 102 may determine to apply an AP CSI-RS (e.g., AP CSI-RS ‘x’), of the AP CSI-RS trigger state, which is received at 1908 for the PDSCH reception at 1910. If the AP CSI-RS trigger state is not triggered, the WTRU 102 may determine to apply the first and the second TCI states for the PDSCH reception at 1910.

For example, the second DCI may carry a TCI selection field to indicate to the WTRU 102 to either apply the first TCI state or the second TCI state for the AP CSI-RS monitoring. For example, the second DCI may further carry a QCL indicator to indicate to the WTRU 102 to apply (e.g., for the scheduled PDSCH reception) either: (i) the unified TCI state (e.g., the first TCI state and the second TCI state are the unified TCI state as indicated by the first DCI); or (ii) the AP CSI-RS (e.g., of the AP CSI-RS trigger state which may be triggered by the second DCI).

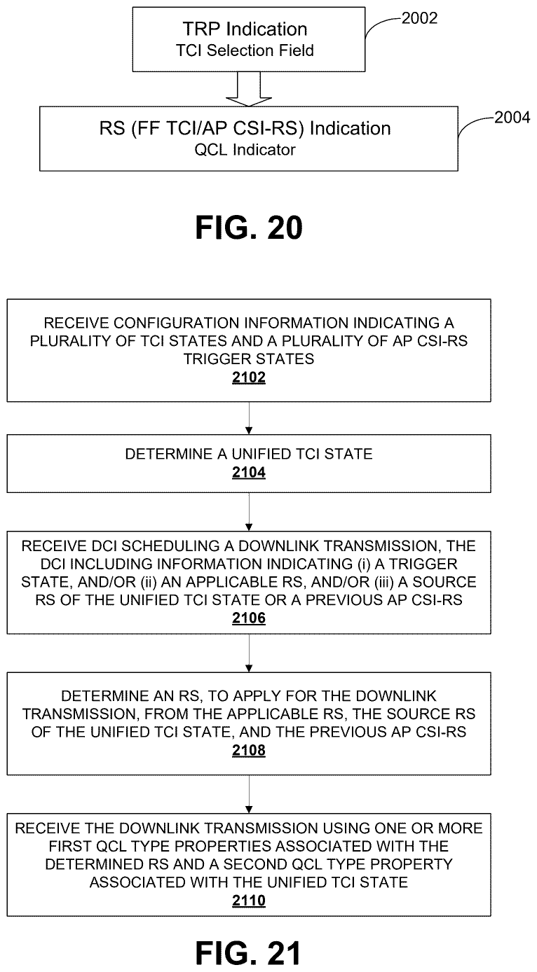

FIG. 20 is an indication diagram illustrating an example two-stage indication for source RS determination, according to one or more embodiments of the present disclosure. As shown in FIG. 20, a WTRU 102 may receive a TRP indication at 2002, via a TCI selection field (e.g., by a gNB 180), that a RS (e.g., AP CSI-RS) is associated with one of multiple TRPs. The WTRU 102 may monitor the RS by applying a TCI state which is associated with the one of the multiple TRPs. After, the WTRU 102 may receive an RS indication at 2004, via a QCL indicator, to apply either the RS (e.g., AP CSI-RS) or apply the unified TCI state (e.g., FF TCI state) for the PDSCH reception.

In certain representative embodiments, a WTRU may use a two-stage indication to receive an (e.g., dynamic) indication of multiple cases by the TCI selection field and QCL indicator jointly. That is, the WTRU 102 may determine which RS is to be applied for QCL property estimation for the PDSCH reception and which TCI state is to be applied for the RS monitoring based on the TCI selection field and the QCL indicator. For example, there may be four cases associated with the RS to be applied as follows.

In a first case, the WTRU 102 may be indicated to apply a first TCI state (e.g., ‘TCI 1’). For example, the QCL indicator field may indicate to apply the first TCI state for the PDSCH reception.

In a second case, the WTRU 102 may be indicated to apply a triggered AP CSI-RS (e.g., AP CSI ‘x’) which is transmitted by the first TRP (e.g., ‘TRP 1’ assuming that the TCI 1 is associated with the ‘TRP 1’). For example, the QCL indicator field indicates to apply the AP CSI-RS for the PDSCH reception, and the TCI selection field indicates to apply the first TCI state for the AP CSI-RS monitoring.

In a third case, the WTRU 102 may be indicated to apply a second TCI state (e.g., ‘TCI 2’). For example, the QCL indicator field indicates to apply a TCI 2 for the PDSCH reception.

In a fourth case, the WTRU may be indicated apply a triggered AP CSI-RS (e.g., AP CSI ‘x’) which is transmitted by the second TRP (e.g., ‘TRP 2’ assuming that the TCI 2 is associated with the ‘TRP 2’). For example, the QCL indicator field indicates to apply the AP CSI-RS for the PDSCH reception, and the TCI selection field indicates to apply the second TCI state for the AP CSI-RS monitoring.

### Example Solutions

In certain representative embodiments, a WTRU 102 may determine a source RS for a first QCL type (e.g., QCL-A) based on one or more L1 indications.

In certain representative embodiments, a WTRU 102 may send (e.g., report) a flexible source RS determination related capability. For example, the flexible source RS determination related capability may include information indicating a maximum number of estimated QCL-A properties the WTRU 102 can store.

The WTRU 102 may receive (e.g., via RRC) configuration information that includes: (i) multiple TCI states, and (ii) an AP CSI-RS trigger state configuration. The AP CSI-RS trigger state configuration may include one or more AP CSI-RS trigger states. For example, any, each, or a subset of the configured AP CSI-RS trigger states may include information indicating a RS (e.g., an AP CSI-RS resource, such as for QCL-A) and a trigger state ID.

The WTRU 102 may receive a first DCI that includes information indicating a unified TCI state.

The WTRU 102 may apply the unified TCI state for PDCCH monitoring. The WTRU 102 may receive a PDCCH transmission using the unified TCI state.

The PDCCH transmission may include a second DCI (e.g., in a 1_x format). The second DCI may include information scheduling a PDSCH reception. For example, the second DCI may include information indicating (i) which of the configured AP CSI-RS trigger state is triggered, and (ii) one or more previously triggered RSs.

As one example, the second DCI may include (i) a CSI trigger state indicator indicating which of the configured AP CSI trigger state is triggered, and (ii) a previous CSI-RS indicator indicating one or more previously triggered AP CSI-RSs. For example, if an AP CSI trigger state is triggered, the CSI trigger state indicator may indicate one of the AP CSI-RS trigger states.

The WTRU 102 may determine (e.g., based on the CSI trigger state indicator) whether an AP CSI-RS trigger state is triggered.

For example, if an AP CSI-RS trigger state is triggered, the WTRU 102 may monitor the AP CSI-RS of the triggered AP CSI-RS trigger state by applying the unified TCI state for a first type of QCL (e.g., QCL-A) property estimation.

For example, if an AP CSI-RS trigger state is not triggered, the WTRU 102 may determine (e.g., based on the previous CSI-RS indicator) whether to apply either the unified TCI state or at least one of previously triggered AP CSI-RSs. As an example, the previously triggered AP CSI-RSs may have been triggered for previous PDSCH reception by previous second DCI (e.g., in a 1_x format). The WTRU 102 may have stored the QCL-A property estimations for the previously triggered AP CSI-RSs.

The WTRU 102 may receive the PDSCH transmission based on (e.g., using) the determined first type of QCL properties (e.g., QCL properties of the triggered AP CSI-RS, the unified TCI state, or the QCL properties for the previously triggered AP CSI-RSs) and the unified TCI state for QCL-D.

The WTRU 102 may send HARQ feedback (e.g., ACK or NACK) associated with the PDSCH transmission.

In certain representative embodiments, a WTRU 102 may determine a source RS for a first QCL type (e.g., QCL-A) based on a timing associated with scheduling DCI and PDSCH reception (e.g., a K0 parameter). For example, the timing may be based on a slot in which the scheduling DCI is received and a slot in which the PDSCH is scheduled.

In certain representative embodiments, a WTRU 102 may send (e.g., report) an AP CSI-RS triggering time related capability. For example, the AP CSI-RS triggering time related capability may include information indicating a minimum time between DCI reception and AP CSI-RS reception that the WTRU 102 supports.

The WTRU 102 may receive (e.g., via RRC) configuration information that includes: (i) multiple TCI states, and (ii) an AP CSI-RS trigger state configuration. The AP CSI-RS trigger state configuration may include one or more AP CSI-RS trigger states. For example, any, each, or a subset of the configured AP CSI-RS trigger states may include information indicating a RS (e.g., an AP CSI-RS resource, such as for QCL-A) and a trigger state ID.

The WTRU 102 may receive a first DCI that includes information indicating a unified TCI state.

The WTRU 102 may apply the unified TCI state for PDCCH monitoring. The WTRU 102 may receive a PDCCH transmission using the unified TCI state.

The PDCCH transmission may include a second DCI (e.g., in a 1_x format). The second DCI may include information scheduling a PDSCH reception. For example, the second DCI may include information indicating (i) which of the configured AP CSI-RS trigger state is triggered.

As one example, the second DCI may include at least (i) a CSI trigger state indicator indicating which of the configured AP CSI trigger state is triggered. For example, if an AP CSI trigger state is triggered, the CSI trigger state indicator may indicate one of the AP CSI-RS trigger states.

The WTRU 102 may determine (e.g., based on the CSI trigger state indicator) whether an AP CSI-RS trigger state is triggered.

The WTRU 102 may determine to apply either the AP CSI RS of the triggered state or the unified TCI state for QCL (e.g., QCL-A) property estimation for the PDSCH based on: (i) a time duration (e.g., K0) associated with the second DCI and the scheduled PDSCH, and (ii) the AP CSI-RS triggering time related capability.

For example, if the time duration is greater than (e.g., or equal to) the AP CSI-RS triggering time related capability, the WTRU 102 may monitor the AP CSI-RS (e.g., for QCL-A property estimation).

For example, if the time duration is less than (e.g., or equal to) the AP CSI-RS triggering time related capability, the WTRU 102 may apply the unified TCI state (e.g., for QCL-A property estimation).

The WTRU 102 may receive the PDSCH transmission based on the determination for QCL-A and the unified TCI state for QCL-D;

The WTRU 102 may receive the PDSCH transmission based on (e.g., using) the determined first type of QCL properties (e.g., QCL properties of the triggered AP CSI-RS, or the unified TCI state) and the unified TCI state for QCL-D.

The WTRU 102 may send HARQ feedback (e.g., ACK or NACK) associated with the PDSCH transmission.

In certain representative embodiments, a WTRU 102 may determine a source RS for a first QCL type (e.g., QCL-A) based on one or more L1 indications and the timing associated with the scheduling DCI and the PDSCH reception.

In certain representative embodiments, a WTRU 102 may determine to apply a triggered AP CSI-RS or a source RS of a unified TCI state. For example, the unified TCI state may be used by multiple TRPs.

In certain representative embodiments, a WTRU 102 may receive (e.g., via RRC) configuration information that includes: (i) multiple TCI states including a first TCI state and a second TCI state, and (ii) an AP CSI-RS trigger state configuration, and (iii) information indicating a TCI state applicable for PDCCH reception.

For example, the first TCI state may be a first FF TCI state and/or associated with a first TRP. For example, the second TCI state may be a second FF TCI state and/or associated with a second TRP.

For example, the AP CSI-RS trigger state configuration may include one or more AP CSI-RS trigger states. For example, any, each, or a subset of the configured AP CSI-RS trigger states may include information indicating a RS (e.g., an AP CSI-RS resource, such as for QCL-A) and a trigger state ID.

For example, the information indicating a TCI state applicable for PDCCH reception may be an applyIndicatedTCIstate indicator for PDCCH reception (e.g., such as in the case of two applicable joint/DL TCI states). For example, the first TCI state, the second TCI state or both the first and second TCI state may be indicated for PDCCH monitoring.

The WTRU 102 may receive a first DCI that indicates a unified TCI state (e.g., the first TCI state and the second TCI state).

The WTRU 102 may apply the unified TCI state for PDCCH monitoring. The WTRU 102 may receive a PDCCH transmission using unified TCI state.

The WTRU 102 may applying the first and/or the second TCI state for PDCCH monitoring based on information indicating a TCI state applicable for PDCCH reception (e.g., applyIndicatedTCIstate). The WTRU 102 may receive a PDCCH transmission based on the monitoring of the PDCCH.

The PDCCH transmission may include a second DCI. The second DCI may include information scheduling a PDSCH reception. For example, the second DCI may include information indicating (i) which of the configured AP CSI-RS trigger states is triggered (e.g., a CSI trigger state indicator), (ii) a QCL indicator, and (iii) a TCI selection field indicating the (e.g., FF) first TCI state.

The WTRU 102 may determine to monitor the AP CSI-RS of the AP CSI-RS trigger state (e.g., triggered by the CSI trigger state indicator) by applying the first TCI state based on the TCI selection field.

The WTRU 102 may determine to apply either the first TCI state or the AP CSI-RS for QCL-A property estimation for receiving the PDSCH based on the QCL indicator.

The WTRU 102 may receive the PDSCH transmission based on (e.g., using) the QCL properties estimated using the determined source RS for QCL-A and the first TCI state for QCL-D. For example, the QCL-A properties may be estimated using the determined source RS of either the first TCI state or the AP CSI-RS based on the QCL indicator.

The WTRU 102 may send HARQ feedback (e.g., ACK or NACK) associated with the PDSCH transmission.

In certain representative embodiments, a WTRU 102 may determine to apply a triggered AP CSI-RS or a source RS of a unified TCI state based on anchoring information and/or TCI status. For example, the unified TCI state may be used by multiple TRPs.

For example, a first TCI state may be anchored with a second TCI state. The first TCI state may be indicated to be applied for PDSCH reception based on a TCI status of the second TCI state (e.g., the TCI status of the second TCI is activated).

For example, either a unified TCI state or a NF TCI state may be applicable for PDSCH reception based on a TCI status of a corresponding anchored TCI state.

In certain representative embodiments, a WTRU 102 may receive (e.g., via RRC) configuration information that includes: (i) a first TCI state, and (ii) anchoring information. The anchoring information may indicate the first TCI state is anchored with a second TCI state for a first type of QCL (e.g., QCL-A), and the first TCI state is anchored with a third TCI state for a second type of QCL (e.g., QCL-D.

As a non-limiting example, the configuration information may include configuration of each of the first TCI state, the second TCI state, and the third TCI state.

The WTRU 102 may receive a first DCI. The first DCI may include information indicating to apply a unified TCI state for PDCCH and PDSCH. For example, the first DCI may indicate the third TCI state as the unified TCI state.

The WTRU 102 may apply the unified TCI state for PDCCH monitoring. The WTRU 102 may receive a PDCCH transmission using the unified TCI state. The PDCCH transmission may include information scheduling a PDSCH reception.

The WTRU 102 may determine to apply either the third TCI state or the first TCI state to receive the PDSCH based on a TCI status (e.g., associated with the anchoring information) of the second TCI state.

For example, if the second TCI state has a TCI status which is active, the WTRU 102 may apply the first TCI state for the PDSCH.

For example, if the second TCI state has a TCI status which is inactive, or semi-active, the WTRU 102 may apply the third TCI state for the PDSCH.

The WTRU 102 may receive the PDSCH transmission based on (e.g., using) the TCI state which is determined to be applicable (e.g., depending on the TCI status of the second TCI state).

The WTRU 102 may send HARQ feedback (e.g., ACK or NACK) associated with the PDSCH transmission.

In certain representative embodiments, a WTRU 102 may receive anchoring information associated with TCI states based on L2 signaling.

In certain representative embodiments, a WTRU 102 may receive (e.g., via RRC) configuration information that includes: (i) a first TCI state with a first source RS for QCL type A, and (ii) a second TCI state with a second source RS for QCL type A and a third source RS for QCL type D.

The WTRU 102 may receive a MAC CE. The MAC CE may include information indicating activation (e.g., active as the TCI status) of the first TCI state and the second TCI state. The first TCI state may be anchored with (e.g., according to anchoring information) the second TCI state for a QCL type (e.g., QCL-D).

The WTRU 102 may monitor for a PDCCH transmission using the first TCI state. The WTRU 102 may receive the PDCCH transmission which includes a first DCI including information scheduling a PDSCH reception.

For example, the WTRU 102 may determine to apply the first source RS (e.g., for QCL-A) and the third source RS (e.g., for QCL-D) for receiving the PDSCH. The determination may be based on the RRC configuration and the MAC CE.

The WTRU 102 may receive the PDSCH transmission by using the first source RS for the first QCL type (e.g., QCL-A) and the third source RS for the second QCL type (e.g., QCL-D).

For example, the WTRU 102 may determine to use the second TCI state for PDCCH monitoring. The determination may be based on the RRC configuration, the MAC CE, and the DCI.

The WTRU 102 may receive a second DCI by using the second TCI state. The WTRU 102 may receive the second DCI based on the second source RS for QCL type A and a third source RS for QCL type D.

### Representative Procedures

FIG. 21 is a procedural diagram illustrating an example procedure for determining QCL properties for receiving a downlink transmission, according to one or more embodiments of the present disclosure. As shown in FIG. 21, a WTRU 102 may receive (e.g., from the network) configuration information indicating a plurality of TCI states (e.g., NF and FF TCI states) and a plurality of AP CSI-RS trigger states at 2102. For example, the configuration information may include an AP CSI-RS trigger state configuration. The AP CSI-RS trigger state configuration may include information indicating a set of AP CSI-RS trigger states.

For example, any (e.g., each) of the AP CSI-RS trigger states may be identified by a triggering state ID. For example, any (e.g., each) of the AP CSI-RS trigger states may be include or be associated with a (e.g., respective) RS resource (e.g., an AP CSI-RS). For example, any (e.g., each) of the AP CSI-RS trigger states may include or be associated with a (e.g., respective) TCI state. For example, any (e.g., each) of the AP CSI-RS trigger states may be include or be associated with a (e.g., respective) QCL type and/or (e.g., a set of) one or more QCL properties. For example, any (e.g., each) of the AP CSI-RS trigger states may include or be associated with a Q CL_Applied IE that indicates the AP CSI-RS trigger state is (e.g., part of a set) configured for QCL property estimation.

For example, anchoring information may be received by the WTRU 102 which indicates that one or more of the TCI states are anchored with one or more other TCI states.

At 2104, the WTRU 102 may determine a unified TCI state. The WTRU 102 may determine the unified TCI state based on received signaling. For example, the WTRU 102 may monitor for a (e.g., first) PDCCH transmission. The WTRU 102 may receive the (e.g., first) PDCCH transmission which includes a (e.g., first) DCI. The (e.g., first) DCI may include information indicating (e.g., to apply) the unified TCI state.

At 2106, the WTRU 102 may receive DCI scheduling a downlink (e.g., PDSCH) transmission. For example, the DCI received at 2106 may be a second DCI. The (e.g., second) DCI may be received in a (e.g., second) PDCCH transmission based on monitoring using the unified TCI state. The (e.g., second) DCI may include information indicating (i) a trigger state, and/or (ii) an applicable RS, and/or (iii) a source RS of the unified TCI state or a previous AP CSI-RS.

For example, the information indicating the trigger state may indicate at least one AP CSI-RS trigger state from among the set of AP CSI-RS trigger states (e.g., configured at 2102). For example, the trigger state may not indicate an AP CSI-RS trigger state from among the set of AP CSI-RS trigger states (e.g., configured at 2102).

For example, the information indicating the applicable RS may indicate an AP CSI-RS, or another RS, for QCL property estimation. For example, the applicable RS may indicate an AP CSI-RS which is associated with AP CSI-RS trigger state indicated by the trigger state information in the (e.g., second) DCI.

In some embodiments, the trigger state may be indicated via a CSI trigger state indicator. For example, the CSI trigger state indicator may identify an AP CSI-RS trigger state from the set of configured AP CSI-RS trigger states. For example, the CSI trigger state indicator may identify an AP CSI-RS trigger state and the applicable RS (e.g., an AP CSI-RS resource configured to be associated with the AP CSI-RS trigger state).

In some embodiments, the trigger state may be indicated via a CSI_Applied field of the (e.g., second) DCI. For example, the CSI_Applied field may identify (e.g., via codepoint) an AP CSI-RS trigger state from the set of configured AP CSI-RS trigger states. For example, the CSI_Applied field may identify an AP CSI-RS trigger state and the applicable RS (e.g., an AP CSI-RS resource configured to be associated with the AP CSI-RS trigger state).

For example, the information indicating the source RS of the unified TCI state or a previous AP CSI-RS may indicate that one of the source RS or a previous AP CSI-RS is applicable (e.g., for reception of the scheduled downlink transmission). For example, the information indicating a previous AP CSI-RS may indicate one of plurality AP CSI-RSs (e.g., which were previously triggered for QCL estimation).

At 2108, the WTRU 102 may determine a (e.g., source) RS, to apply for the downlink transmission, from the applicable RS, the source RS of the unified TCI state, and the previous AP CSI-RS.

For example, the WTRU 102 may use the information indicating (i) the trigger state, and/or (ii) the applicable RS, and/or (iii) the source RS of the unified TCI state or a previous AP CSI-RS to determine the RS, to apply for the downlink transmission.

At 2110, the WTRU 102 may receive the downlink transmission using one or more first QCL type (e.g., QCL-A) properties associated with the determined RS and a second QCL type (e.g., QCL-D) property associated with the unified TCI state.

For example, the WTRU 102 may send HARQ feedback, to the network (e.g., gNB 180), that is associated with the downlink transmission.

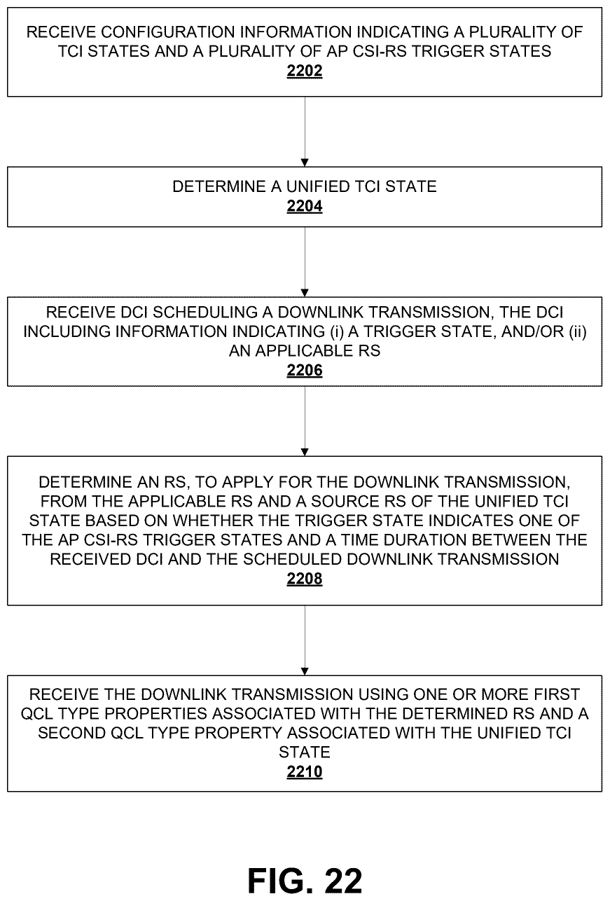

FIG. 22 is a procedural diagram illustrating another example procedure for determining QCL properties for receiving a downlink transmission, according to one or more embodiments of the present disclosure. As shown in FIG. 22, a WTRU 102 may receive (e.g., from the network) configuration information indicating a plurality of TCI states (e.g., NF and FF TCI states) and a plurality of AP CSI-RS trigger states at 2102. For example, the configuration information may include an AP CSI-RS trigger state configuration. The AP CSI-RS trigger state configuration may include information indicating a set of AP CSI-RS trigger states.

For example, any (e.g., each) of the AP CSI-RS trigger states may be identified by a triggering state ID. For example, any (e.g., each) of the AP CSI-RS trigger states may be include or be associated with a (e.g., respective) RS resource (e.g., an AP CSI-RS). For example, any (e.g., each) of the AP CSI-RS trigger states may include or be associated with a (e.g., respective) TCI state. For example, any (e.g., each) of the AP CSI-RS trigger states may be include or be associated with a (e.g., respective) QCL type and/or (e.g., a set of) one or more QCL properties. For example, any (e.g., each) of the AP CSI-RS trigger states may include or be associated with a Q CL_Applied IE that indicates the AP CSI-RS trigger state is (e.g., part of a set) configured for QCL property estimation.

For example, anchoring information may be received by the WTRU 102 which indicates that one or more of the TCI states are anchored with one or more other TCI states.

At 2204, the WTRU 102 may determine a unified TCI state. The WTRU 102 may determine the unified TCI state based on received signaling. For example, the WTRU 102 may monitor for a (e.g., first) PDCCH transmission. The WTRU 102 may receive the (e.g., first) PDCCH transmission which includes a (e.g., first) DCI. The (e.g., first) DCI may include information indicating (e.g., to apply) the unified TCI state.

At 2106, the WTRU 102 may receive DCI scheduling a downlink (e.g., PDSCH) transmission. For example, the DCI received at 2106 may be a second DCI. The (e.g., second) DCI may be received in a (e.g., second) PDCCH transmission based on monitoring using the unified TCI state. The (e.g., second) DCI may include information indicating (i) a trigger state, and/or (ii) an applicable RS.

For example, the information indicating the trigger state may indicate at least one AP CSI-RS trigger state from among the set of AP CSI-RS trigger states (e.g., configured at 2102). For example, the trigger state may not indicate an AP CSI-RS trigger state from among the set of AP CSI-RS trigger states (e.g., configured at 2102).

For example, the information indicating the applicable RS may indicate an AP CSI-RS, or another RS, for QCL property estimation. For example, the applicable RS may indicate an AP CSI-RS which is associated with AP CSI-RS trigger state indicated by the trigger state information in the (e.g., second) DCI.

In some embodiments, the trigger state may be indicated via a CSI trigger state indicator. For example, the CSI trigger state indicator may identify an AP CSI-RS trigger state from the set of configured AP CSI-RS trigger states. For example, the CSI trigger state indicator may identify an AP CSI-RS trigger state and the applicable RS (e.g., an AP CSI-RS resource configured to be associated with the AP CSI-RS trigger state).

In some embodiments, the trigger state may be indicated via a CSI_Applied field of the (e.g., second) DCI. For example, the CSI_Applied field may identify (e.g., via codepoint) an AP CSI-RS trigger state from the set of configured AP CSI-RS trigger states. For example, the CSI_Applied field may identify an AP CSI-RS trigger state and the applicable RS (e.g., an AP CSI-RS resource configured to be associated with the AP CSI-RS trigger state).

At 2208, the WTRU 102 may determine a (e.g., source) RS, to apply for the downlink transmission, from the applicable RS and a source RS of the unified TCI state based on whether the trigger state indicates one of the AP CSI-RS trigger states and a time duration between the received DCI and the scheduled downlink transmission.

For example, the WTRU 102 may determine to apply the applicable RS indicated by the DCI based on (i) one of the AP CSI-RS trigger states being indicated by the trigger state included in the DCI and (ii) the time duration between the received DCI and the scheduled downlink transmission being greater than a threshold amount (e.g., an AP CSI-RS triggering time related capability of the WTRU 102).

For example, the WTRU 102 may determine to apply the applicable RS indicated by the DCI based on (i) no AP CSI-RS trigger state being indicated by the trigger state included in the DCI or (ii) the time duration between the received DCI and the scheduled downlink transmission being greater than a threshold amount (e.g., an AP CSI-RS triggering time related capability of the WTRU 102).

In another (e.g., alternative) example, the WTRU 102 may determine a (e.g., source) RS, to apply for the downlink transmission at 2208 based (e.g., only) on the time duration between the received DCI and the scheduled downlink transmission. For example, the WTRU 102 may determine to apply an AP CSI-RS associated with the triggered AP CSI-RS trigger state upon determining that the time duration is greater than a threshold, or is in a first range. For example, the WTRU 102 may determine to apply one or more stored QCL properties (e.g., associated with a source RS) upon determining that the time duration is less than a threshold, or is in a second range. For example, the WTRU 102 may determine to apply (e.g., QCL properties associated with a source RS of) the unified TCI state upon determining that the time duration is less than a threshold, or is in a second, or third, range.

At 2210, the WTRU 102 may receive the downlink transmission using one or more first QCL type (e.g., QCL-A) properties associated with the determined RS and a second QCL type (e.g., QCL-D) property associated with the unified TCI state.

For example, the WTRU 102 may send HARQ feedback, to the network (e.g., gNB 180), that is associated with the downlink transmission.

For example, the WTRU 102 may estimate the one or more first QCL type properties using the applicable RS.

For example, the WTRU 102 may estimate, prior to receiving the DCI, the one or more first QCL type properties using the previous AP CSI-RS.

For example, the WTRU 102 may receive the DCI using the unified TCI state.

For example, the WTRU 102 may determine the trigger state (e.g., implicitly or explicitly) indicates an AP CSI-RS trigger state from among the set of AP CSI-RS trigger states. The WTRU 102 may determine the RS to apply for the downlink transmission from any of the indicated AP CSI-RS trigger state and/or the indicated applicable RS.

For example, the WTRU 102 may determine the trigger state does not (e.g., implicitly or explicitly) indicate any of the set of AP CSI-RS trigger states. The WTRU 102 may determine the RS to apply for the downlink transmission from the indicated source RS of the unified TCI state and the AP CSI-RS of the triggered AP CSI-RS trigger state.

For example, the WTRU 102 may determine the trigger state does not (e.g., implicitly or explicitly) indicate any of the set of AP CSI-RS trigger states. The WTRU 102 may determine the RS to apply for the downlink transmission from the indicated source RS of the unified TCI state and the (e.g., one or more) previous AP CSI-RS.

For example, the WTRU 102 may determine the RS to apply for the downlink transmission from the indicated source RS of the unified TCI state and the AP CSI-RS of the triggered AP CSI-RS trigger state based on a time duration between reception of the DCI and the scheduled downlink transmission.

For example, the WTRU 102 may determine the RS to apply for the downlink transmission from the indicated source RS of the unified TCI state and the (e.g., one or more) previous AP CSI-RS based on a time duration between reception of the DCI and the scheduled downlink transmission.

For example, the information indicating (i) the trigger state and (ii) the applicable RS may be provided via a CSI trigger state indicator included in the DCI.

For example, the information indicating (iii) the source RS of the unified TCI state or the AP CSI-RS of the triggered AP CSI-RS trigger state may be provided by a previous CSI indicator included in the DCI.

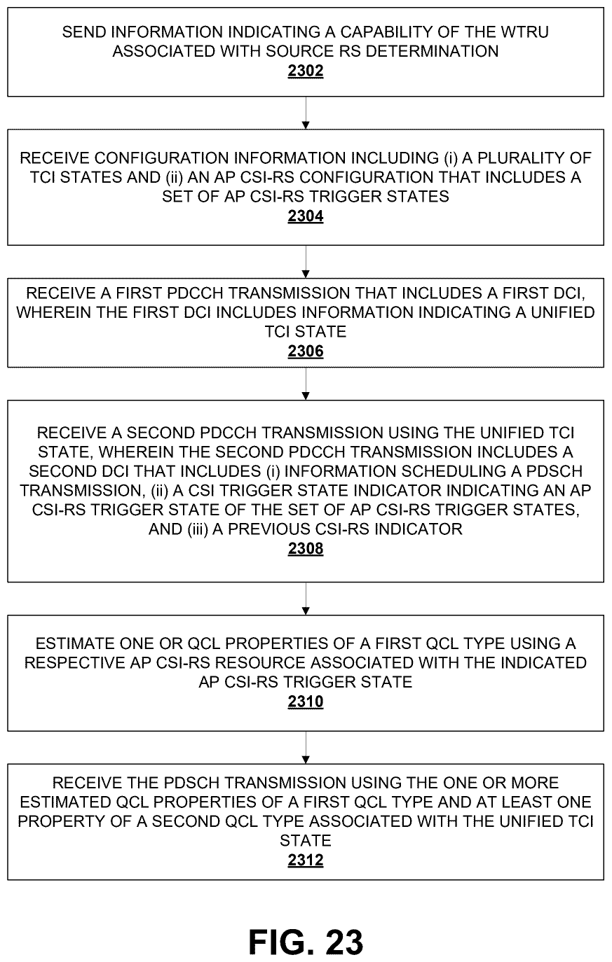

FIG. 23 is a procedural diagram illustrating another example procedure for determining QCL properties for receiving a downlink transmission, according to one or more embodiments of the present disclosure. As shown in FIG. 23, a WTRU 102 may send information indicating a capability of the WTRU associated with source RS determination at 2302. At 2304, the WTRU 102 may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. At 2306, the WTRU 102 may receive a first PDCCH transmission that includes a first DCI. The first DCI may include information indicating a unified TCI state. At 2308, the WTRU 102 may receive a second PDCCH transmission using the unified TCI state. For example, the second PDCCH transmission includes a second DCI that may include (i) information scheduling a physical downlink shared channel (PDSCH) transmission, (ii) a CSI trigger state indicator indicating an AP CSI-RS trigger state of the set of AP CSI-RS trigger states, and (iii) a previous CSI-RS indicator. At 2310, the WTRU 102 may estimate one or more properties of a first QCL type (e.g., QCL-A) using the respective AP CSI-RS resource associated with the indicated AP CSI-RS trigger state.

For example, the WTRU 102 may determine (e.g., select) the respective AP CSI-RS resource is to be used for QCL property estimation based on the CSI trigger state indicator, in the second DCI indicating the AP CSI-RS trigger state. For example, the WTRU 102 may determine (e.g., select) the respective AP CSI-RS resource is to be used for QCL property estimation based on a time duration between the reception of the second DCI and the scheduled PDSCH transmission being greater than a threshold time amount (e.g., supported by the WTRU) and/or another time duration as described herein.

At 2312, the WTRU 102 may receive the PDSCH transmission using the one or more estimated QCL properties of the first QCL type and at least one QCL property of a second QCL type (e.g., QCL-D) associated with the unified TCI state.

For example, the WTRU 102 may send HARQ feedback that is associated with the PDSCH transmission.

For example, the information indicating the capability of the WTRU includes a maximum number of instances of previously estimated QCL properties (e.g., of the first QCL type) that the WTRU supports and/or a time amount associated with AP CSI-RS trigger timing that the WTRU supports.

For example, each AP CSI-RS trigger state may be associated, by the configuration information, with a respective AP CSI-RS resource for QCL (e.g., QCL-A) property estimation.

For example, prior to reception of the second PDCCH transmission, the WTRU 102 may receive a third PDCCH transmission that includes a third DCI that includes a CSI trigger state indicator indicating another AP CSI-RS trigger state of the set of AP CSI-RS trigger states. For example, the previous CSI-RS indicator, included in the second DCI, may indicate (e.g., at least) a respective AP CSI-RS resource associated with the other AP CSI-RS trigger state indicated in the third DCI.

For example, each AP CSI-RS trigger state may be associated with a respective AP CSI-RS resource and a respective TCI state. For example, each TCI state may be associated with at least one QCL type.

For example, the WTRU 102 may determine the indicated AP CSI-RS trigger state of the set of AP CSI-RS trigger states based on an identifier, index, or codepoint indicated by the CSI trigger state indicator.

For example, the previous CSI-RS indicator may indicate one or more previously triggered AP CSI-RS resources and/or AP CSI-RS trigger states. As an example, FIG. 8 shows a set of previous AP CSI-RS resources that the WTRU 102 may use to determine one or more QCL properties of and store for availability at the WTRU 102. As an example, FIG. 10 shows a set of previously triggered CSI trigger states.

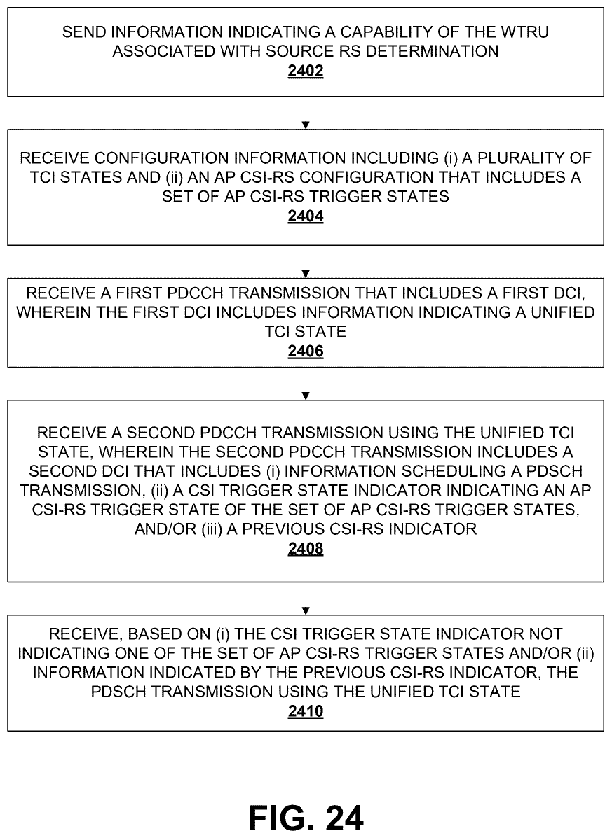

FIG. 24 is a procedural diagram illustrating another example procedure for determining QCL properties for receiving a downlink transmission, according to one or more embodiments of the present disclosure. As shown in FIG. 24, a WTRU 102 may send information indicating a capability of the WTRU associated with source RS determination at 2402. At 2404, the WTRU 102 may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. At 2406, the WTRU 102 may receive a first PDCCH transmission that includes a first DCI. The first DCI may include information indicating a unified TCI state. At 2408, the WTRU 102 may receive a second PDCCH transmission using the unified TCI state. For example, the second PDCCH transmission includes a second DCI that may include (i) information scheduling a physical downlink shared channel (PDSCH) transmission, (ii) a CSI trigger state indicator indicating an AP CSI-RS trigger state of the set of AP CSI-RS trigger states, and/or (iii) a previous CSI-RS indicator.

At 2410, the WTRU 102 may receive, based on (i) the CSI trigger state indicator not indicating one of the set of AP CSI-RS trigger states and/or (ii) information indicated by the previous CSI-RS indicator, the PDSCH transmission using the unified TCI state. For example, the previous CSI-RS indicator may indicate the unified TCI state (e.g., is to be applied to the PDSCH transmission). For example, the WTRU 102 may receive the PDSCH transmission using the one or more QCL properties of a first QCL type (e.g., QCL-A) associated with the unified TCI state and a second QCL type property (e.g., QCL-D) associated with the unified TCI state.

For example, the WTRU 102 may send HARQ feedback that is associated with the PDSCH transmission.

For example, the information indicating the capability of the WTRU includes a maximum number of instances of previously estimated QCL properties (e.g., of a first QCL type) that the WTRU supports and/or a time amount associated with AP CSI-RS trigger timing that the WTRU supports.

For example, each AP CSI-RS trigger state may be associated, by the configuration information, with a respective AP CSI-RS resource for QCL type (e.g., QCL-A) property estimation.

For example, prior to reception of the second PDCCH transmission, the WTRU 102 may receive a third PDCCH transmission that includes a third DCI that includes a CSI trigger state indicator indicating another AP CSI-RS trigger state of the set of AP CSI-RS trigger states.

For example, each AP CSI-RS trigger state may be associated with a respective AP CSI-RS resource and a respective TCI state. For example, each TCI state may be associated with at least one QCL type.

For example, the WTRU 102 may determine the indicated CSI trigger state indicator does not indicate any of the set of AP CSI-RS trigger states based on an identifier, index, or codepoint indicated by the CSI trigger state indicator.

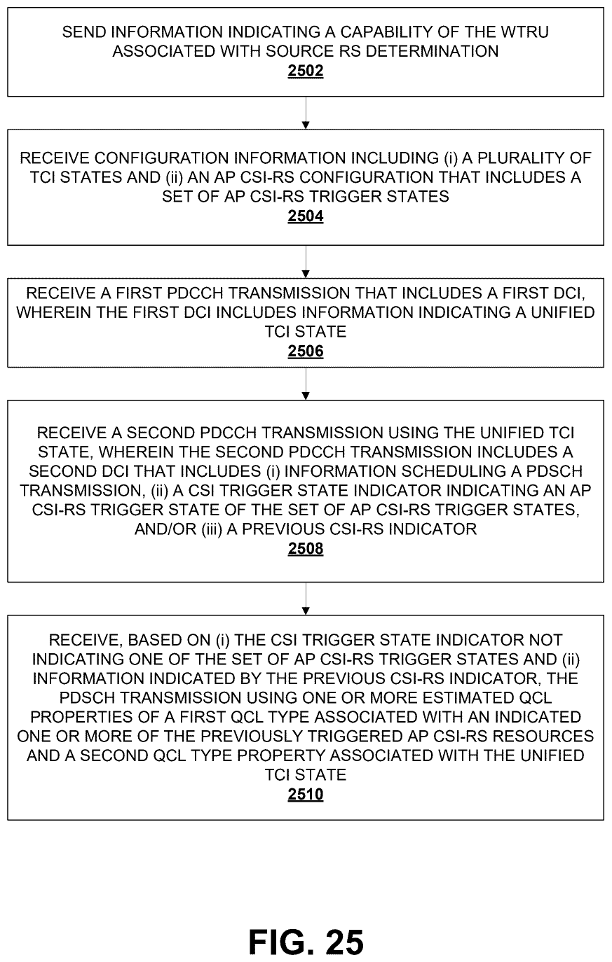

FIG. 25 is a procedural diagram illustrating another example procedure for determining QCL properties for receiving a downlink transmission, according to one or more embodiments of the present disclosure. As shown in FIG. 25, a WTRU 102 may send information indicating a capability of the WTRU associated with source RS determination at 2502. At 2504, the WTRU 102 may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. At 2506, the WTRU 102 may receive a first PDCCH transmission that includes a first DCI. The first DCI may include information indicating a unified TCI state. At 2508, the WTRU 102 may receive a second PDCCH transmission using the unified TCI state. For example, the second PDCCH transmission includes a second DCI that may include (i) information scheduling a physical downlink shared channel (PDSCH) transmission, (ii) a CSI trigger state indicator indicating an AP CSI-RS trigger state of the set of AP CSI-RS trigger states, and/or (iii) a previous CSI-RS indicator.

At 2510, the WTRU 102 may receive, based on (i) the CSI trigger state indicator not indicating one of the set of AP CSI-RS trigger states and (ii) information indicated by the previous CSI-RS indicator, the PDSCH transmission using one or more estimated QCL properties of a first QCL type (e.g., QCL-A) associated with an indicated one or more of the previously triggered AP CSI-RS resources and a second QCL type property (e.g., QCL-D) associated with the unified TCI state.

For example, the WTRU 102 may send HARQ feedback that is associated with the PDSCH transmission.

For example, the previous CSI-RS indicator may indicate one or more previously triggered AP CSI-RS resources and/or AP CSI-RS trigger states. As an example, FIG. 8 shows a set of previous AP CSI-RS resources that the WTRU 102 may use to determine one or more QCL properties (e.g., of the first QCL type) and store for availability at the WTRU 102. As an example, FIG. 10 shows a set of previously triggered CSI trigger states.

For example, each AP CSI-RS trigger state may be associated, by the configuration information, with a respective AP CSI-RS resource for QCL property (e.g., for QCL-A) estimation.

For example, prior to reception of the second PDCCH transmission, the WTRU 102 may receive a third PDCCH transmission that includes a third DCI that includes a CSI trigger state indicator indicating another AP CSI-RS trigger state of the set of AP CSI-RS trigger states. The WTRU 102 may estimate the one or more QCL properties of the first QCL type using a respective AP CSI-RS resource associated with the indicated other AP CSI-RS trigger state.

For example, each AP CSI-RS trigger state may be associated with a respective AP CSI-RS resource and a respective TCI state. For example, each TCI state may be associated with at least one QCL type.

For example, the WTRU 102 may determine the indicated CSI trigger state indicator does not indicate any of the set of AP CSI-RS trigger states based on an identifier, index, or codepoint indicated by the CSI trigger state indicator.

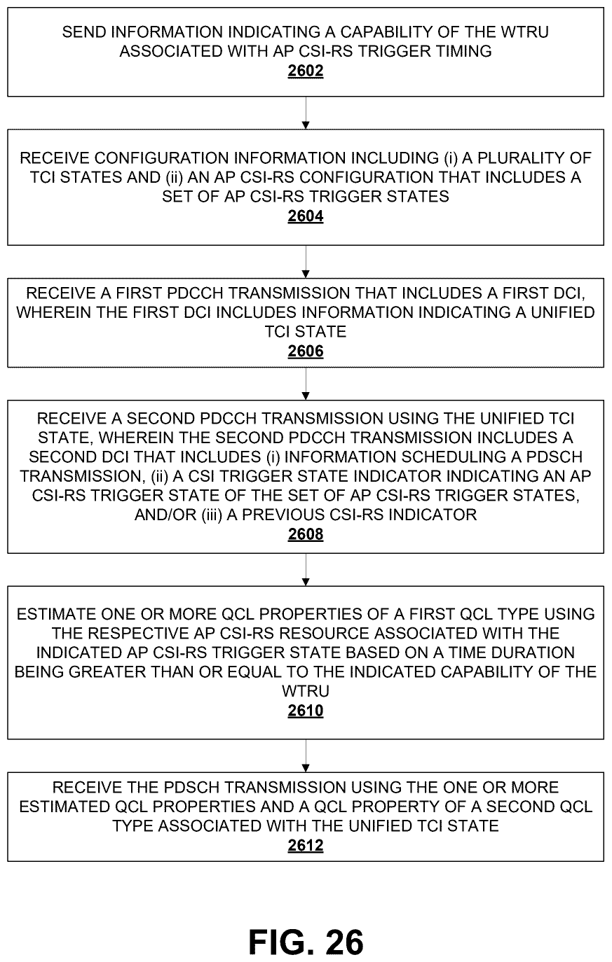

FIG. 26 is a procedural diagram illustrating another example procedure for determining QCL properties for receiving a downlink transmission, according to one or more embodiments of the present disclosure. As shown in FIG. 26, a WTRU 102 may send information indicating a capability of the WTRU 102 associated with AP CSI-RS trigger timing at 2602. At 2604, the WTRU 102 may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. At 2606, the WTRU 102 may receive a first PDCCH transmission that includes a first DCI. For example, the first DCI may include information indicating a unified TCI state. At 2608, the WTRU 102 may receive a second PDCCH transmission using the unified TCI state. For example, the second PDCCH transmission may include a second DCI that includes (i) information scheduling a PDSCH transmission, and (ii) a CSI trigger state indicator indicating an AP CSI-RS trigger state of the set of AP CSI-RS trigger states, and/or (iii) a previous CSI-RS indicator.

At 2610, the WTRU 102 may estimate one or more QCL (e.g., QCL-A) properties using the respective AP CSI-RS resource associated with the indicated AP CSI-RS trigger state based on a time duration (e.g., between the received second DCI and the scheduled PDSCH transmission) being greater than, or equal to, the indicated capability of the WTRU 102. For example, the WTRU 102 may determine that the CSI trigger state indicator includes information indicating the AP CSI-RS trigger state. The WTRU 102 may determine the one or more QCL properties using the respective AP CSI-RS resource on condition that the time duration is greater than, or equal to, the indicated WTRU capability.

As another (e.g., alternative) example, the WTRU 102 may determine to the estimate one or more QCL (e.g., QCL-A) properties using the respective AP CSI-RS resource associated with the indicated AP CSI-RS trigger state based on a time duration, between the respective AP CSI-RS resource and the scheduled PDSCH transmission, being greater than, or equal to, a threshold value (e.g., based on a capability of the WTRU 102).

At 2612, the WTRU 102 may receive the PDSCH transmission using the one or more estimated QCL properties of the first QCL type and a QCL property of a second QCL type (e.g., QCL-D) associated with the unified TCI state.

For example, the WTRU 102 may send HARQ feedback that is associated with the PDSCH transmission.

For example, the information indicating the capability of the WTRU may also include a maximum number of instances of previously estimated QCL (e.g., QCL-A) properties that the WTRU supports.

For example, each AP CSI-RS trigger state may be associated, by the configuration information, with a respective AP CSI-RS resource for QCL property estimation.

For example, the unified TCI state may include a first TCI state and a second TCI state, such as in the case of multi-TRP operation.

For example, the first TCI state may be associated with a first SSB resource and/or a first CSI-RS resource. For example, the second TCI state may be associated with a second SSB resource and/or a second CSI-RS resource.

For example, the WTRU 102 may receive, prior to the second PDCCH transmission, one or more transmissions using at least one resource associated with the unified TCI state.

For example, any (e.g., each) AP CSI-RS trigger state may be associated with a respective AP CSI-RS resource and a respective TCI state.

For example, the WTRU 102 may determine the indicated AP CSI-RS trigger state of the set of AP CSI-RS trigger states based on a triggering state index, identifier, or codepoint indicated by the CSI trigger state indicator.

For example, the WTRU 102 may receive, during the time duration, one or more CSI-RS transmissions using the respective AP CSI-RS resource associated with the indicated AP CSI-RS trigger state.

For example, the WTRU 102 may determine the time duration, between the second DCI and the scheduled PDSCH transmission, is greater than or equal to the indicated capability of the WTRU.

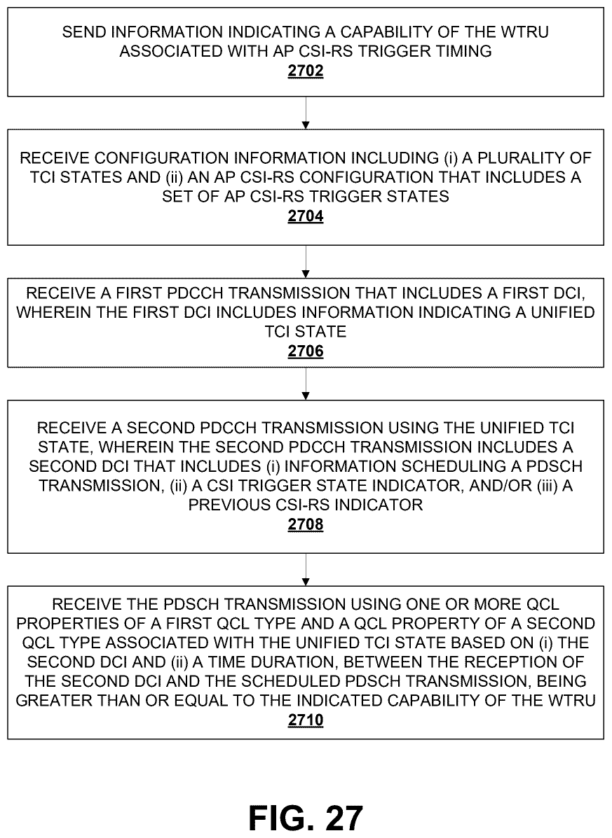

FIG. 27 is a procedural diagram illustrating another example procedure for determining QCL properties for receiving a downlink transmission, according to one or more embodiments of the present disclosure. As shown in FIG. 27, a WTRU 102 may send information indicating a capability of the WTRU 102 associated with AP CSI-RS trigger timing at 2702. At 2704, the WTRU 102 may receive configuration information including (i) a plurality of TCI states and (ii) an AP CSI-RS configuration that includes a set of AP CSI-RS trigger states. For example, any (e.g., each) AP CSI-RS trigger state may be associated with a respective AP CSI-RS resource. At 2706, the WTRU 102 may receive a first PDCCH transmission that includes a first DCI. For example, the first DCI may include information indicating a unified TCI state. At 2708, the WTRU 102 may receive a second PDCCH transmission using the unified TCI state. For example, the second PDCCH transmission may include a second DCI that includes (i) information scheduling a PDSCH transmission, and (ii) a CSI trigger state indicator, and/or (iii) a previous CSI-RS indicator.

At 2710, the WTRU 102 may receive the PDSCH transmission using one or more QCL properties of a first QCL type (e.g., QCL-A) and a QCL property of a second QCL type (e.g., QCL-D) associated with the unified TCI state based on (i) the second DCI and (ii) a time duration, between the reception of the second DCI and the scheduled PDSCH transmission, being less than, or equal to, the indicated capability of the WTRU. For example, the WTRU 102 may determine to use the one or more QCL properties which are associated with the unified TCI state or indicated by the previous CSI-RS indicator. For example, the WTRU 102 may determine to use the one or more QCL properties which are associated with the unified TCI state based on any of the CSI trigger state indicator indicating none of the set of AP CSI-RS trigger states, the previous CSI-RS indicator indicating the unified TCI state, and/or the time duration being less than, or equal to, the indicated capability of the WTRU. For example, the WTRU 102 may determine to use the one or more QCL properties which are associated with a previous AP CSI-RS resource or AP CSI-RS trigger state indicated by the previous CSI-RS indicator based on any of the CSI trigger state indicator indicating none of the set of AP CSI-RS trigger states, the previous AP CSI-RS resource or AP CSI-RS trigger state indicated by the previous CSI-RS indicator, and/or the time duration being less than, or equal to, the indicated capability of the WTRU 102.

For example, the WTRU 102 may send HARQ feedback that is associated with the PDSCH transmission.

For example, the information indicating the capability of the WTRU may also include a maximum number of instances of previously estimated QCL (e.g., QCL-A) properties that the WTRU supports.

For example, the previous CSI-RS indicator may indicate one or more previously triggered AP CSI-RS resources and/or AP CSI-RS trigger states. As an example, FIG. 8 shows a set of previous AP CSI-RS resources that the WTRU 102 may use to determine one or more QCL properties of and store for availability at the WTRU 102. As an example, FIG. 10 shows a set of previously triggered CSI trigger states.

For example, each AP CSI-RS trigger state may be associated, by the configuration information, with a respective AP CSI-RS resource for QCL property estimation.

For example, the unified TCI state may include a first TCI state and a second TCI state, such as in the case of multi-TRP operation.

For example, the first TCI state may be associated with a first SSB resource and/or a first CSI-RS resource. For example, the second TCI state may be associated with a second SSB resource and/or a second CSI-RS resource.

For example, the WTRU 102 may receive, prior to the second PDCCH transmission, one or more transmissions using at least one resource associated with the unified TCI state.

For example, any (e.g., each) AP CSI-RS trigger state may be associated with a respective AP CSI-RS resource and a respective TCI state.

For example, the WTRU 102 may determine the indicated AP CSI-RS trigger state of the set of AP CSI-RS trigger states based on a triggering state index, identifier, or codepoint indicated by the CSI trigger state indicator.

For example, the WTRU 102 may receive, during the time duration, one or more CSI-RS transmissions using the respective AP CSI-RS resource associated with the indicated AP CSI-RS trigger state.

For example, the WTRU 102 may determine the time duration, between the second DCI and the scheduled PDSCH transmission, is less than or equal to the indicated capability of the WTRU 102.

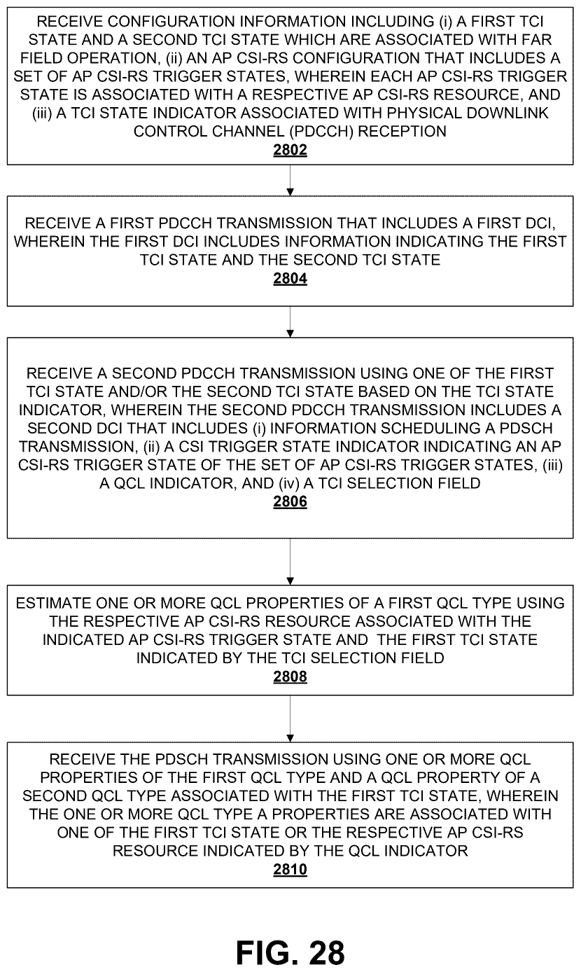

FIG. 28 is a procedural diagram illustrating another example procedure for determining QCL properties for receiving a downlink transmission, according to one or more embodiments of the present disclosure. As shown in FIG. 28, a WTRU 102 may receive, at 2802, configuration information including (i) a first TCI state and a second TCI state which are associated with far field operation, (ii) an AP CSI-RS configuration that includes a set of AP CSI-RS trigger states, wherein each AP CSI-RS trigger state is associated with a respective AP CSI-RS resource, and (iii) a TCI state indicator associated with physical downlink control channel (PDCCH) reception. For example, the TCI state indicator may be an applyIndicatedTCIstate indicator which indicates that one or both of the first and second TCI states are applicable for PDCCH reception. At 2804, the WTRU 102 may receive a first PDCCH transmission that includes a first DCI, wherein the first DCI includes information indicating the first TCI state and the second TCI state (e.g., as a unified TCI state).

At 2806, the WTRU 102 may receive a second PDCCH transmission using one of the first TCI state and/or the second TCI state based on the TCI state indicator. The second PDCCH transmission may include a second DCI that includes (i) information scheduling a PDSCH transmission, (ii) a CSI trigger state indicator indicating an AP CSI-RS trigger state of the set of AP CSI-RS trigger states, (iii) a QCL indicator, and (iv) a TCI selection field. For example, the QCL indicator may indicate one or more values, such as a first value or a second value. The first value of the QCL indicator field may indicate to the WTRU 102 to apply a source RS of the unified TCI state for the PDSCH reception, and a second value of the QCL indicator field may indicate to the WTRU 102 to apply the AP CSI-RS of the triggered AP CSI-RS trigger state for the PDSCH reception. For example, the TCI selection field may indicate to the WTRU 102 to apply first TCI state or the second TCI state for AP CSI-RS monitoring.

At 2808, the WTRU 102 may estimate one or more QCL properties of a first QCL type (e.g., QCL-A) using the respective AP CSI-RS resource associated with the indicated AP CSI-RS trigger state and the first TCI state as indicated by the TCI selection field. At 2810, the WTRU 102 may receive the PDSCH transmission using the estimated one or more QCL properties of the first QCL type and a QCL property of a second QCL type (e.g., QCL-D) associated with the first TCI state. For example, the one or more QCL properties (e.g., of the first QCL type) may be associated with one of (e.g., the source RS of) the first TCI state or the respective AP CSI-RS resource indicated by the QCL indicator.

For example, the WTRU 102 may send HARQ feedback that is associated with the PDSCH transmission.

For example, the first TCI state may be associated with (e.g., communicating with) a first TRP, and the second TCI state may be associated with (e.g., communicating with) a second TRP.

For example, the TCI state indicator may be an applyIndicatedTCIstate indicator which indicates to apply either the first TCI state, the second TCI state or both the first and second TCI state for PDCCH monitoring.

For example, the QCL indicator may indicate either to apply the source RS of the unified TCI state for the PDSCH reception, or to apply the triggered the AP CSI-RS of the triggered AP CSI-RS trigger state for the PDSCH reception. The QCL indicator may indicate to apply either the unified TCI state (e.g., as indicated by the first DCI), or to apply the first TCI state and the second TCI state as a unified TCI state as indicated by the first DCI; or to apply the AP CSI-RS of the AP CSI-RS trigger state triggered by the second DCI.

For example, the TCI selection field may be an indicator carried by the second DCI. The TCI selection field may indicate to either apply the first TCI state or the second TCI state for AP CSI-RS monitoring.

For example, the first PDCCH transmission may be received from a first TRP or a second TRP. For example, the second PDCCH transmission may be received from the first TRP or the second TRP. For example, the PDSCH transmission may be received from the first TRP.

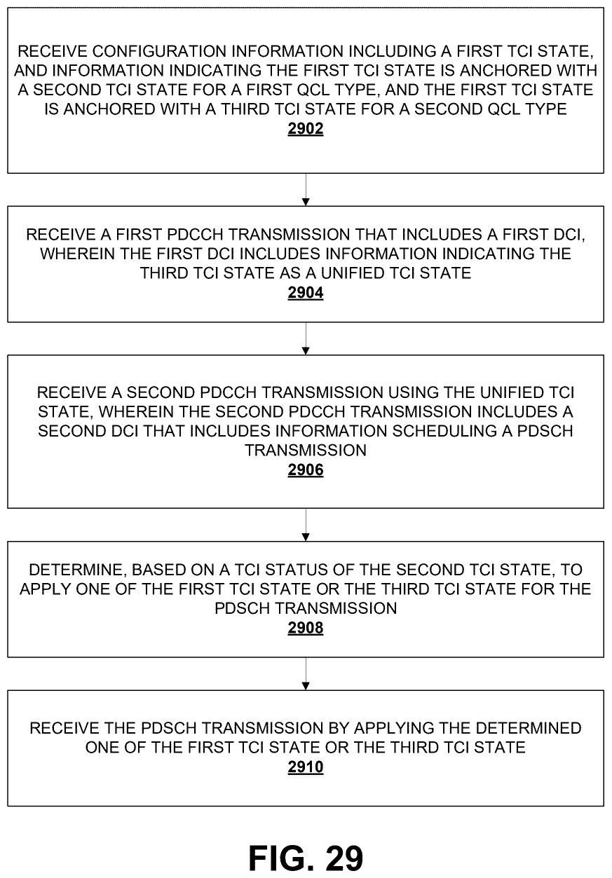

FIG. 29 is a procedural diagram illustrating an example procedure for determining QCL properties for receiving a downlink transmission, according to one or more embodiments of the present disclosure. As shown in FIG. 29, a WTRU 102 may receive, at 2902, configuration information including a first TCI state, and (e.g., anchoring) information indicating the first TCI state is anchored with a second TCI state for a first QCL type (e.g., QCL-A), and the first TCI state is anchored with a third TCI state for a second QCL type (e.g., QCL-D). At 2904, the WTRU 102 may receive a first PDCCH transmission that includes a first DCI. For example, the first DCI may include information indicating the third TCI state as a unified TCI state (e.g., for PDCCH and PDSCH reception). At 2906, the WTRU 102 may receive a second PDCCH transmission using the unified TCI state. For example, the second PDCCH transmission may include a second DCI that includes information scheduling a PDSCH transmission. At 2908, the WTRU 102 may determine, based on a TCI status of the second TCI state, to apply one of the first TCI state or the third TCI state for the receiving of the PDSCH transmission. At 2910, the WTRU 102 may receive the PDSCH transmission by applying the determined one of the first TCI state or the third TCI state.

For example, the WTRU 102 may send HARQ feedback that is associated with the PDSCH transmission.

For example, the WTRU 102 may determine the TCI status of the second TCI state as activated (e.g., active). The WTRU 102 may (e.g., determine to) apply the first TCI state for the PDSCH transmission based on the TCI status of the second TCI state being activated. The WTRU 102 may receive the PDSCH transmission by applying the first TCI state (e.g., which is anchored to the second TCI state which is active).

For example, the WTRU 102 may receive a MAC CE including information indicating the second TCI state is (e.g., to be) activated.

For example, the WTRU 102 may receive the PDSCH transmission by applying the first TCI state which is associated with one or more QCL properties (e.g., of QCL-A) of the second TCI state.

For example, the WTRU 102 may determine the TCI status of the second TCI state as deactivated (e.g., inactive or semi-active). The WTRU 102 may (e.g., determine to) apply the third TCI state for the PDSCH transmission based on the TCI status of the second TCI state being deactivated (e.g., inactive or semi-active). The WTRU 102 may receive the PDSCH transmission by applying the third TCI state (e.g., which is not anchored to the second TCI state).

For example, the WTRU 102 may receive a MAC CE including information indicating the second TCI state is (e.g., to be) deactivated.

For example, the WTRU 102 may receive the PDSCH transmission by applying the first TCI state which is associated with a QCL property of a second QCL type of the third TCI state.

For example, the WTRU 102 may receive an applicable TCI status indicator indicating the TCI status of the second TCI state.

For example, the WTRU 102 may determine the TCI status of the second TCI state based on a time at which signaling indicating the TCI status of the second TCI state is received.

For example, the WTRU 102 may estimate one or more QCL properties using a source RS resource associated with the second TCI state.

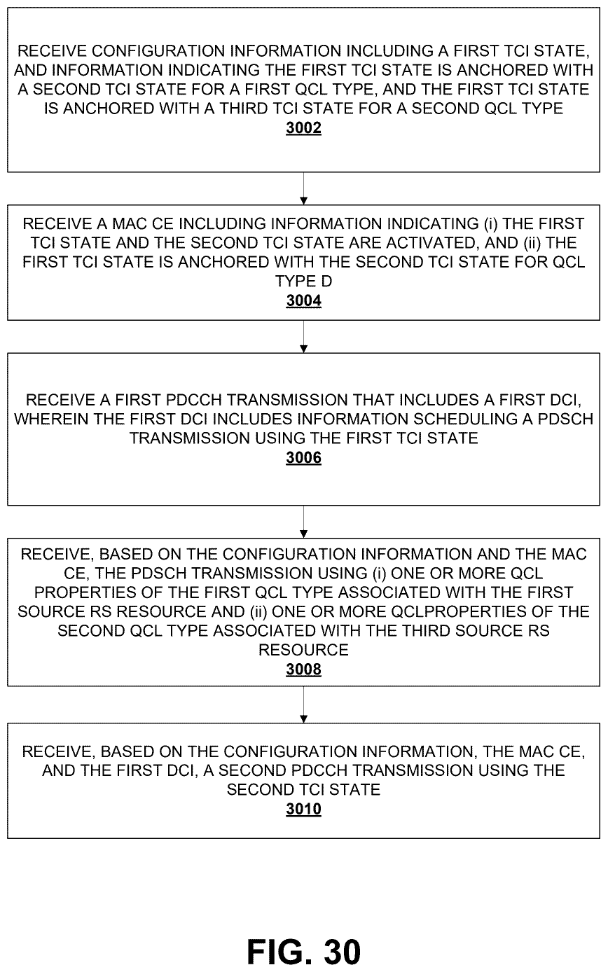

FIG. 30 is a procedural diagram illustrating an example procedure for determining QCL properties for receiving a downlink transmission, according to one or more embodiments of the present disclosure. As shown in FIG. 30, a WTRU 102 may receive, at 3002, configuration information including (i) a first TCI state associated with a first source RS resource for a first QCL type (e.g., QCL-A), and (ii) a second TCI state associated with a second source RS resource for the first QCL type and a third source RS resource for a second QCL type (e.g., QCL-D). At 3004, the WTRU 102 may receive a MAC CE including information indicating (i) the first TCI state and the second TCI state are activated, and (ii) the first TCI state is anchored with the second TCI state for the second QCL type. At 3006, the WTRU 102 may receive a first PDCCH transmission that includes a first DCI. For example, the first DCI may include information scheduling a PDSCH transmission (e.g., using the first TCI state). At 3008, the WTRU 102 may receive, based on the configuration information and the MAC CE, the PDSCH transmission using (i) one or more QCL properties of the first QCL type associated with the first source RS resource and (ii) one or more QCL properties of the second QCL type associated with the third source RS resource. At 3010, the WTRU 102 may receive, based on the configuration information, the MAC CE, and the first DCI, a second PDCCH transmission using the second TCI state (e.g., (i) the one or more QCL properties associated with the second source RS resource and (ii) one or more QCL properties associated with the third source RS resource).

For example, the WTRU 102 may estimate the one or more QCL properties (e.g., of the first QCL type) associated with the first source RS resource.

For example, the WTRU 102 may estimate the one or more QCL properties (e.g., of the first QCL type) associated with the second source RS resource.

For example, the WTRU 102 may estimate the one or more QCL properties (e.g., of the second QCL type) associated with the third source RS resource.

For example, the WTRU 102 may receive one or more transmissions of any of the first source RS resource, the second source RS resource, and/or the third source RS resource.

For example, the first TCI state may be a NF TCI state.

For example, the first TCI state may be a FF TCI state.

While the foregoing example solutions and representative procedures described above relate to reception in the downlink direction by the WTRU 102, the example solutions and representative procedures may be implemented by the WTRU 102 to perform transmission in the uplink direction and/or a combination of the downlink and uplink directions.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

The content of each of the following references is incorporated by reference herein in its entirety:
Third generation partnership project (3GPP), “Technical Specification Group Radio Access Network; NR; Physical layer procedures for control (Release 18)”, 3GPP TS 38.213 V 18.5.0, January 2025;
3GPP, “Technical Specification Group Radio Access Network; NR; Multiplexing and channel coding (Release 18)”, 3GPP TS 38.212V 18.5.0 , January 2025;
3GPP, “Technical Specification Group Radio Access Network; NR; Medium Access Control (MAC) protocol specification (Release 18)”, 3GPP TS 38.321 V 18.4.0December 2024;
3GPP, “Technical Specification Group Radio Access Network; NR; Radio Resource Control (RRC); Protocol specification (Release 18)”, 3GPP TS 38.331 V 18.4.0, December 2024; and
3GPP, “Technical Specification Group Radio Access Network; NR; Physical layer procedures for data (Release 18)”, 3GPP TS 38.214 V 18.5.0, January 2025.

1. A wireless transmit/receive unit (WTRU) comprising:
a processor, memory, and a transceiver which are configured to:
receive configuration information indicating a plurality of transmission configuration indicator (TCI) states and a plurality of aperiodic (AP) channel state information reference signal (CSI-RS) trigger states,
determine a unified TCI state is applicable,
receive downlink control information (DCI) scheduling a downlink transmission, wherein the DCI may include information indicating (i) a trigger state, (ii) an applicable RS, and/or (iii) a source RS of the unified TCI state or a previous AP CSI-RS,
determine a RS, to apply for the downlink transmission, from the applicable RS, the source RS of the unified TCI state, and the previous AP CSI-RS, and
receive the downlink transmission using one or more first quasi-colocation (QCL) type properties associated with the determined RS and a second QCL type property associated with the unified TCI state.

2. The WTRU of claim 1, wherein the processor, memory, and the transceiver are configured to estimate the one or more first QCL type properties using the applicable RS.

3. The WTRU of claim 1, wherein the processor, memory, and the transceiver are configured to estimate, prior to receiving the DCI, the one or more first QCL type properties using the previous AP CSI-RS.

4. The WTRU of claim 1, wherein the processor, memory, and the transceiver are configured to receive the DCI using the unified TCI state.

5. The WTRU of claim 1, wherein the processor, memory, and the transceiver are configured to:
determine the trigger state indicates an AP CSI-RS trigger state from among the set of AP CSI-RS trigger states,
determine the RS to apply for the downlink transmission from any of the indicated AP CSI-RS trigger state and/or the indicated applicable RS.

6. The WTRU of claim 1, wherein the processor, memory, and the transceiver are configured to:
determine the trigger state does not indicate any of the set of AP CSI-RS trigger states,
determine the RS to apply for the downlink transmission from the indicated source RS of the unified TCI state and the AP CSI-RS of the triggered AP CSI-RS trigger state.

7. The WTRU of claim 1, wherein the processor, memory, and the transceiver are configured to:
determine the RS to apply for the downlink transmission from the indicated source RS of the unified TCI state and the AP CSI-RS of the triggered AP CSI-RS trigger state based on a time duration between reception of the DCI and the scheduled downlink transmission.

8. The WTRU of claim 1, wherein the information indicating (i) the trigger state and (ii) the applicable RS is a CSI trigger state indicator included in the DCI.

9. The WTRU of claim 1, wherein the information indicating (iii) the source RS of the unified TCI state or the AP CSI-RS of the triggered AP CSI-RS trigger state is a previous CSI indicator included in the DCI.

10. The WTRU of claim 1, wherein the processor, memory, and the transceiver are configured to send hybrid automatic repeat request (HARQ) feedback information associated with the received downlink transmission.

11. A method implemented by a wireless transmit/receive unit (WTRU), the method comprising:
receiving configuration information indicating a plurality of transmission configuration indicator (TCI) states and a plurality of aperiodic (AP) channel state information reference signal (CSI-RS) trigger states;
determining a unified TCI state is applicable;
receiving downlink control information (DCI) scheduling a downlink transmission, wherein the DCI may include information indicating (i) a trigger state, (ii) an applicable RS, and/or (iii) a source RS of the unified TCI state or a previous AP CSI-RS;
determining a RS, to apply for the downlink transmission, from the applicable RS, the source RS of the unified TCI state, and the previous AP CSI-RS; and
receiving the downlink transmission using one or more first quasi-colocation (QCL) type properties associated with the determined RS and a second QCL type property associated with the unified TCI state.

12. The method of claim 11, further comprising:
estimating the one or more first QCL type properties using the applicable RS.

13. The method of claim 11, further comprising:
estimating, prior to receiving the DCI, the one or more first QCL type properties using the previous AP CSI-RS.

14. The method of claim 11, further comprising:
receiving the DCI using the unified TCI state.

15. The method of claim 11, further comprising:
determining the trigger state indicates an AP CSI-RS trigger state from among the set of AP CSI-RS trigger states; and
determining the RS to apply for the downlink transmission from the indicated AP CSI-RS trigger state and/or the indicated applicable RS.

16. The method of claim 11, further comprising:
determining the trigger state does not indicate any of the set of AP CSI-RS trigger states; and
determining the RS to apply for the downlink transmission from the indicated source RS of the unified TCI state and the previous AP CSI-RS.

17. The method of claim 11, further comprising:
determining the RS to apply for the downlink transmission from the indicated source RS of the unified TCI state and the AP CSI-RS of the triggered AP CSI-RS trigger state based on a time duration between reception of the DCI and the scheduled downlink transmission being greater than a WTRU capability.

18. The method of claim 11, wherein the information indicating (i) the trigger state and (ii) the applicable RS is a CSI trigger state indicator included in the DCI.

19. The method of claim 11, wherein the information indicating (iii) the source RS of the unified TCI state or the previous AP CSI-RS is a previous CSI indicator included in the DCI.

20. The method of claim 11, further comprising:
sending hybrid automatic repeat request (HARQ) feedback information associated with the received downlink transmission.
